(19) United States
(12) Patent Application Publication
(10) Pub. No.: US 2006/0046933 A1
(43) Pub. Date: Mar. 2, 2006

(54) Heat-sensitive recording material

(76) Inventors: Masayuki Iwasaki, Shizuoka (JP); Tsutomu Watanabe, Shizuoka (JP); Hirofumi Mitsuo, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/499,514

(22) PCT Filed: Dec. 20, 2002
(86) PCT No.: PCT/JP02/13394

§ 371 Date: Jul. 12, 2005

(30) Foreign Application Priority Data
Dec. 20, 2001 (JP) 2001-387593
Dec. 20, 2001 (JP) 2001-387597
Dec. 20, 2001 (JP) 2001-388128

(51) Int. Cl. B41M 5/30

(52) U.S. Cl. 503/216

(57) ABSTRACT

The present invention provides a heat-sensitive recording material having a support, and a heat-sensitive recording layer containing an electron-donating colorless dye and an electron-accepting compound for coloring by reacting with the electron-donating colorless dye on the support. The above-mentioned electron-accepting compound is preferably a compound represented by R¹-Ph-SO₂R². The maximum value of the curl height of the material is preferably 5.0 mm or less. The image density formed by thermal printing by energy application at 15.2 mJ/mm² from the heat-sensitive recording layer side of the support is preferably 1.20 or more. The static friction coefficient and the dynamic friction coefficient of the material are preferably in the range of 0.2 to 0.5 in the case where the outermost surface of the front side having at least one heat-sensitive recording layer and the outermost surface of the rear side are rubbed against each other. The pigment preferably has the boiled linseed oil absorption amount of 30 to 200 ml/100 g and an volume average particle diameter of 0.5 to 3 μm, and the heat-sensitive recording material is preferably used for a recording apparatus capable of thermal printing at speed of 10 cm/sec or more.

### TECHNICAL FIELD

The present invention relates to a heat-sensitive recording material. Specifically, the invention relates to a heat-sensitive recording material having superior apparatus applicability that does not cause deterioration of apparatus durability such as head abrasion, and the like; having photographic applicability and stability as a recording medium; having printing applicability, stamping applicability, environment applicability, and the like; and having usefulness as a plain paper-like recording medium.

### BACKGROUND ART

Historically, dye-type heat-sensitive paper containing a colorless leuco dye and a phenolic acidic substance was developed as a heat-sensitive recording technology by NCR Inc. in the 1960s, and this system has become the mainstream of heat-sensitive recording systems. Thereafter, demand for heat-sensitive paper (hereinafter referred to as “heat-sensitive recording material”) has increased rapidly since (1) miniaturization and price reduction of apparatuses became possible due to development of thermal heads based on semiconductor technologies and significant improvement in cost and performance; (2) besides (1), high quality (high sensitivity, improvement of head matching property, and the like) of heat-sensitive paper (heat-sensitive recording material) itself was realized; and (3) heat-sensitive recording systems were evaluated to be advantageous in view of user-friendliness, i.e., convenience, low costs, freedom from frequent maintenance, and the like as compared to other recording systems such as static recording, ink jet recording, PPC recording, and the like.

However, as heat-sensitive recording materials are used for facsimile machines, various printers, and the like and have become familiar to daily life, defects of heat-sensitive recording materials have also become well known. Namely, the following defects have been pointed out:
discoloration by light;
discoloration during storage at high temperature (when left in a vehicle, and the like);
fading of a recorded image by chemical agents such as plasticizers in wrapping films, oils, organic solvents in marker pens, ink for ink jet printers, and the like;
a lack of plain paper-like feeling (good stamping applicability such as good drying of stamps without bleeding, and the like, a recording surface that is matted and easy to read, good writing property with respect ot a pencil, and the like, resistance to stainining due to friction, and the like, and so forth), and the like.

Therefore, development and provision of a heat-sensitive recording material free from the above-mentioned defects and having high value have been demanded.

Recently, heat-sensitive recording materials have been widely used since they are relatively inexpensive and recording apparatus therefor are compact and free from frequent maintenance. Under such circumstances, competition in the marketing of heat-sensitive recording materials has become tough, and demand for heat-sensitive recording materials having higher performance that can be differentiated from conventional performance, and specifically heat-sensitive recording materials having high density of developed color, whiteness of background, sharpness, storage stability, good hue and sharpness for a full-color image recorded by an ink jet recording system, or the like has increased. Therefore, intensive investigations regarding various characteristics such as color developing property, storability, and the like of heat-sensitive recording materials are now being conducted in order to satisfy such demands.

The characteristics that heat-sensitive recording materials should have include, for example, (1) high sensitivity (capability to provide high density); (2) high whiteness of a background portion (non-printed portion) (low background fogging property); (3) superior image storability after photographic printing; (4) superior light fastness; (5) superior resistance to chemical substances; (6) sharpness and high image quality; (7) good hue and sharpness of colors for a full-color image recorded by an ink jet recording system; (8) good thermal head matching property and head resistance property by which thermal head abrasion is decreased; (9) plane paper-like feeling; (10) printing applicability that enables printing on a heat-sensitive recording layer, and stamping applicability free from bleeding; (11 applicability for high performance printers such as a high speed printer, and the like; and (12) nvironment applicability. Under the above-mentioned circumstances, it is demanded that all of these characteristics are simultaneously satisfied without deterioration of any of the characteristics. However, under the present circumstances, a heat-sensitive recording material that can satisfy all of the above-mentioned characteristics simultaneously has not been provided yet.

Also, in the production process, when the heat-sensitive recording layer or the like is formed by applying a coating solution the support, due to the drying or rolling into a roll-like shape thereafter, if the heat-sensitive recording material is produced by cutting the obtained material into sheets (e.g. square or rectangular shape), the four corners of each sheet tend to be curved and curled up toward the heat-sensitive recording layer side after the cutting [(13) curling tendency]. In the case where such curling shape is significant, not only the product value or quality is deteriorated but also transportation failure is caused at the time of recording.

Conventionally, 2,2-bis(4-hydroxyphenyl)propane (so-called “bisphenol A”) has been widely used as an electron-accepting compound that reacts with an electron-donating colorless dye to develop color used for a heat-sensitive recording material. However, in such a system, a heat-sensitive recording material having satisfactory properties in view of sensitivity, background fogging property, image storability and heat resistance has not been provided yet.

Furthermore, such a system also has a problem in view of (14) ink jet applicability. Namely, full color information is sometimes recorded on a heat-sensitive recording material using inks for ink jet recording. However, when ink jet recording is carried out on a recording surface of a conventional heat-sensitive recording material containing bisphenol A, hues of inks cannot be reproduced faithfully, sharp hues cannot be obtained, and when an image is already formed on the recording surface by heat-sensitive recording, the image sometimes fades. Furthermore, when the above-mentioned conventional heat-sensitive recording material is placed in contact with a medium having an image recorded by an ink jet printer, background fogging or fading of a recorded image sometimes occurs.

Conventionally, in the field of applications for receipts of resistors in POS systems, high speed printing is required, and in the case where of high speed printing, a head is generally easily stained and in an extreme case, printing quality is sometimes deteriorated due to the stain of the head. Especially, in the recent years, in the case of a printer made usable selectively for the heat-sensitive recording and thermal transfer recording for saving installation investments, in order to provide the thermal transfer recording suitability, a thermal head having so-called partial graze structure is employed in some cases and in the case where high speed recording is carried out on the heat-sensitive recording material using this type of thermal head, the head tends to be stained.

Generally, the heat-sensitive recording material is relatively economical and the recording appliance for the material is compact and maintenance free, so that it has been used in a wide range. In such situation, recently, the selling competition of the thermal recording paper (heat-sensitive recording materials) has been escalating and therefore higher functions differentiated from the conventional functions are required for the heat-sensitive recording materials and investigations and studies on improvements of coloring density of the heat-sensitive recording materials, image storability, chemical resistance (especially, plasticizer resistance), high speed printing suitability and the like have enthusiastically been carried out. Particularly, in the above-mentioned field of the applications for the receipts, image storability and the chemical resistance (especially, plasticizer resistance) are very important.

Further, Japanese Patent Application Laid-Open (JP-A) No. 6-135159 discloses recording materials using salicylic acid derivatives having aryloxyalkyloxy group as a substituent group and/or metal salts thereof as electron-accepting compounds and describes that the chemical resistance is improved. However, with respect to the image density and high speed printing suitability (head stain), there still remains a margin for further improvements.

The purpose of the invention is to solve the above-mentioned conventional problems and accomplish following objects.

That is, an object of the invention is to provide a heat-sensitive recording material which is scarcely curled and suitable for high quality recording and transportation; which is useful for forming images with high sensitivity and high density with suppressed fogging density (background fogging) in the background portion (non-image portions); which is excellent in the image storability and chemical resistance after printing and has ink-jet suitability without causing hue failure and blurring of the ink jet images or image color fading attributed to the ink for ink jet; and which shows good matching property to the thermal head and scarcely causes head wear or head stain even in the case of application to a high speed or a high functional printer having a partial graze structure (good head matching property in the high speed printing) and another object of the invention is to provide a heat-sensitive recording material, in addition to the above-mentioned properties, which gives sharp and high quality images, is excellent in the light fastness of the formed images, comprises a heat-sensitive recording layer or a protective layer for printing or stamping without blurring, is produced at a low cost with a saved amount of coating (environmental friendly property), and is provided with an plain paper-like touch.

### DISCLOSURE OF INVENTION

Based on the results of repeatedly carried out investigations on techniques for satisfying a variety of properties and abilities which heat-sensitive recording materials are required to have simultaneously at high level, the present inventors have found the following findings.

<Provision of High Sensitivity>

In order to provide high sensitivity, the following items (1) to (3) are important.

(1) Firstly, it is important to improve heat conduction from a thermal head to a heat-sensitive recording layer. For this purpose, it is effective to improve the surface smoothness of the recording surface of a heat-sensitive recording material and to provide a cushioning property to the recording surface. (2) Secondly, it is important to effectively utilize heat conducted from the thermal head. For this purpose, it is effective to make a substrate adiabatic and to thin down the heat-sensitive recording layer. (3) Thirdly, it is important to improve dissolution velocities of an electron-donating colorless dye and an electron-accepting compound in a sensitizer. For this purpose, it is effective to improve solubility, to decrease melt viscosity, and to decrease the particle sizes of raw materials. Hereinafter, items (1) to (3) are specifically explained.

(1) Improvement of Heat Conduction from Thermal Head to Heat-Sensitive Recording Layer

Since a certain amount of heat is necessary to develop color to a certain density on a heat-sensitive recording layer, it is important to effectively transmit heat from a thermal head to a recording layer in order to improve the sensitivity of a heat-sensitive recording material. Heat conductivity of solid is astronomically higher than that of gas, and conductive heat is much higher than radiant heat. Therefore, it is effective to increase the contact rate of the heat-sensitive recording layer surface (hereinafter sometimes referred to as “recording surface”) and the thermal head during printing, whereby heat from the thermal head can be effectively transmitted to the heat-sensitive recording layer.

In order to increase the contact rate of the recording surface and the thermal head, it is specifically effective to [1] increase the smoothness of the recording surface in advance, and to [2] increase the cushioning property of the heat-sensitive recording material, and the like (the smoothness of the recording surface and the cushioning property are physical properties necessary for the heat-sensitive recording material).

[1] In order to increase the smoothness of the recording surface, it is effective to improve flatness of a substrate. Specifically, it is desirable to use base paper having high flatness and/or to provide a undercoat layer including an oil-absorbing pigment as a main component on a substrate in order to compensate irregularity due to pulp, and the like. Furthermore, in order to increase smoothness, it is effective to conduct a heat calendar or super calendar treatment after a coating solution for the recording layer has been applied and the resultant coating has been dried.

[2] Furthermore, the effectiveness of improving the cushioning property of the heat-sensitive recording material (provision of cushioning property) is based on the following findings. That is, when thermal printing is carried out on a heat-sensitive recording material using a thermal head, a suitable pressure is applied to the heat-sensitive recording material and the thermal head using a platen roll. In order to increase the contact rate between the thermal head and the recording surface under the pressure, it is sufficient that the heat-sensitive recording material easily changes its shape. Therefore, it is effective as a specific means for providing a heat-sensitive material with a cushioning property to provide a undercoat layer containing an oil-absorbing pigment as a main component or to incorporate a pigment having a high oil-absorbing property in the heat-sensitive recording layer. Specifically, this concept for providing a cushioning property is also effective in increasing sensitivity when recording is conducted using a thermal head which has a partially glazed structure. Here, the partially glazed structure refers to a structure wherein, in a heat generating portion, a glazed layer having a convex (chevron-shaped) cross-section is disposed on a substrate.

(2) Effective Utilization of Heat Conducted from Thermal Head

In order to effectively utilize heat conducted from a thermal head, it is effective to make a substrate adiabatic. Providing as many gaps as possible in the substrate is effective as a specific means for this purpose. In the case of a heat-sensitive recording material, for example, the means can be provision of a undercoat layer including a pigment which has a high oil-absorbing property to decrease the amount of a binder used in the undercoat layer as much as possible, incorporation of hollow particles in the undercoat layer, or the like.

Furthermore, it is effective to thin down the heat-sensitive recording layer in order to effectively utilize heat. Given that the heat capacity of a heat-sensitive recording layer contributes to sensitivity, the heat-sensitive recording layer contains many components those do not contribute to development of color, and the heat capacities of these components are unnecessarily consumed. Examples of such components include a releasing agent and waxs, which suppress adhesion between the thermal head and the recording layer, an oil-absorbing pigment, which absorbs melted components, binders, in which materials are dispersed and which provides film strength, and the like. Since the heat consumption by these components accounts for about 20% to 30% of the total heat consumption, it is expected to increase sensitivity by about 10% to 15% by reducing the amounts of these components by half.

According to the inventor's investigation, sensitivity can be increased by decreasing the amounts of a pigment and a binder in a recording layer. Since sensitivity can be increased unexpectedly by decreasing the amount of the binder, it is considered that factors other than heat capacity contribute to increased sensitivity. However, it is unclear what the factors are. It should be noted that, however, when the amount of the binder is simply decreased, a head matching property with respect to a thermal head, film strength, and the like deteriorate. Accordingly, it is important to use as effective incorporation rates as possible, i.e., to use desired components in desired layers in minimum amounts.

(3) Improvement of Dissolution Velocities of Electron-Donating Colorless Dye and Electron-Accepting Compound in Sensitizer

In the earlier stage of engeneering development in heat-sensitive recording materials, a sensitizer was selected as an agent which decreases melting points of an electron-donating colorless dye and an electron-accepting compound in order to develop color at a lower temperature. However, in this concept, there is a limitation in increasing sensitivity while keeping a temperature at which color development starts. Consistency between background fogging prevention and increased sensitivity is difficult. Accordingly, the inventors considered a sensitizer as a material for dissolving an electron-donating colorless dye and an electron-accepting compound and investigated a sensitizer that realizes high sensitivity without unnecessarily decreasing a co-melting point, in other words, with keeping background fogging at a low level, and found that, in order to increase sensitivity, it is more advantageous to more rapidly diffuse the electron-donating colorless dye and the electron-accepting compound in the melted sensitizer. Accordingly, in order to increase sensitivity, it is advantageous and preferable to select a sensitizer having not only high solubility but also a low melt viscosity, and to decrease the dispersion liquid particle size of the electron-donating colorless dye and the electron-accepting compound. It should be noted that, however, when the dispersion liquid particle size is too small, background fogging becomes worse. Therefore, it is important to select a suitable size.

<Provision of Matching Property with Respect to Thermal Head, and Head Durability>

Printing is carried out on a heat-sensitive recording material by bring a thermal head, which is a heat generating element, into direct contact with the recording surface of the recording material (surface of the heat-sensitive recording layer), and rubbing the recording surface with the head. Accordingly, the melted components in the recording layer sometimes adhere to the head and deposit as smutch thereon. Furthermore, the components physically abrade or corrode the surface of the thermal head and then the lifetime of the head sometimes shortens.

Accordingly, it is desirable to use the following means.

1) In view of prevention of stain on the head, it is important for a heat-sensitive recording material to absorb and retain materials melted by heat, such as a dye, a developer, a sensitizer, and the like. For this purpose, it is effective to use a pigment having a high oil-absorbing property in the recording layer, or to provide a undercoat layer including a pigment which has a high oil-absorbing property, or the like.

2) Furthermore, it is important to suppress the amount of ions (Na⁺, K⁺, and the like), which easily cause corrosion of the head, in components of a recording material.

3) In view of decreasing physical abrasion as much as possible, it is important to consider hardness, shape, particle size, and the like of a pigment.

<Compatibility of Heat Resistance or Image Retention Property (and Chemical Resistance) and Background Fogging>

A developed image is specifically vulnerable to moisture, and easily fades out due to a reverse reaction caused by chemical agents such as oils and fats, plasticizers, and the like, since chemical reaction that is caused by heat melt and contact of a leuco dye and a developer, which chemical reaction is a principle of color development of heat-sensitive recording materials, is reversible reaction. Accordingly, problems regarding heat resistance, image storability (specifically moisture resistance) and chemical resistance, such as problems in which a developed image fades out due to heat or moisture during storage, or in daily life in which users may touch their hands, onto which a hand cream, any other cosmetic, oil or fat adheres, to the recording material, or in which the image may be brought into contact with a plastic product including a plasticizer, a product including an organic solvent or a leather product (an eraser, a desk mat or food wrapping film made of vinyl chloride, a marker pen, an ink for ink jet, a wallet, a commuter-pass holder, and the like).

In order to overcome the above-mentioned phenomenon due to the color development principle (dissapearance or fading of images), many invesitigations have been done. For example, [1] a measure to make a heat-sensitive recording material a so-called overcoat type material by forming a protective layer on a recording layer for the purpose of physical shielding, [2] a measure to add additives such as a cross-linking agent to a recording layer, or the like was done. However, even if a protective layer is provided, effects by heat and moisture cannot be completely suppressed. Furthermore, fading over time due to gradual permeation of oil or a plasticizer cannot be avoided. As a result, a heat-sensitive recording material has problems in that usage of the material is limited to short-time application such as measuring labels to be adhered to perishable foods sold in supermarkets, and the like, and that, even if a cross-linking substance is added, it takes substantially long period of time from color development to exhibit the effect thereof, ane the like. Therefore, storability, which is a basic characteristic, has not been satisfied yet.

Accordingly, as a result of the inventors' intensive investigations regarding improvement in storability, the inventors have found that a specific electron-accepting compound is useful for improvement in heat resistance and image storability and for prevention of background fogging, and that background fogging can be further prevented by combining the compound with a specific sensitizer and/or a specific electron-donating colorless dye. Furthermore, the inventors have found that heat resistance, image storability and light fastness can be further improved without deteriorating background fogging by combining the compound with a specific image stabilizer. According to the above findings, it is also possible to provide not only heat resistance and image storability, which are difficult to realize in conventional techniques in which an overcoat is formed to provide storability, but also stamping applicability and handling property at a high level. Accordingly, stamping applicability and image storability or heat resistance can be achieved simultaneously.

<Improvement in Light Fastness>

A heat-sensitive recording material having superior light fastness is necessary for some applications. However, a leuco dye, which contributes to image formation, easily decompose due to ultraviolet light, and the like, and fades after a long-time exposure to natural light. Therefore, the material including a leuco dye has a problem in point of light fastness.

In order to improve light fastness, it is important to provide a means for preventing decomposition of a leuco dye due to light. For this purpose, it is specifically effective to incorporate an ultraviolet light absorbent (an image stabilizer), which shuts out ultraviolet light that provides high level energy, in a heat-sensitive recording layer or a protective layer. Specifically, it is more effective to incorporate microcapsules encapsulating a liquid ultraviolet light absorbent in a protective layer in order to effectively shut out ultraviolet light before it arrives at the heat-sensitive recording layer.

<Provision of Printing Applicability>

Offset printing is sometimes conducted on the recording surface of a heat-sensitive recording material (surface of a heat-sensitive recording layer) depending on application. For such an application, the material is required to have enough surface strength to bear a printing vecocity of more than 100 m/min in a rotary form printing machine, and to have a dampening water-absorbing property. For this purpose, it is important to optimize the incorporation rates of a pigment and a binder in a heat-sensitive recording layer. A preferable pigment for this purpose is an oil-absorbing pigment such as calcium carbonate, or the like. A preferable binder for this purpose is polyvinyl alcohol (PVA). Sulfo-modified polyvinyl alcohol, diacetone-modified polyvinyl alcohol and acetoacetyl-modified polyvinyl alcohol are specifically preferred.

<Provision of Plain Paper-Like Feeling>

As a result of wide use of heat-sensitive recording materials as recording paper for facsimile machines in offices and at home and as recording paper for various printers, the heat-sensitive recording materials are compared with general paper (PPC paper, and woodfree paper such as a notebook, writing paper, or the like), and differences between the heat-sensitive recording materials and general paper, such as a slick surface, a bad writing property, and, when held by a hand, thinness and unsufficient strengh, have been often pointed out. These are some of reasons why facsimile machines used in offices have been recently replaced with PPC type facsimile machines using plane paper. In view of these points, it is important to provide heat-sensitive recording materials with hand feeling and user-friendliness close to those of woodfree paper, by [1] thickening base paper that is used as a substrate to improve strength, and/or by [2] providing a protective layer to provide low surface gloss, a writing property and stamping applicability, or the like.

Here, a heat-sensitive recording material having plain paper-like feeling is considered to have no defects of converted paper which conventional heat-sensitive recording paper has, and to have a matted surface, and, when touched by hands, to have no slick feeling, and to have resistance to abrasion and stain, and to provide a recorded image having fading resistance, and the like. Accordingly, materials having a protective layer on a recording layer have been proposed to provide plane paper-like feeling. However, in conventional protective layers, too much importance was placed on hand feeling, appearance (matted surface), a writing property, and the like, and stamping applicability was not considered.

However, the inventors thouoght that stamping applicability (no bleeding, rapid drying of a stamped image, or the like) is specifically important in view of traditional custom in Japan, and have investigated improvement in a protective layer for heat-sensitive recording materials having a plain paper-like property.

As a result, the inventors have found that the following materials are useful as a pigment and a binder of a protective layer in order to obtain plain paper-like feeling including stamping applicability.

Those having a suitable particle size, a suitable oil-absorption amount are preferred as a pigment, in order to place importance on stamping applicability, appearance (matted surface) and a writing property. When the particle size is too large, image quality sometimes becomes worse. When the particle size is too small, a writing property and appearance sometimes become worse. Furthermore, when the oil-absorption amount is too large, the level of opacity of the protective layer raises, which leads to a decreased recording density. When the oil-absorption amount is too small, stamping applicability (drying) tends to become worse.

Those obtained by mixing PVA and starch in a suitable ratio are preferable as the binder, in order to prevent deterioration of stamping applicability (bleeding). So-called completely-saponified PVA (having a saponification degree of about 93% or more) are preferable as PVA, in view of provision of stamping applicability (drying).

<Provision of High Sensitivity and Head Matching Property in Combination with Apparatus>

The reason why heat-sensitive recording materials have been recently applied to many fields and applications is that a heat-sensitive recording system has advantages such as miniturization, low running cost, freedom from frequent maintenance, and that techniques regarding both printers (hardware) and recording paper (medium) have been improved. In hardware, for example, high performance printers which have high performance similar to that of conventional dot printers and laser printers, such as those having a recording speed of 10 inch (about 25 cm)/sec, a maximum recording width of AO size (about 900 mm) and resolution of 600 dpi (24 dot/mm), were developped. Therefore, it is important to produce hardware having an optimal design and a controlling means by combining techniches according to application thereof.

Accordingly, the high performance printer is preferably a high speed printer having a recording velocity of not less than 10 cm/sec, a printer having a thermal head which has a partially glazed structure, or the like. However, when a conventional heat-sensitive recording material is combined with the high speed printer having a recording velocity of not less than 10 cm/sec, sensitivity is sometimes insufficient. When it is combined with the printer having a thermal head which has a partially glazed structure, head stain tends to occur.

Accordingly, the inventors investigated the optimal design of heat-sensitive recording materials, and have found that, even when specifically combined with the high speed printer that has a recording velocity of not less than 10 cm/sec or the printer having a thermal head which has a partially glazed structure, a heat-sensitive recording material, in which a specific developer (an electron-accepting compound) is selectively used, not only satisfies, at a high level, the above-mentioned performance necessary for heat-sensitive recording materials but also can exhibit high sensitivity and a good head matching property.

<Improvement in Image Quality>

In some cases, for examples, in the case where a facximile machine receives a photograph, quality of recorded image is important for hardware (apparatuses) using a heat-sensitive recording material. In order to improve quality of recorded images, the inventors have found that it is effective to provide a undercoat layer including an oil-absorbing pigment as a main component, and specifically to apply a undercoat layer by a curtain coating method or a blade coating method (specifically by a blade coating method).

<Decrease of Environmental Burden>

Recently, a system that less provides a burden on environment has been socially demanded, and this it is true in the field of heat-sensitive recording materials. In order to decrease environmental burden, it is important to satisfy required performance by using smaller amounts of materials and a smaller amount of energy. For this purpose, the inventors have found that applying a heat-sensitive recording layer, or the like by a curtain coating method is effective in improvement in color development density, and that applying a plurality of layers simultaneously to form a multi-layered structure is effective in decreasing energy consumption during drying and handling. That is, such measures can provide the same color development density even when smaller amounts of materials and lower energy are used.

<Handling Easiness>

At the time of printing on a heat-sensitive recording material in form of a roll or a sheet by a printer, or in the case where the heat-sensitive recording material is accumulated in form of the sheet after printing, if the height (the curl height) of the curved and curled four corners is higher than 5.0 mm, the recording material is wound or accordingly folded and bent to result in transportation failure in the printer during the transportation. Further, in the case where the recording material in form of a sheet is stacked after printing, the positioning is shifted while the material is stacked or accordingly, recording materials stacked in unbalanced state are slid to result in inferior stacking.

In terms of prevention of occurrence of such transportation failure and inferior stacking and improvement of the handling easiness, it is found effective to keep the maximum value of the curl height of the curved and curled up four corners of the sheet-like material 5.0 mm or less.

The invention is accomplished based on the above-mentioned finding and the practical means for solving the above-mentioned problem are as follows.

<1> A heat-sensitive recording material comprising a support and a heat-sensitive recording laywer provided thereon, the heat-sensitive recording layer containing an electron-donating colorless dye and an electron-accepting compound for coloring by reacting with the electron-donating colorless dye,
wherein the electron-accepting compound is a compound represented by the following general formula (1), and a maximum value of a curl height of the heat-sensitive recording maetial is 5.0 mm or less:
   R¹-Ph-SO₂R² General formula (1)

In the formula, R¹ represents a hydroxyl group or an alkyl group; R² represents -Ph, —NH-Ph, -Ph-OH, or —NH—CO—NH-Ph; Ph represents a phenyl group and may be substituted with a substituent group including —SO₂R².

According to the heat-sensitive recording material described in <1>, since the electron-accepting compound represented by the above-mentioned general formula (1) as one coloring component is used, high sensitivity can be provided while the background fogging is kept at a low level and the long time storability of formed images (hereinafter, referred to as image storability), chemical resistance, head-matching property to a thermal head can simultaneously be improved. Moreover, since the maximum value of the curl height (e.g. the distance between the heat-sensitive recording material surface contacting the flat face and the surface of the curled up portions of the heat-sensitive recording material in the flat face side) of the heat-sensitive recording material curled and coming up from the flat state of the heat-sensitive recording material placed still is kept 5.0 mm or less, the transportation property in a printer and the accumulation of sheets (of the heat-sensitive recording material) after printing can be kept good and according the heat-sensitive recording material with excellent handling easiness can be obtained.

<2> The heat-sensitive recording material as described in <1>, wherein the heat-sensitive recording layer is formed by applying a coating solution and, a dried coating amount after application is less than 6 g/cm².

According to the heat-sensitive recording material described in <2>, since the heat-sensitive recording layer is formed to be thin by applying a coating solution to be applied for the layer formation and adjusting the coating amount to be lower than 6 g/cm² so as to lessen the drying load, prevent deterioration of the whiteness of the background portions and image storability, and provide plain paper-like touch.

<3> The heat-sensitive recording material as described in <1> or <2>, wherein the compound represented by the general formula (1) is 4-hydroxybenzenesulfonanilide.

According to the heat-sensitive recording material described in <3>, since 4-hydroxybenzenesulfonanilide is contained as the electron-accepting compound, high sensitivity, the image storability, and the head-matching property can more efficiently be improved and increase of the background fogging in the background portions (fogging density in the background portions) can be prevented.

<4> The heat-sensitive recording material as described in any one of <1> to <3>, wherein the heat-sensitive recording layer contains an image stabilizer and the image stabilizer is 1,1,3-tris(2-methyl-4-hydroxy-5-tert-butylphenyl)butane and/or 1,1,3-tris(2-methyl-4-hydroxy-5-cyclohexylphenyl)butane.

According to the heat-sensitive recording material described in <4>, since the heat-sensitive recording layer contains a specified image stabilizer, transfer to the reverse reaction to the coloration reaction (right reaction) can be suppressed and the image storability can further be improved and at the same time it contributes to the improvement of the light fastness.

<5> The heat-sensitive recording material as described in any one of <1> to <4>, wherein the heat-sensitive recording layer contains an inorganic pigment and the inorganic pigment is at least one compound selected from calcite type (precipitated) calcium carbonate, amorphous silica, and aluminum hydroxide.

According to the heat-sensitive recording material described in <5>, since the heat-sensitive recording layer contains a specified inorganic pigment, the head-matching property to the thermal head to be brought into contact with can be improved more and at the same time, it contributes to the stamping suitability.

<6> The heat-sensitive recording material as described in any one of <1> to <5>, wherein the heat-sensitive recording layer contains an adhesive and the adhesive is at least one substance selected from sulfo-modified polyvinyl alcohol, diacetone-modified polyvinyl alcohol, and acetoacetyl-modified polyvinyl alcohol.

According to the heat-sensitive recording material described in <6>, since the heat-sensitive recording layer contains a specified water-soluble resin as the adhesive, further higher sensitivity and further decreased background fogging can be achieved simultaneously. Also, with this constitution, printing suitability is also provided and water resistance can be provided also by using a cross-linking agent in combination.

<7> The heat-sensitive recording material as described in any one of <1> to <6>, wherein the support contains waste paper pulp.

According to the heat-sensitive recording material described in <7>, since the waste paper pulp is used for the support, recycling of a resource and saving consumption of the resource can be achieved.

<8> The heat-sensitive recording material as described in any one of <1> to <7>, wherein a protective layer is formed on the heat-sensitive recording layer and the protective layer contains at least one inorganic pigment selected from aluminum hydroxide, kaolin, and amorphous silica and a water-soluble polymer.

According to the heat-sensitive recording material described in <8>, since the protective layer containing a specified inorganic pigment is formed on the heat-sensitive recording layer, the storability can be improved due to the oil absorbing property of the layer and at the same time, the handling easiness and the stamping suitability (plain paper-like touch) can be provided.

<9> The heat-sensitive recording material as described in any one of <1> to <8>, wherein the total ion concentration of Na⁺ ions and K⁺ ions is 1,500 ppm or less.

According to the heat-sensitive recording material described in <9>, since a material with a low ion content is used selectively, the total ion concentration in the whole body of the support and layers composing the heat-sensitive recording material can be suppressed low and therefore, the amount of ions to adhere to the head can be suppressed to result in improvement of corrosion resistance (durability) of a thermal head.

<10> The heat-sensitive recording material as described in any one of <1> to <9>, wherein a contact angle after 0.1 seconds after dropwise dropping distilled water on the surface of the heat-sensitive recording layer is 20° or more.

According to the heat-sensitive recording material described in <10>, since the contact angle of the surface of the heat-sensitive recording layer is adjusted to be 20° or more, blurring of ink at the time of ink jet recording or stamping can effectively suppressed and ink jet recording suitability and stamping suitability are improved.

<11> The heat-sensitive recording material as described in any one of <1> to <10>, wherein the density retention rate of the formed image is 65% or more in the case where the formed image is left still under environmental conditions of 60° C. temperature and 20% relative humidity for 24 hours after the printing.

According to the heat-sensitive recording material described in <11>, since the formed image can be kept at a high density for a long duration, the material can be used in fields such as important document storage, prepaid tickets, receipts, money certificates, and the like for which long term image reliability is required.

<12> The heat-sensitive recording material as described in any one of <1> to <11>, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane, and diphenylsulfone.

According to the heat-sensitive recording material described in <12>, since the heat-sensitive recording layer contains a specified sensitizer, the dissolution viscosity is decreased and a coloring component can excellently be dispersed and the sensitivity can efficiently be improved without deteriorating the background fogging.

<13> The heat-sensitive recording material as described in <12>, wherein the content of the sensitizer is 75 to 200 parts by mass in 100 parts by mass of the compound represented by the general formula (1).

According to the heat-sensitive recording material described in <13>, since the sensitizer is added in an amount in a range proper to the electron-accepting compound, the sensitivity can efficiently be improved without deteriorating other abilities and properties.

<14> The heat-sensitive recording material as described in any one of <1> to <13>, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

According to the heat-sensitive recording material described in <14>, since the heat-sensitive recording layer contains a specified electron-donating colorless dye, the sensitivity at a higher level, the background fogging suppression, and the storability can all be improved satisfactorily.

<15> The heat-sensitive recording material as described in any one of <1> to <14>, wherein at least one layer on the support is formed by application by a curtain coating method.

According to the heat-sensitive recording material described in <15>, since at least one layer among a plurality of layers, especially the heat-sensitive recording layer, is formed by the curtain coating method, the constituent components can be concentrated on the recording face and accordingly, the coloring density can be increased with decreased amounts of materials to be used and at the same time the image quality (image feeling) can be improved. Further, in the case where a plurality of layers are simultaneously coated in layers by the curtain coating method, the consumption energy can be saved at the time of production.

<16> A heat-sensitive recording material comprising a support and a heat-sensitive recording layer provided thereon, the heat-sensitive recording layer containing an electron-donating colorless dye and an electron-accepting compound for coloring by reacting with the electron-donating colorless dye,
wherein the electron-accepting compound is a compound represented by the following general formula (1):
   R¹-Ph-SO₂R² General formula (1)

In the formula, R¹ represents a hydroxyl group or an alkyl group; R² represents -Ph, —NH-Ph, -Ph-OR³, or —NH—CO—NH-Ph; R³ represents an alkyl group; and Ph represents a phenyl group and may be substituted with a substituent group including —SO₂R²,
and an image density (the reflection density measured by Macbeth reflection densitometer RD-918 (manufactured by Macbeth Co.) formed by thermal printing by energy application at 15.2 mJ/mm² from a heat-sensitive recording layer side of the support is 1.20 or more.

According to the heat-sensitive recording material described in <16>, since the electron-accepting compound represented by the above-mentioned general formula (1) as one coloring component is used, high sensitivity can be provided while the background fogging is kept at a low level and the long time storability of formed images (hereinafter, referred to as image storability), chemical resistance, head-matching property to a thermal head can simultaneously be improved. Moreover, since the image density is adjusted at 1.20 or more in the case of thermal printing with application energy of 15.2 mJ/mm², the colored image is clear and the recorded information is easily readable even after a long time storage and the readability and discrimination can be assured.

<17> The heat-sensitive recording material as described in <16>, wherein the heat-sensitive recording layer is formed by applying a coating solution and the dried coating amount after application is lower than 6 g/cm².

According to the heat-sensitive recording material described in <17>, since the heat-sensitive recording layer is formed to be thin by applying a coating solution to be applied for the layer formation and adjusting the coating amount to be lower than 6 g/cm² so as to lessen the drying load, prevent deterioration of the whiteness of the background portions and image storability, and provide plain paper-like touch.

<18> The heat-sensitive recording material as described in <16> or <17>, wherein the compound represented by the general formula (1) is 4-hydroxybenzenesulfonanilide.

According to the heat-sensitive recording material described in <17>, since 4-hydroxybenzenesulfonanilide is added as the electron-accepting compound, high sensitivity, the image storability, and the head-matching property can more efficiently be improved and increase of the background fogging in the background portions (fogging density in the background portions) can be prevented.

<19> The heat-sensitive recording material as described in any one of <16> to <18>, wherein the heat-sensitive recording layer contains an image stabilizer and the image stabilizer is 1,1,3-tris(2-methyl-4-hydroxy-5-tert-butylphenyl)butane and/or 1,1,3-tris(2-methyl-4-hydroxy-5-cyclohexylphenyl)butane.

According to the heat-sensitive recording material described in <19>, since the heat-sensitive recording layer contains a specified image stabilizer, transfer to the reverse reaction to the coloration reaction (right reaction) can be suppressed and the image storability can further be improved and at the same time it contributes to the improvement of the light fastness.

<20> The heat-sensitive recording material as described in any one of <16> to <19>, wherein the heat-sensitive recording layer contains an inorganic pigment and the inorganic pigment is at least one compound selected from calcite type (precipitated) calcium carbonate, amorphous silica, and aluminum hydroxide.

According to the heat-sensitive recording material described in <20>, since the heat-sensitive recording layer contains a specified inorganic pigment, the head-matching property to the thermal head to be brought into contact with can be improved more and at the same time, it contributes to the stamping suitability.

<21> The heat-sensitive recording material as described in any one of <16> to <20>, wherein the heat-sensitive recording layer contains an adhesive and the adhesive is at least one substance selected from sulfo-modified polyvinyl alcohol, diacetone-modified polyvinyl alcohol, and acetoacetyl-modified polyvinyl alcohol.

According to the heat-sensitive recording material described in <21>, since the heat-sensitive recording layer contains a specified water-soluble resin as the adhesive, further higher sensitivity and further decreased background fogging can be achieved simultaneously. Also, with this constitution, printing suitability is also provided and water resistance can be provided also by using a cross-linking agent in combination.

<22> The heat-sensitive recording material as described in any one of <16> to <21>, wherein the support contains waste paper pulp.

According to the heat-sensitive recording material described in <22>, since the waste paper pulp is used for the support, recycling of a resource and saving consumption of the resource can be achieved.

<23> The heat-sensitive recording material as described in any one of <16> to <22>, wherein a protective layer is formed on the heat-sensitive recording layer and the protective layer contains at least one inorganic pigment selected from aluminum hydroxide, kaolin, and amorphous silica and a water-soluble polymer.

According to the heat-sensitive recording material described in <23>, since the protective layer containing a specified inorganic pigment is formed on the heat-sensitive recording layer, the storability can be improved due to the oil absorbing property of the layer and at the same time, the handling easiness and the stamping suitability can be provided.

<24> The heat-sensitive recording material as described in any one of <16> to <23>, wherein the total ion concentration of Na⁺ ions and K⁺ ions is 1,500 ppm or less.

According to the heat-sensitive recording material described in <24>, since a material with a low ion content is used selectively, the total ion concentration in the whole body of the support and layers composing the heat-sensitive recording material can be suppressed low and therefore, the amount of ions to adhere to the head can be suppressed to result in improvement of corrosion resistance (durability) of a thermal head.

<25> The heat-sensitive recording material as described in any one of <16> to <24>, wherein a contact angle after 0.1 seconds after of dropwise dropping distilled water on the surface of the heat-sensitive recording layer is 20° or more.

According to the heat-sensitive recording material described in <25>, since the contact angle of the surface of the heat-sensitive recording layer is adjusted to be 20° or more, blurring of ink at the time of ink jet recording or stamping can effectively suppressed and ink jet recording suitability and stamping suitability are improved.

<26> The heat-sensitive recording material as described in any one of <16> to <25>, wherein the density retention rate of the formed image is 65% or more in the case where the formed image is left still under environmental conditions of 60° C. temperature and 20% relative humidity for 24 hours after the printing.

According to the heat-sensitive recording material described in <26>, since the formed image can be kept at a high density for a long duration, the material can be used in fields such as important document storage, prepaid tickets, receipts, money certificates, and the like for which long term image reliability is required.

<27> The heat-sensitive recording material as described in any one of <16> to <26>, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane, and diphenylsulfone.

According to the heat-sensitive recording material described in <27>, since the heat-sensitive recording layer contains a specified sensitizer, the dissolution viscosity is decreased and a coloring component can excellently be dispersed and the sensitivity can efficiently be improved without deteriorating the background fogging.

<28> The heat-sensitive recording material as described in <27>, wherein the content of the sensitizer and the sensitizer is 75 to 200 parts by mass in 100 parts by mass of the compound represented by the general formula (1).

According to the heat-sensitive recording material described in <28>, since the sensitizer is added in an amount in a range proper to the electron-accepting compound, the sensitivity can efficiently be improved without deteriorating other abilities and properties.

<29> The heat-sensitive recording material as described in any one of <16> to <28>, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

According to the heat-sensitive recording material described in <29>, since the heat-sensitive recording layer contains a specified electron-donating colorless dye, the sensitivity at a higher level, the background fogging suppression, and the storability can all be improved satisfactorily.

<30> The heat-sensitive recording material as described in any one of <16> to <29>, wherein at least one layer on the support is formed by application by a curtain coating method.

According to the heat-sensitive recording material described in <30>, since at least one layer among a plurality of layers, especially the heat-sensitive recording layer, is formed by the curtain coating method, the constituent components can be concentrated on the recording face and accordingly, the coloring density can be increased with decreased amounts of materials to be used and at the same time the image quality (image feeling) can be improved. Further, in the case where a plurality of layers are simultaneously coated in layers by the curtain coating method, the consumption energy can be saved at the time of production.

<31> A heat-sensitive recording material comprising a support and heat-sensitive recording containing an electron-donating colorless dye and an electron-accepting compound for coloring by reacting with the electron-donating colorless dye, wherein an image density (the reflection density measured by Macbeth reflection densitometer RD-918 (manufactured by Macbeth Co.) formed by printing with a thermal head by energy application at 15.2 mJ/mm² is 1.20 or more, and a static friction coefficient and a dynamic friction coefficient are in a range of 0.2 to 0.5 in a case where an outermost surface of a front side of the recording material having at least one heat-sensitive recording layer and an outermost surface of a rear side of the recording material are rubbed against each other.

According to the heat-sensitive recording material described in <31>, since the image density is adjusted at 1.20 or more in the case of thermal printing with application energy of 15.2 mJ/mm², the colored image is clear and the recorded information is easily readable even after a long time storage and the readability and discrimination can be assured. Moreover, since the static friction coefficient and the dynamic friction coefficient are adjusted to be in the range of 0.2 to 0.5 in the case where the outermost surface of the front side having at least one heat-sensitive recording layer and the outermost surface of the rear side are rubbed against each other, the friction force between the material and a transportation means such as rubber roller is sufficient so as to prevent slipping of the transportation means at the time of transporting the heat-sensitive recording material and prevent transportation failure and thus the transportation property can be improved. Further, since the friction force between the outer most surface in the side where at least one heat-sensitive recording layer of the heat-sensitive recording material is formed (e.g. the recording face side in the case where the heat-sensitive recording layer is formed only in one face: hereinafter, referred to as the front side in some cases) and the opposite side (e.g. the side where no heat-sensitive recording layer is formed in the case where the heat-sensitive recording layer is formed only in one face: hereinafter, referred to as the rare side in some cases) is in a proper range, in the case where respective heat-sensitive recording materials are stacked, the respective materials have good slippage property. Therefore, in the case where sheets of the heat-sensitive recording material of the invention are transported, transportation of a plurality of sheets stacked together can be prevented and the transportation property can be improved. Incidentally, with respect to the heat-sensitive recording material of the invention, in the case where the heat-sensitive recording layer is formed in both faces of the support, one face side is optionally selected to be the front face and the reverse side is set to be the rear side.

<32> The heat-sensitive recording material as described in <31>, wherein the electron-accepting compound is a compound represented by the following general formula (1):
R¹-Ph-SO₂R² General formula (1)

In the formula, R¹ represents a hydroxyl group or an alkyl group; R² represents -Ph, —NH-Ph, -Ph-OR³, or —NH—CO—NH-Ph; R³ represents an alkyl group; and Ph represents a phenyl group and may be substituted with a substituent group including —SO₂R²,

According to the heat-sensitive recording material described in <32>, since the electron-accepting compound represented by the above-mentioned general formula (1) as one coloring component is used, high sensitivity can be provided while the background fogging is kept at a low level and the long time storability of formed images (hereinafter, referred to as image storability), chemical resistance, head-matching property to a thermal head can simultaneously be improved.

<33> The heat-sensitive recording material as described in <31> or <32>, wherein the compound represented by the general formula (1) is 4-hydroxybenzenesulfonanilide.

According to the heat-sensitive recording material described in <33>, since 4-hydroxybenzenesulfonanilide is added as the electron-accepting compound, high sensitivity, the image storability, and the head-matching property can more efficiently be improved and increase of the background fogging in the background portions (fogging density in the background portions) can be prevented.

<34> The heat-sensitive recording material as described in any one of <31> to <33>, wherein the heat-sensitive recording layer contains an image stabilizer and the image stabilizer is 1,1,3-tris(2-methyl-4-hydroxy-5-tert-butylphenyl)butane and/or 1,1,3-tris(2-methyl-4-hydroxy-5-cyclohexylphenyl)butane.

According to the heat-sensitive recording material described in <34>, since the heat-sensitive recording layer contains a specified image stabilizer, transfer to the reverse reaction to the coloration reaction (right reaction) can be suppressed and the image storability can further be improved and at the same time it contributes to the improvement of the light fastness.

<35> The heat-sensitive recording material as described in any one of <31> to <34>, wherein the heat-sensitive recording layer contains an inorganic pigment and the inorganic pigment is at least one compound selected from calcite type (precipitated) calcium carbonate, amorphous silica, and aluminum hydroxide.

According to the heat-sensitive recording material described in <35>, since the heat-sensitive recording layer contains a specified inorganic pigment, the head-matching property to the thermal head to be brought into contact with can be improved more and at the same time, it contributes to the stamping suitability.

<36> The heat-sensitive recording material as described in any one of <31> to <35>, wherein the heat-sensitive recording layer contains an adhesive and the adhesive is at least one substance selected from sulfo-modified polyvinyl alcohol, diacetone-modified polyvinyl alcohol, and acetoacetyl-modified polyvinyl alcohol.

According to the heat-sensitive recording material described in <36>, since the heat-sensitive recording layer contains a specified water-soluble resin as the adhesive, further higher sensitivity and further decreased background fogging can be achieved simultaneously. Also, with this constitution, printing suitability is also provided and water resistance can be provided also by using a cross-linking agent in combination.

<37> The heat-sensitive recording material as described in any one of <31> to <36>, wherein the support contains waste paper pulp.

According to the heat-sensitive recording material described in <37>, since the waste paper pulp is used for the support, recycling of a resource and saving consumption of the resource can be achieved.

<38> The heat-sensitive recording material as described in any one of <31> to <37>, wherein a protective layer is formed on the heat-sensitive recording layer and the protective layer contains at least one inorganic pigment selected from aluminum hydroxide, kaolin, and amorphous silica and a water-soluble polymer.

According to the heat-sensitive recording material described in <38>, since the protective layer containing a specified inorganic pigment is formed on the heat-sensitive recording layer, the storability can be improved due to the oil absorbing property of the layer and at the same time, the handling easiness and the stamping suitability can be provided.

<39> The heat-sensitive recording material as described in any one of <31> to <38>, wherein the total ion concentration of Na⁺ ions and K⁺ ions is 1,500 ppm or less.

According to the heat-sensitive recording material described in <39>, since a material with a low ion content is used selectively, the total ion concentration in the whole body of the support and layers composing the heat-sensitive recording material can be suppressed low and therefore, the amount of ions to adhere to the head can be suppressed to result in improvement of corrosion resistance (durability) of a thermal head.

<40> The heat-sensitive recording material as described in any one of <31> to <39>, wherein a contact angle after 0.1 seconds after of dropwise dropping distilled water on the surface of the heat-sensitive recording layer is 20° or more.

According to the heat-sensitive recording material described in <40>, since the contact angle of the surface of the heat-sensitive recording layer is adjusted to be 20° or more, blurring of ink at the time of ink jet recording or stamping can effectively suppressed and ink jet recording suitability and stamping suitability are improved.

<41> The heat-sensitive recording material as described in any one of <31> to <40>, wherein the density retention rate of the formed image is 65% or more in the case where the formed image is left still under environmental conditions of 60° C. temperature and 20% relative humidity for 24 hours after the printing.

According to the heat-sensitive recording material described in <41>, since the formed image can be kept at a high density for a long duration, the material can be used in fields such as important document storage, prepaid tickets, receipts, money certificates, and the like for which long term image reliability is required.

<42> The heat-sensitive recording material as described in any one of <31> to <41>, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, diphenylsulfone, and 1,2-diphenoxyethane.

According to the heat-sensitive recording material described in <42>, since the heat-sensitive recording layer contains a specified sensitizer, the dissolution viscosity is decreased and a coloring component can excellently be dispersed and the sensitivity can efficiently be improved without deteriorating the background fogging.

<43> The heat-sensitive recording material as described in <42>, wherein the content of the sensitizer and the sensitizer is 75 to 200 parts by mass in 100 parts by mass of the compound represented by the general formula (1).

According to the heat-sensitive recording material described in <43>, since the sensitizer is added in an amount in a range proper to the electron-accepting compound, the sensitivity can efficiently be improved without deteriorating other abilities and properties.

<44> The heat-sensitive recording material as described in any one of <31> to <43>, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

According to the heat-sensitive recording material described in <44>, since the heat-sensitive recording layer contains a specified electron-donating colorless dye, the sensitivity at a higher level, the background fogging suppression, and the storability can all be improved satisfactorily.

<45> The heat-sensitive recording material as described in any one of <31> to <44>, wherein at least one layer on the support is formed by application by a curtain coating method.

According to the heat-sensitive recording material described in <45>, since at least one layer among a plurality of layers, especially the heat-sensitive recording layer, is formed by the curtain coating method, the constituent components can be concentrated on the recording face and accordingly, the coloring density can be increased with decreased amounts of materials to be used and at the same time the image quality (image feeling) can be improved. Further, in the case where a plurality of layers are simultaneously coated in layers by the curtain coating method, the consumption energy can be saved at the time of production.

<46> A heat-sensitive recording material comprising a support and a heat-sensitive recording layer provided thereon, and the heat-sensitive recording layer containing an electron-donating colorless dye, an electron-accepting compound for coloring by reacting with the electron-donating colorless dye, and a pigment,
wherein the pigment has a boiled linseed oil absorption amount of 30 to 200 ml/100 g and an volume average particle diameter of 0.5 to 3 μm, and the heat-sensitive recording material is used for a recording apparatus capable of thermal printing at speed of 10 cm/sec or more.

According to the heat-sensitive recording material described in <46>, since the pigment having the boiled linseed oil absorption amount of 30 to 200 ml/100 g and a volume average particle diameter of 0.5 to 3 μm is used, the stain of a head by high speed printing can be prevented. Further, since the recording apparatus capable of thermal printing at speed of 10 cm/sec or more is used, the heat transmission efficiency to the heat-sensitive recording layer is high and colored images with high density can be obtained with suppressed heat loss. Accordingly, the application energy at the time of recording can be saved and the density fluctuation due to the fluctuation of the heat transmission efficiency can be prevented.

<47> The heat-sensitive recording material as described in <46>, wherein the electron-accepting compound is a compound represented by the following general formula (1):
R¹-Ph-SO₂R² General formula (1)

In the formula, R¹ represents a hydroxyl group or an alkyl group; R² represents -Ph, —NH-Ph, -Ph-OR³, or —NH—CO—NH-Ph; R³ represents an alkyl group; and Ph represents a phenyl group and may be substituted with a substituent group including —SO₂R².

According to the heat-sensitive recording material described in <47>, since the electron-accepting compound represented by the above-mentioned general formula (1) as one coloring component is used, high sensitivity can be provided while the background fogging is kept at a low level and the long time storability of formed images (hereinafter, referred to as image storability), chemical resistance, head-matching property to a thermal head can simultaneously be improved.

<48> The heat-sensitive recording material as described in <47>, wherein the compound represented by the general formula (1) is 4-hydroxybenzenesulfonanilide.

According to the heat-sensitive recording material described in <48>, since 4-hydroxybenzenesulfonanilide is added as the electron-accepting compound, high sensitivity, the image storability, and the head-matching property can more efficiently be improved and increase of the background fogging in the background portions (fogging density in the background portions) can be prevented.

<49> The heat-sensitive recording material as described in any one of <46> to <48>, wherein the heat-sensitive recording layer contains an inorganic pigment and the inorganic pigment is at least one compound selected from calcite type (precipitated) calcium carbonate, amorphous silica, and aluminum hydroxide.

According to the heat-sensitive recording material described in <49>, since the heat-sensitive recording layer contains a specified inorganic pigment, the head-matching property to the thermal head to be brought into contact with can be improved more and at the same time, it contributes to the stamping suitability.

<50> The heat-sensitive recording material as described in any one of <46> to <49>, wherein the heat-sensitive recording layer contains an image stabilizer and the image stabilizer is 1,1,3-tris(2-methyl-4-hydroxy-5-tert-butylphenyl)butane and/or 1,1,3-tris(2-methyl-4-hydroxy-5-cyclohexylphenyl)butane.

According to the heat-sensitive recording material described in <50>, since the heat-sensitive recording layer contains a specified image stabilizer, transfer to the reverse reaction to the coloration reaction (right reaction) can be suppressed and the image storability can further be improved and at the same time it contributes to the improvement of the light fastness.

<51> The heat-sensitive recording material as described in any one of <46> to <50>, wherein the heat-sensitive recording layer contains an adhesive and the adhesive is at least one substance selected from sulfo-modified polyvinyl alcohol, diacetone-modified polyvinyl alcohol, and acetoacetyl-modified polyvinyl alcohol.

According to the heat-sensitive recording material described in <51>, since the heat-sensitive recording layer contains a specified water-soluble resin as the adhesive, further higher sensitivity and further decreased background fogging can be achieved simultaneously. Also, with this constitution, printing suitability is also provided and water resistance can be provided also by using a cross-linking agent in combination.

<52> The heat-sensitive recording material as described in any one of <46> to <51>, wherein the support contains waste paper pulp.

According to the heat-sensitive recording material described in <52>, since the waste paper pulp is used for the support, recycling of a resource and saving consumption of the resource can be achieved.

<53> The heat-sensitive recording material as described in any one of <46> to <52>, wherein a protective layer is formed on the heat-sensitive recording layer and the protective layer contains at least one inorganic pigment selected from aluminum hydroxide, kaolin, and amorphous silica and a water-soluble polymer.

According to the heat-sensitive recording material described in <53>, since the protective layer containing a specified inorganic pigment is formed on the heat-sensitive recording layer, the storability can be improved due to the oil absorbing property of the layer and at the same time, the handling easiness and the stamping suitability (plain paper-like touch) can also be provided.

<54> The heat-sensitive recording material as described in any one of <46> to <53>, wherein the total ion concentration of Na⁺ ions and K⁺ ions is 1,500 ppm or less.

According to the heat-sensitive recording material described in <54>, since a material with a low ion content is used selectively, the total ion concentration in the whole body of the support and layers composing the heat-sensitive recording material can be suppressed low and therefore, the amount of ions to adhere to the head can be suppressed to result in improvement of corrosion resistance (durability) of a thermal head.

<55> The heat-sensitive recording material as described in any one of <46> to <54>, wherein a contact angle after 0.1 seconds after of dropwise dropping distilled water on the surface of the heat-sensitive recording layer is 20° or more.

According to the heat-sensitive recording material described in <55>, since the contact angle of the surface of the heat-sensitive recording layer is adjusted to be 20° or more, blurring of ink at the time of ink jet recording or stamping can effectively suppressed and ink jet recording suitability and stamping suitability are improved.

<56> The heat-sensitive recording material as described in any one of <46> to <55>, wherein the density retention rate of the formed image is 65% or more in the case where the formed image is left still under environmental conditions of 60° C. temperature and 20% relative humidity for 24 hours after the printing.

According to the heat-sensitive recording material described in <56>, since the formed image can be kept at a high density for a long duration, the material can be used in fields such as important document storage, prepaid tickets, receipts, money certificates, and the like for which long term image reliability is required.

<57> The heat-sensitive recording material as described in any one of <46> to <56>, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane, and diphenylsulfone.

According to the heat-sensitive recording material described in <57>, since the heat-sensitive recording layer contains a specified sensitizer, the dissolution viscosity is decreased and a coloring component can excellently be dispersed and the sensitivity can efficiently be improved without deteriorating the background fogging.

<58> The heat-sensitive recording material as described in <57>, wherein the content of the sensitizer and the sensitizer is 75 to 200 parts by mass in 100 parts by mass of the compound represented by the general formula (1).

According to the heat-sensitive recording material described in <58>, since the sensitizer is added in an amount in a range proper to the electron-accepting compound, the sensitivity can efficiently be improved without deteriorating other abilities and properties.

<59> The heat-sensitive recording material as described in any one of <46> to <58>, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

According to the heat-sensitive recording material described in <59>, since the heat-sensitive recording layer contains a specified electron-donating colorless dye, the sensitivity at a higher level, the background fogging suppression, and the storability can all be improved satisfactorily.

### BEST MODE FOR CARRYING OUT THE INVENTION

### First Embodiment

In the first embodiment of a heat-sensitive recording material of the present invention, the heat-sensitive recording material comprises a heat-sensitive recording layer of a coloration system containing an electron-donating colorless dye and an electron-accepting compound in combination and as the electron-accepting compound, a compound defined as R¹-Ph-SO₂R² is contained and the maximum value of the curl height of the heat-sensitive recording material itself is 5.0 mm or less.

Hereinafter, the first embodiment of the heat-sensitive recording material of the invention will be described more in details.

The first embodiment of the heat-sensitive recording material of the invention comprises one or two or more heat-sensitive recording layers on a support and preferably a protective layer. Furthermore, if required, the material may have other layers such as an intermediate layer, etc.

<Heat-Sensitive Recording Layer>

The heat-sensitive recording layer includes at least an electron-donating colorless dye and an electron-accepting compound that reacts with the electron-donating colorless dye to develop color, and preferably includes an image stabilizer (an ultraviolet light blocking agent), an inorganic pigment, an adhesive and a sensitizer. If required, the layer may include any other component.

Electron-Donating Colorless Dye

The heat-sensitive recording layer used in the invention includes an electron-donating colorless dye as a color-developing component. The electron-donating colorless dye can be selected from conventionally known dyes. Examples thereof include, for example, 2-anilino-3-methyl-6-diethylaminofluorane, 2-anilino-3-methyl-6-dibutylaminofluorane, 2-anilino-3-methyl-6-(N-ethyl-N-isoamylamino)fluorane, 2-anilino-3-methyl-6-(N-ethyl-N-propylamino)fluorane, 2-anilino-3-methyl-6-di-n-amylaminofluorane, 2-anilino-3-methyl-6-(N-ethyl-N-p-tolylamino)fluorane, 2-anilino-3-methyl-6-N-ethyl-N-sec-butylaminofluorane, 3-di-(n-pentylamino)-6-methyl-7-anilinofluorane, 3-(N-isoamyl-N-ethylamino)-6-methyl-7-anilinofluorane, 3-(N-n-hexyl-N-ethylamino)-6-methyl-7-anilinofluorane, 3-[N-(3-ethoxypropyl)-N-ethylamino]-6-methyl-7-anilinofluorane, 3-di-(n-butylamino)-7-(2-chloroanilino)fluorane, 3-diethylamino-7-(2-chloroanilino)fluorane, 3-(N-cyclohexyl-N-methylamino)-6-methyl-7-anilinofluorane, and the like.

Among these, it is specifically preferable to include at least one kind selected from the group consisting of 2-anilino-3-methyl-6-diethylaminofluorane, 2-anilino-3-methyl-6-dibutylaminofluorane, 2-anilino-3-methyl-6-(N-ethyl-N-isoamylamino)fluorane, 2-anilino-3-methyl-6-(N-ethyl-N-propylamino)fluorane, 2-anilino-3-methyl-6-di-n-amylaminofluorane and 2-anilino-3-methyl-6-(N-ethyl-N-p-tolylamino)fluorane. In addition, these electron-donating colorless dyes can be used alone or in combination in a single heat-sensitive recording layer.

Specifically, by including at least one kind of selected from the above-mentioned group as the electron-donating colorless dye, color development density can be increased while keeping background fogging at low level. In addition, the image storability of a formed image portion can be simultaneously improved.

In preparation of a coating solution for forming a heat-sensitive recording layer (hereinafter sometimes referred to as a “coating solution for a heat-sensitive recording layer”), the particle size (volume mean diameter) of the electron-donating colorless dye is preferably not more than 1.0 μm, and more preferably 0.4 to 0.7 μm. When the volume mean diameter exceeds 1.0 μm, heat sensitivity sometimes decreases, and, when the volume mean diameter is less than 0.4 μm, background fogging sometimes deteriorates.

The volume mean diameter can be easily measured by a laser diffraction type size distribution measuring instrument (e.g., trade name: LA500, manufactured by Horiba, Inc.), or the like.

The coating amount of the electron-donating colorless dye is preferably 0.1 to 1.0 g/m², and, in view of color development density and background fogging, more preferably 0.2 to 0.5 g/m².

Electron-Accepting Compound

The heat-sensitive recording layer used in the first embodiment of the invention includes at least one kind of the compound represented by general formula (1) as an electron-accepting compound that reacts with the electron-donating colorless dye during heating to develop color. In addition, in the third aspect, it is preferable to include this compound in the heat-sensitive recording layer. By including the compound as an electron-accepting compound, sensitivity can be increased while keeping background fogging at low level. Furthermore, long-term storability of a formed image (image storability), chemical resistance, inkjet applicability and a head matching property with respect to a thermal head can be simultaneously improved.
R¹-Ph-SO₂R² General formula (1)

In the formula, R¹ represents a hydroxyl group or an alkyl group, R² represents -Ph, —NH-Ph, -Ph-OH or —NH—CO—NH-Ph, and Ph represents a phenyl group, which is optionally substituted with a substituent having —SO₂R².

The alkyl group represented by R¹ is preferably an alkyl group having 1 to 3 carbon atoms, and more preferably a methyl group, an ethyl group, an isopropyl group, or the like. Among these, R¹ is specifically preferably a hydroxyl group.

Ph may be a substituted phenyl group wherein the phenyl group is substituted with a “substituent including —SO₂R²”, and R² of the substituent may be substituted with a methyl group, a halogen atom, or the like. Examples of the substituent include —CH₂—C₆H₅—NHCONH—SO₂—C₆H₅, —SO₂—C₆H₄—CH₃, —SO₂—C₆H₄—Cl, and the like. Furthermore, in the second to fourth aspects, the substituent can be —SO₂—C₆H₅.

Among these, R² is preferably —NH-Ph, and specifically preferably —NH—C₆H₅.

Preferable examples of the compound represented by general formula (1) include 4-hydroxybenzenesulfoneanilide (=p-N-phenylsulfamoylphenol), p-N-(2-chlorophenyl) sulfamoylphenol, p-N-3-tolylsulfamoylphenol, p-N-2-tolylsulfamoylphenol, p-N-(3-methoxyphenyl)sulfamoylphenol, p-N-(3-hydroxyphenyl) sulfamoylphenol, p-N-(4-hydroxyphenyl) sulfamoylphenol, 2-chloro-4-N-phenylsulfamoylphenol, 2-chloro-4-N-(3-hydroxyphenyl) sulfamoylphenol, 4′-hydroxy-p-toluenesulfoneanilide, 4,4′-bis (p-toluenesulfonylaminocarbonylamino)diphenylmethane (=BTUM), 4-hydroxy-4′-isopropoxydiphenylsulfone, and the like. However, in the invention, the compound of formula (1) is not limited to these compounds.

Among the electron-accepting compounds represented by general formula (1), 4-hydroxybenzenesulfoneanilide is the most preferable in view of balance between image storability and background fogging.

The amount of the electron-accepting compound in a single heat-sensitive recording layer is preferably 50 to 400% by mass, and more preferably 100 to 300% by mass relative to the mass of the electron-donating colorless dye.

Any other known electron-accepting compound may be used in combination with the electron-accepting compound represented by general formula (1), so long as the effects of the invention (specifically decrease in background fogging level, improvement in sensitivity, and improvements in image storability, chemical resistance and a head matching property) are not deteriorated.

The known electron-accepting compound is properly selected and used. It is spedicfically preferably a phenolic compound or a salicylic acid derivative or a polyvalent metal salt thereof from the viewpoint of suppression of background fogging.

2,2′-bis(4-hydroxyphenol)propane (bisphenol A), 4-t-butylphenol, 4-phenylphenol, 4-hydroxydiphenoxide, 1,1′-bis(4-hydroxyphenyl)cyclohexane, 1,1′-bis(3-chloro-4-hydroxyphenyl)cyclohexane, 1,1′-bis(3-chloro-4-hydroxyphenyl)-2-ethylbutane, 4,4′-sec-isoctylidenediphenol, 4,4′-sec-butylidenediphenol, 4-tert-octylphenol, 4-p-methylphenylphenol, 4,4′-methylcyclohexylidenephenol, 4,4′-isopentylidenephenol, 4-hydroxy-4-isopropyloxydiphenylsulfone, benzyl p-hydroxybenzoate, and the like. 4-pentadecylsalicylic acid, 3,5-di-(α-methylbenzyl) salicylic acid, 3,5-di-(tert-octyl)salicylic acid, 5-octadecylsalicylic acid, 5-α-(p-α-methylbenzylphenyl)ethylsalicylic acid, 3-α-methylbenzyl-5-tert-octylsalicylic acid, 5-tetradecylsalicylic acid, 4-hexyloxysalicylic acid, 4-cyclohexyloxysalicylic acid, 4-decyloxysalicylic acid, 4-dodecyloxysalicylic acid, 4-pentadecyloxysalicylic acid, 4-octadecyloxysalicylic acid, and the like, and zinc salts, aluminum salts, calcium salts, copper salts and lead salts thereof, and the like.

When the known electron-accepting compound is used in combination with the compound of formula (1), the amount of the electron-accepting compound represented by general formula (1) is preferably not less than 50% by mass, and specifically preferably not less than 70% by mass relative to the total mass of the electron-accepting compounds.

In preparation of a coating solution for forming a heat-sensitive recording layer, the particle size (volume mean diameter) of the electron-accepting compound is preferably not more than 1.0 μm, and more preferably 0.4 to 0.7 μm. When the volume mean diameter exceeds 1.0 μm, heat sensitivity sometimes decreases. When the volume mean diameter is less than 0.4 μm, background fogging sometimes deteriorates.

The volume mean diameter can also be readily measured by using a laser diffraction type size distribution measuring instrument (e.g., LA500 manufactured by Horiba, Inc.), or the like.

Sensitizer

used in the invention preferably includes a sensitizer. Specifically, in view of further improvement in sensitivity, the layer preferably includes at least one kind selected from the group consisting of 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane and diphenylsulfone (hereinafter sometimes referred to as “sensitizer according to the invention”).

The total amount of the sensitizer selected in the heat-sensitive recording layer is preferably 75 to 200 parts by mass, and more preferably 100 to 150 parts by mass relative to 100 parts by mass of the electron-accepting compound.

When the sensitizer is contained in the layer such that the amount of the sensitizer is suitable for the amount of the electron-accepting compound, sensitivity can be effectively improved without deterioration of other characteristics.

When the amount is in the above-mentioned range, the effect of improvement in sensitivity can be large. Furthermore, image storability, heat resistance and moisture resistance can also be improved.

Any other sensitizer selected from conventionally known ones can be used in combination with the sensitizer selected from the above-mentioned group, so long as the effects of the invention are not deteriorated.

When a conventional sensitizer is used in combination, the amount of the sensitizer selected from the above-mentioned group is preferably not less than 50% by mass, and more preferably not less than 70% by mass relative to the total amount of the sensitizers included in the layer.

Examples of other sensitizer include, for example, aliphatic monoamide, aliphatic bisamide, stearylurea, di(2-methylphenoxy)ethane, di(2-methoxyphenoxy)ethane, β-naphthol(p-methylbenzyl)ether, α-naphthylbenzylether, 1,4-butanediol-p-methylphenylether, 1,4-butanediol-p-isopropylphenylether, 1,4-butanediol-p-tert-octylphenylether, 1-phenoxy-2-(4-ethylphenoxy)ethane, 1-phenoxy-2-(chlorophenoxy)ethane, 1,4-butanediolphenylether, diethyleneglycolbis(4-methoxyphenyl)ether, 1,4-bis(phenoxymethyl)benzene, and the like.

Image Stabilizer (Ultraviolet Light Absorbent)

The heat-sensitive recording layer used in the invention preferably includes an image stabilizer (including an ultraviolet light absorbent). The ultraviolet light absorbent may be microcapsuled. By incorporating the image stabilizer, storability of a developed image (image storability) can be further improved.

As the image stabilizer, for example, a phenol compound, specifically a hindered phenol compound is effective. Examples thereof include, for example, 1,1,3-tris(2-methyl-4-hydroxy-5-tert-butylphenyl)butane, 1,1,3-tris(2-methyl-4-hydroxy-5-cyclohexylphenyl)butane, 1,1,3-tris(2-ethyl-4-hydroxy-5-cyclohexylphenyl)butane, 1,1,3-tris(3,5-di-tert-butyl-4-hydroxyphenyl)butane, 1,1,3-tris(2-methyl-4-hydroxy-5-tert-butylphenyl)propane, 2,2′-methylene-bis(6-tert-butyl-4-methylphenol), 2,2′-methylene-bis(6-tert-butyl-4-ethylphenol), 4,4′-butylidene-bis(6-tert-butyl-3-methylphenol), 4,4′-thio-bis(3-methyl-6-tert-butylphenol), and the like. These image stabilizers can be used alone or in combination.

Among these, 1,1,3-tris(2-methyl-4-hydroxy-5-tert-butylphenyl)butane and 1,1,3-tris(2-methyl-4-hydroxy-5-cyclohexylphenyl)butane are specifically preferred.

The total amount of the image stabilizer in a single heat-sensitive recording layer is preferably 10 to 100 parts by mass, and more preferably 20 to 60 parts by mass relative to 100 parts by mass of the electron-donating colorless dye in view of suppression of background fogging and effective improvement in image storability.

Moreover, when any of the above-mentioned image stabilizers other than 1,1,3-tris(2-methyl-4-hydroxy-5-tert-butylphenyl) butane and 1,1,3-tris(2-methyl-4-hydroxy-5-cyclohexylphenyl)butane is used in combination with at least one of the two image stabilizers, the amount of 1,1,3-tris(2-methyl-4-hydroxy-5-tert-butylphenyl)butane and/or 1,1,3-tris(2-methyl-4-hydroxy-5-cyclohexylphenyl)butane in a single heat-sensitive recording layer is preferably at least 50% by mass, and more preferably at least 70% by mass relative to the total mass of the image stabilizers.

Examples of the ultraviolet light absorbent include the ultraviolet light absorbents shown below.

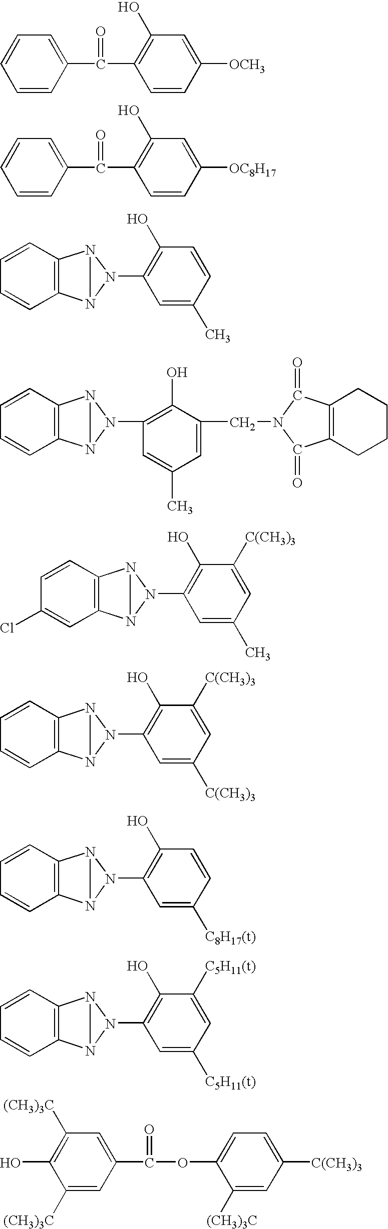

The amount of the ultraviolet light absorbent in a single heat-sensitive recording layer is preferably 10 to 300 parts by mass, and more preferably 30 to 200 parts by mass relative to 100 parts by mass of the electron-donating colorless dye from the viewpoint of effective improvement in image storability.

Inorganic Pigment

The heat-sensitive recording layer of in the first embodiment of the invention preferably includes an inorganic pigment, specifically at least one kind selected from calcite calcium carbonate, amorphous silica and aluminum hydroxide (inorganic pigments according to the invention). By incorporating the inorganic pigment, a head matching property with respect to a thermal head with which the layer is brought into contact can be further improved. At the same time, stamping applicability, printing applicability and plain paper-like property can be provided.

(Light) calcium carbonate generally has crystalline forms of calcite, aragonite, baterite, and the like. Among these, calcite (light) calcium carbonate is preferred in view of color development density and prevention of head stain when recording is conducted with a thermal head and in view of an absorbing property, hardness, or the like. Among these, those having a spindle-like or scalenohedron-like particle shape are specifically preferred. The calcite (light) calcium carbonate can be prepared by a conventional preparation method.

The average particle size (volume mean diameter) of the calcite (light) calcium carbonate is preferably 1 to 3 μm. The volume mean diameter can be measured in the same manner as the method for measuring the volume mean diameter of the electron-donating colorless dye, or the like.

The amount of the “inorganic pigment according to the invention” in a single heat-sensitive recording layer is preferably 50 to 500 parts by mass, more preferably 70 to 350 parts by mass, and specifically preferably 90 to 250 parts by mass relative to 100 parts by mass of the electron-accepting compound in view of improvement in color development density and prevention of adhesion of foregin matter to a thermal head.

Furthermore, any other inorganic pigment can be used in combination with the above-mentioned inorganic pigment according to the invention to such an extent that the effects of the invention (specifically improvement in a head matching property, printing applicability and plain paper-like property) are not deteriorated.

Examples of any other inorganic pigment include calcium carbonate other than calcite (light) calcium carbonate, barium sulfate, lithpone, agalmatolite, kaolin, calcined kaolin, magnesium carbonate, magnesium oxide, and the like.

The volume mean diameter of any other inorganic pigment measured by a laser diffraction type size distribution measuring instrument (e.g., LA500 manufactured by Horiba, Inc., or the like) is preferably 0.3 to 1.5 μm, and more preferably 0.5 to 0.9 μm.

When the inorganic pigment according to the invention is used in combination with any other inorganic pigment, the ratio of the total mass (V) of the “inorganic pigment according to the invention” and the total mass (W) of any other inorganic pigment (V/W) is preferably 100/0 to 60/40, and more preferably 100/0 to 80/20.

Furthermore, an inorganic pigment having Mohs hardness of not more than 3 is preferred in view of suppression of abrasion of a thermal head. The “Mohs hardness” means Mohs hardness described in “English-Japanese Plastic Industrial Dictionary, 5^{th} eddition, p. 616” (Shin Ogawa, Kogyo Chosakai Publishing Co., Ltd.). Examples of the inorganic pigment having Mohs hardness of not more than 3 include calcium carbonate, aluminum hydroxide, and the like.

A mixture of the inorganic pigment according to the invention and magnesium carbonate and/or magnesium oxide is preferable since it is effective in suppression of background fogging. The content of magnesium carbonate and/or magnesium oxide is preferably 3 to 50% by mass, and specifically preferably 5 to 30% by mass relative to the total mass of the inorganic pigments.

Adhesive

The heat-sensitive recording layer used in the first embodiment of the invention preferably includes, as an adhesive (or a protective colloid at the time of dispersion), at least one kind selected from sulfo-modified polyvinyl alcohol, diacetone-modified polyvinyl alcohol and acetoacetyl-modified polyvinyl alcohol (i.e., modified polyvinyl alcohols (hereinafter sometimes referred to as “specific modified PVA”). By incorporating the specific modified PVA in the heat-sensitive recording layer as an adhesive, plain paper-like feeling can be provided, and adhesive force between the heat-sensitive recording layer and the substrate can be increased to prevent troubles such as peeling of paper that may occur during offset printing, or the like, which can lead to improvement in printing applicability. Furthermore, color development density when the recording material is recorded with a thermal head can be increased while background fogging is more suppressed during recording, which can lead compatibility between improvement in sensitivity and further decrease in background fogging at high level.

The specific modified PVAs can be used alone or in combination, or in combination with any other modified PVA or polyvinyl alcohol (PVA).

When any other modified PVA or PVA is used in combination, the rate of the specific modified PVA is preferably not less than 10% by mass, and more preferably not less than 20% by mass relative to the total mass of the adhesive components.

The specific modified PVA is preferably one having a saponification degree of 85 to 99% by mole.

When the saponification degree is less than 85% by mole, water resistance against danmpening water used during offset printing is insufficient, which tends to cause so-called peeling of paper. On the other hand, when the amount of the modified PVA to be added is increased in order to avoid such peeling of paper, color development density sometimes decreases. Furthermore, when the saponification degree exceeds 99% by mole, unsolved products tend to remain during preparation of a coating solution, which sometimes results in a defective coating film.

For the purpose of avoiding deterioration of the effects of the invention, when any other modified PVA and/or PVA is used in combination, the saponification degree of any other modified PVA and/or PVA is preferably in the above-mentioned range.

Specifically, the polymerization degree of the specific modified PVA is preferably 200 to 2000.

When the polymerization degree is less than 200, peeling of paper easily occurs during offset printing. Furthermore, when the addition amount thereof is increased in order to avoid such peeling of paper, color development density sometimes decreases. Furthermore, when the polymerization degree exceeds 2000, the modified PVA becomes hardly-soluble in a solvent (water), and the viscosity of liquid during preparation increases, which makes preparation of a coating solution for forming a heat-sensitive recording layer and the application thereof difficult.

For the purpose of avoiding deterioration of the effects of the invention, when any other modified PVA and/or PVA is used in combination, the polymerization degree of any other modified PVA and/or PVA is preferably in the above-mentioned range.

The polymerization degree used herein refers to an average polymerization degree obtained by the method described in JIS-K6726 (1994).

The content of the specific modified PVA in the heat-sensitive recording layer is preferably 30 to 300 parts by mass, more preferably 70 to 200 parts by mass, and specifically preferably 100 to 170 parts by mass relative to 100 parts by mass of the electron-donating colorless dye in view of improvement in color development density and provision of offset printing applicability (prevention of peeling of paper, or the like).

The specific modified PVA functions not only as an adhesive for increasing adhesive force between layers but also as a dispersing agent, a binder, and the like.

Next, each of the specific modified PVAs, i.e., sulfo-modified polyvinyl alcohol, diacetone-modified polyvinyl alcohol and acetoacetyl-modified polyvinyl alcohol will be specifically explained.

The sulfo-modified polyvinyl alcohol can be prepared by a method including: copolymerizing an olefinsulfonic acid or a salt thereof such as ethylenesulfonic acid, allylsulfonic acid, methallylsulfonic acid, or the like with a vinylester such as vinyl acetate, or the like in an alcohol or a mixed solvent of an alcohol and water to form a polymer and saponifying the obtained polymer; a method including: copolymerizing an amide sodium salt and a vinyl ester such as vinyl acetate, or the like and saponifying the obtained polymer; a method including: treating PVA with bromine, iodine, or the like and heating the treated PVA in an acidic aqueous sodium sulfite solution; a method including: heating PVA in a concentrated aqueous sulfuric acid solution; a method including: acetalating PVA with an aldehyde compound including a sulfonic acid group; or the like.

The diacetone-modified polyvinyl alcohol is a partially or completely saponified product of a copolymer of a monomer having a diacetone group and a vinyl ester, and can be prepared by a method including: copolymerizing the monomer having a diacetone group and the vinyl ester to form a resin and saponifying the obtained resin.

The proportion of the monomer having a diacetone group (repeating unit structure) in the diacetone-modified polyvinyl alcohol is not specifically limited.

The acetoacetyl-modified polyvinyl alcohol can be generally prepared by adding liquid or gaseous diketene to a solution, a dispersion liquid or powder of a polyvinyl alcohol resin to cause the diketene to react with the resin. The acetylation degree of the acetoacetyl-modified polyvinyl alcohol can be suitably selected according to the desired quality of an objective heat-sensitive recording material.

Other Component

The heat-sensitive recording layer used in the first embodiment of the invention may include, according to the purpose or need, other components such as a cross-linking agent, any other pigment, a metal soap, wax, a surfactant, a binder, an antistatic agent, a defoaming agent, a fluorescence dye, and the like as well as the above-mentioned components.

[Cross-Linking Agent]

The heat-sensitive recording layer may include a cross-linking agent that reacts with the specific modified PVA, and/or any other modified PVA used as an adhesive (or a protective colloid) and the like. By incorporating such a cross-linking agent, water resistance of the heat-sensitive recording material can be improved.

The cross-linking agent can be suitably selected from cross-linking agents which can cross-link the specific modified PVA (and preferably the above-mentioned other modified PVA, and the like). Among these, an aldehyde compound such as glyoxal, or the like, a dihydrazide compound such as adipic acid dihydrazide, or the like is specifically preferred.

The content of the cross-linking agent in the heat-sensitive recording layer is preferably 1 to 50 parts by mass, and more preferably 3 to 20 parts by mass relative to 100 parts by mass of the specific modified PVA, other modified PVA and the like to be cross-linked. When the content of the cross-linking agent is in the above-mentioned range, water resistance can be effectively improved.

[Mordant]

The heat-sensitive recording layer may include a mordant for the purpose of preventing bleeding at the time of ink jet recording.

Examples of the mordant include compounds having at least one cationic group selected from an amide group, an imide group, a primary amino group, a secondary amino group, a tertiary amino group, a primary ammonium salt group, a secondary ammonium salt group, a tertiary ammonium salt group and a quatenary ammonium salt group.

Specific examples thereof include polyamide epichlorohydrin, polyvinylbenzyltrimethylammonium chloride, polydiallyldimethylammonium chloride, polymethacryloyloxyethyl-p-hydroxyethyldimethylammonium chloride, polydimethylaminoethylmethacrylate hydrochloride, polyethyleneimine, polyallylamine, polyallylamine hydrochloride, polyamide-polyamine resins, cationated starch, dicyanodiamide-formalin condensates, dimethyl-2-hydroxypropylammonium salt polymers, and the like.

Beside the above-mentioned polymers, a cationic polymer is also preferred. Examples of such a cationic polymer include, for example, polyethyleneimine, polydiallylamine, polyallylamine, polydiallyldimethylammonium chloride, polymethacryloyloxyethyl-p-hydroxyethyldimethylammonium chloride, polyallylamine hydrochloride, polyamide-polyamine resins, cationated starch, dicyanodiamide formalin condensates, dimethyl-2-hydroxypropylammonium salt polymers, polyamidine, polyvinylamine, and the like.

The molecular weight of the mordant is preferably about 1000 to 200000. When the molecular weight is less than 1000, water resistance tends to become insufficient, and, when the molecular weight exceeds 200000, viscosity increases, which sometimes leads to bad handling applicability.

The cationic polymer may be contained in either the heat-sensitive recording layer or the protective layer described later.

[Metal Soap, Wax and Surfactant]

The metal soap can be a higher fatty acid metal salt, and specifically zinc stearate, calcium stearate, aluminum stearate or the like.

Examples of wax include, for example, paraffin wax, microcrystalline wax, carnauba wax, methylolstearoamide, polyethylene wax, polystyrene wax, fatty acid amide wax, and the like. These can be used alone or in combination.

The surfactant can be, for example, an alkali metal salt of a sulfosuccinic acid, a fluorine-containing surfactant, or the like.

[Binder]

The electron-donating colorless dye, the electron-accepting compound, the inorganic pigment, the adhesive and the sensitizer, and other components can be suitably dispersed in a water-soluble binder. The binder used herein is preferably a compound that can be dissolved by not less than 5% by mass in water at 25° C. Specific examples of the binder include polyvinyl alcohol, methylcellulose, carboxymethylcellulose, starchs (including modified starchs), gelatin, gum arabic, casein, a saponified product of a styrene-maleic anhydride copolymer, and the like.

The binder not only functions as a material in which substances are dispersed but also functions to improve film strength of the heat-sensitive recording layer. In order to exhibit such function, a synthetic polymer latex binder such as a styrene-butadiene copolymer, a vinyl acetate copolymer, an acrylonitrile-butadiene copolymer, a methyl acrylate-butadiene copolymer, polyvinylidene chloride, or the like can be used in combination with the above-mentioned binder.

Others

The electron-donating colorless dye, the electron-accepting compound, the inorganic pigment, the adhesive and the sensitizer can be simultaneously or separately dispersed with a stirrer or a crusher such as a ball mill, an attritor, a sand mill, or the like and then a coating solution is prepared. If neccesary, the coating solution may include the above-mentioned other components, i.e., a cross-linking agent, a mordant, a metal soap, wax, a surfactant, a binder, an antistatic agent, a defoaming agent, a fluorescence dye and the like.

As mentioned above, the coating solution is prepared and applied onto the surface of a support, whereby a heat-sensitive recording layer is formed. The coating method for applying the coating solution is not specifically limited, and may be suitably selected from coating methods using an air knife coater, a roll coater, a blade coater, a curtain coater, or the like. After the application, the resultant coating is dried, and the dried coating is subjected to smoothing treatment, preferably calendar treatment, and the resultant material is used.

The dried coating amount of the coating solution for forming a heat-sensitive recording layer is preferably less than 6 g/m², more preferably not more than 5 g/m² a curtain coating method using a curtain coater is specifically preferred. The reasons for this are as follows. The components can be concentrated on a recording surface. Moreover, high density (high sensitivity) can be obtained even when smaller amounts of materials are used. Furthermore, image quality can be simultaneously improved. When a layer or layers other than a heat-sensitive recording layer, such a protecitve layer, are laminated as mentioned later, the amount of energy consumed during preparation can be further decreased by simultaneously applying multiple layers by a curtain coating method. A specific example of such a method is as follows.

The heat-sensitive recording material is preferably prepared by applying at least one coating solution onto the surface of a substrate by a curtain coating method to form a part or whole of one or more layers to be provided on the substrate and drying the formed layer(s). The layers formed by a curtain coating method are not specifically limited, and specific examples thereof include a undercoat layer, a heat-sensitive recording layer, a protective layer, and the like. In a preferred embodiment, a series of layers which adjoin each other are simultaneously applied by a curtain coating method.

Specific examples of combinations of layers to be simultaneously applied include, but are not limited to, a combination of a undercoat layer and a heat-sensitive recording layer, a combination of a heat-sensitive recording layer and a protective layer, a combination of a undercoat layer, a heat-sensitive recording layer and a protective layer, a combination of two or more of different kinds of undercoat layers, a combination of two or more of different kinds of heat-sensitive recording layers, a combination of two or more of different kinds of protective layers, and the like.

Examples of a curtain coating apparatus used in a curtain coating method include, but are not limited to, an extrusion hopper type curtain coating apparatus, a slide hopper type curtain coating apparatus, and the like. Among these, a slide hopper type curtain coating apparatus described in Japanese Patent Application Publication (JP-B) No. 49-24133, which is used in preparation of photographic photosensitive materials, is specifically preferred. By using the slide hopper type curtain coating apparatus, it is easy to simultaneously apply a plurality of layers.

In the first embodiment of the heat-sensitive recording material of the invention, in terms of prevention of transportation failure in a printer or unbalanced accumulation of sheets after printing, the maximum value of the curl height of the heat-sensitive recording material curved and coming up from the plane where the heat-sensitive recording material is placed is adjusted to be 5.0 mm or less. Here, the curl height means the distance between the flat plane where one surface of the heat-sensitive recording material is placed still appressedly (e.g. the surface where no heat-sensitive recording layer is formed) and the surface of the portions of the heat-sensitive recording material curved and coming up from the flat plane (e.g. four corners of the heat-sensitive recording material), that is, the side of the surface at which no heat-sensitive recording layer in the portion. The distance is approximately same as the distance from the heat-sensitive recording material surface which is not curved on the flat plane to the portions of the heat-sensitive recording material curled up from the flat plane.

By adjusting the maximum value of the curl height to be 5.0 mm or less, the transportation property in a printer and the accumulation of sheets (of the heat-sensitive recording material) after printing can be kept good and according the heat-sensitive recording material with excellent handling easiness can be obtained. It is more preferable to adjust the height of the curl height to be 4.0 mm or less.

To adjust the curl height in the above-mentioned range, it is preferable to employ a method of applying a back liquid to the surface of the support where the heat-sensitive recording layer is not formed.

Hereinafter, the back liquid will be described in details

[Back Liquid]

As the above-mentioned back liquid, besides water, an aqueous solution containing a binder, a surfactant, an antistatic agent and the like in water is preferable. Examples of the binder may include polyvinyl alcohol, carboxy-modified polyvinyl alcohol, vinyl acetate-acrylamide copolymer, silicon-modified polyvinyl alcohol, starch, modified starch, methylcellulose, carboxymethylcellulose, hydroxymethylcellulose, gelatins, gum arabi, casein, hydrolyzed product of styrene-maleic acid copolymer, polyacrylamide derivatives, polyvinylpyrrolidone, latexes such as styrene-butadiene rubber latex, acrylonitrile-butadiene rubber latex, methyl acrylate-butadiene rubber latex, and vinyl acetate emulsion.

Examples of the surfactant are alkylbenzenesulfonic acid salts such as sodium dodecylbenzenesulfonate; sulfosuccinic acid alkyl ester salt such as dioctyl sulfosuccinate sodium salt; polyoxyethylene alkyl ether phosphoric acid ester; sodium hexametaphosphate; and perfluoroalkylcarboxylic acid. Examples of the antistatic agent are inorganic salts such as sodium chloride; anionic electrolytic polymers such as sodium polystyrenesulfonate; and conductive metal compounds such as conductive zinc oxide and tin oxide.

The absolute value of the application amount of the above-mentioned back liquid is not particularly limited and can be selected in a proper range so as to adjust the maximum value of the curl height (especially four corners) of the heat-sensitive recording material to be 5.0 mm or less. For coating the back liquid, known methods can be employed.

Practically, methods using an air knife coater, a roll coater, a gravure coater and the like can be employed and among them, a coating method using the air knife coater or the gravure coater is preferable. In the case of the method using such a coater, application may be carried out by using an off-machine coater or an on-machine coater.

<Protective Layer>

At least one protective layer is preferably disposed on the heat-sensitive recording layer. The protective layer may include organic or inorganic micropowder, a binder, a surfactant, a heat-melting substance, and the like.

Examples of the micropowder include, for example, inorganic micropowder such as calcium carbonate, silicas, zinc oxide, titanium oxide, aluminum hydroxide, zinc hydroxide, barium sulfate, kaolin, clay, talc, surface-treated calcium and silica, and the like, and organic micropowder such as a urea-formalin resin, a styrene/methacrylic acid copolymer, polystyrene, and the like.

Examples of the binder to be included in the protective layer include, for example, polyvinyl alcohol, carboxy-modified polyvinyl alcohol, a vinyl acetate-acrylamide copolymer, silicon-modified polyvinylalcohol, starch, modified starch, methylcellulose, carboxymethylcellulose, hydroxymethylcellulose, gelatins, gum arabic, casein, a styrene-maleic acid copolymer hydrolysate, polyacrylamide derivatives and polyvinylpyrrolidone, and latexes such as a styrene-butadiene rubber latex, an acrylonitrile-butadiene rubber latex, a methyl acrylate-butadiene rubber latex, a vinyl acetate emulsion, and the like.

In a preferred embodiment, the protective layer may contain a waterproofing agent for cross-linking a binder component in the protective layer to further improve storage stability of the heat-sensitive recording material. Examples of the waterproofing agent include, for example, N-methylolurea, N-methylolmelamine, water-soluble initial condensates such as urea-formalin, and the like, dialdehyde compounds such as glyoxal, glutalaldehyde, and the like, inorganic cross-linking agents such as boric acid, borax, colloidal silica, and the like, polyamide epichlorohydrin, and the like.

In a specifically preferred embodiment, the protective layer includes at least one inorganic pigment selected from aluminum hydroxide, kaolin and amorphous silica, and a water-soluble polymer. Such an embodiment can have improved storability due to the oil-absorbing property of the inorganic pigment, or the like, and can have handling property and stamping applicability (plain paper-like feeling). In addition, the protective layer may also include a surfactant, a heat-melting substance, and the like.

The volume mean diameter of the inorganic pigment to be included in the protective layer is preferably 0.5 to 3 μm, and more preferably 0.7 to 2.5 μm. Specifically, aluminum hydroxide having a volume mean diameter of 0.5 to 1.2 μm is preferred in view of improvement in stamping applicability, and amorphous silica is preferred in view of improvement in ink jet applicability. The volume mean diameter can be measured in the same manner as the method for measuring the volume mean diameter of the electron-donating colorless dye, or the like.

aluminum hydroxide, kaolin and amorphous silica is preferably 10 to 90% by mass, and more preferably 30 to 70% by mass relative to the total solid content (mass) of the coating solution for forming a protective layer. Furthermore, any other pigment such as barium sulfate, zinc sulfate, talc, clay, colloidal silica, or the like can be used in combination with aluminum hydroxide, kaolin, or amorphous silica, so long as the effects of the invention (specifically improvement in storability, and provision of a handling property and stamping applicability) are not deteriorated.

Examples of the water-soluble polymer include, among the above-mentioned binders, polyvinyl alcohol and modified polyvinyl alcohols (hereinafter generally referred to as “polyvinyl alcohol”), starch, modified starch such as oxidized starch, urea phosphate esterified starch, and the like, carboxyl group-containing polymers such as a styrene-maleic anhydride copolymer, an alkyl esterified product of a styrene-maleic anhydride copolymer, a styrene-acrylic acid copolymer, and the like. Among these, polyvinyl alcohol, oxidized starch, urea phosphate esterified starch are preferred in view of stamping applicability, and a mixture of polyvinyl alcohol (x) and oxidized starch and/or urea phosphate esterified starch (y) at a mass ratio (x/y) of 90/10 to 10/90 is specifically preferred. Specifically, when polyvinyl alcohol, oxidized starch and urea phosphate esterified starch are used in combination, the mass ratio (y¹/y²) of oxidized starch (y¹) and urea phosphate esterified starch (y²) is preferably 10/90 to 90/10.

The modified polyvinyl alcohol is preferably acetoacetyl-modified polyvinyl alcohol, diacetone-modified polyvinyl alcohol, silicon-modified polyvinyl alcohol and amide-modified polyvinyl alcohol. In addition, sulfo-modified polyvinyl alcohol, carboxy-modified polyvinyl alcohol, and the like are also used.

Furthermore, use of a cross-linking agent that reacts with polyvinyl alcohol can further improve storability, a handling property and stamping applicability.

The rate of the water-soluble polymer is preferably 10 to 90% by mass, and more preferably 30 to 70% by mass relative to the total solid content (mass) of a coating solution for forming a protective layer.

Preferable examples of the cross-linking agent for cross-linking the water-soluble polymer include polyvalent amine compounds such as ethylenediamine, and the like, polyvalent aldehyde compounds such as glyoxal, glutalaldehyde, dialdehyde, and the like, dihydrazide compounds such as adipic acid dihydrazide, phthalic acid dihydrazide, and the like, water-soluble methylol compounds (urea, melamine and phenol), multifunctional epoxy compounds, polyvalent metal salts (Al, Ti, Zr, Mg, and the like), and the like. Among these, polyvalent aldehyde compounds, and dihydrazide compounds are preferred.

The content of the cross-linking agent is preferably about 2 to 30% by mass, and more preferably 5 to 20% by mass relative to the mass of the water-soluble polymer. By incorporating the cross-linking agent, film strength, water resistance, and the like can be further improved.

The mixing ratio of the inorganic pigment selected from aluminum hydroxide, kaolin and amorphous silica and the water-soluble polymer in the protective layer depends on the kind and the particle size of the inorganic pigment, the kind of the water-soluble polymer, and the like, and the amount of the water-soluble polymer is preferably 50 to 400% by mass, and more preferably 100 to 250% by mass relative to the mass of the inorganic pigment.

The total mass of the inorganic pigment and the water-soluble polymer in the protective layer is preferably not less than 50% by mass of the total solid mass of the protective layer.

In a preferred embodiment, the protective layer, i.e., a coating solution for forming a protective layer (hereinafter sometimes referred to as “coating solution for a protective layer”) may contain a surfactant in view of improvement in ink jet ink applicability.

Preferable examples of the surfactant include alkylbenzenesulfonates such as sodium dodecylbenzenesulfonate, and the like, alkyl sulfosuccinates such as sodium dioctylsulfosuccinate, and the like, polyoxyethylene alkyl ether phosphates, sodium hexametaphosphate, perfluoroalkylcarboxylates, and the like. Among these, alkyl sulfosuccinates are more preferred.

The content of the surfactant is preferably 0.1 to 5% by mass, and more preferably 0.5 to 3% by mass relative to the total solid mass of the coating solution for forming a protective layer.

The coating solution for a protective layer can be prepared by dissolving or dispersing the inorganic pigment selected from aluminum hydroxide, kaolin and amorphous silica, and water-soluble polymer, and if required, a cross-linking agent, a surfactant, and the like in a desired water-based solvent. The coating solution may include a lubricant, a defoaming agent, a fluorescent brightening agent, a colored organic pigment, and the like, so long as the effects of the invention (specifically improvement in storability and provision of a handling property and stamping applicability) are not deteriorated.

Examples of the lubricant include, for example, metal soaps such as zinc stearate, calcium stearate, and the like, wax such as paraffin wax, microcrystalline wax, carnauba wax, and synthetic polymer wax, and the like.

Support

Conventionally known supports can be applied to the support. Specific examples tehreof include support support paper supports such as woodfree paper, and the like, coated paper in which paper is coated with a resin or a pigment, paper on which a resin layer is laminated, woodfree paper having a undercoat layer, synthetic paper, plastic films, and the like. A support including recycled pulp as a main component, i.e. a support in which the mass of recycled pulp is 50% by mass of the components of the support can be also used.

The support is preferably a smooth support having smoothness defined by JIS-P8119 in the range of 300 seconds to 500 seconds in view of dot reproducibility. Furthermore, for the same reason, the smoothness of the support defined by JIS-P8119 is more preferably not less than 100 seconds, and still more preferably not less than 150 seconds.

The recycled pulp is made by the combination of the following three steps 1) to 3).
1) Maceration . . . treating recycled paper with mechanical force and a chemical agent using a pulper to form fibers, and separating printing ink from the fibers.
2) Dust removal . . . removing foreign substances (plastic, and the like) and dusts contained in the recycled paper.
3) Deinking . . . removing the printing ink which has been separated from the fibers out of the system by a floatation method or a washing method.

If desired, bleaching can be carried out simultaneously with deinking or in another step.

A support for a heat-sensitive recording material is made of the thus-obtained recycled pulp (100% by mass) or a mixture of recycled pulp and virgin pulp (the content of the virgin pulp is less than 50% by mass) by a conventional method support.

A undercoat layer may be disposed on the support. In this case, the undercoat layer is preferably provided on a surface of a support having a Stockigt size of not less than 5 seconds, and the undercoat layer is preferably mainly made of a pigment and a binder.

As the pigment in the undercoat layer, all of general inorganic and organic pigments can be used, and an oil-absorbing pigment having an oil absorbency defined by JIS-K5101 of not less than 40 ml/100 g (cc/100 g) is specifically preferred. Specific examples of the oil-absorbing pigment include calcined kaolin, aluminum oxide, magnesium carbonate, calcined diatomaceous earth, aluminum silicate, magnesium aluminosilicate, calcium carbonate, barium sulfate, aluminum hydroxide, kaolin, calcined kaolin, amorphous silica, urea-formalin resin powder, and the like. Among these, calcined kaolin having an oil absorbency of 70 ml/100 g to 80 ml/100 g is specifically preferred.

The coating amount of the pigment during application and formation of a undercoat layer on a support is preferably not less than 2 g/m², more preferably not less than 4 g/m², and specifically preferably 7 to 12 g/m².

Examples of the binder of the undercoat layer include water-soluble polymers and aqueous binders. These may be used alone or in combination.

Examples of the water-soluble polymer include, for example, starch, polyvinyl alcohol, polyacrylamide, carboxymethylcellulose, methylcellulose, casein, and the like. The aqueous binder is generally a synthetic rubber latex or a synthetic resine emulsion, and examples thereof include, for example, a styrene-butadiene rubber latex, an acrylonitrile-butadiene rubber latex, a methyl acrylate-butadiene rubber latex, a vinyl acetate emulsion, and the like.

The amount of the binder used in the undercoat layer is determined in accordance with the film strength, the heat sensitivity of a heat-sensitive-color developing layer, or the like, and is preferably 3 to 100% by mass, more preferably 5 to 50% by mass, and specifically preferably 8 to 15% by mass relative to the mass of the pigment in the undercoat layer. The undercoat layer may include wax, a color fading preventing agent, a surfactant, and the like.

A coating solution for forming a undercoat layer can be applied according to a known coating method. Specific examples of such a method include coating methods using an air knife coater, a roll coater, a blade coater, a gravure coater, a curtain coater, or the like. Among these, a coating method using a curtain coater or a blade coater is preferable, and a coating method using a blade coater is more preferable. After application and drying, the undercoat layer may be subjected to smoothing treatment such as calendaring, and the like, if necessary undercoat layer.

The method using the blade coater is not limited to coating methods using a bevel type blade or a bent type blade, and examples of the method include a coating method using a rod blade, a coating method using a bill blade, and the like. Furthermore, the coating method is not limited to methods using an off-machine coater, and coating can be carried out using an on-machine coater provided on a paper machine. In addition, in order to obtain superior smoothness and surface state by providing flowability to a undercoat layer during blade coating, the coating solution for forming a undercoat layer (a coating solution for an undercoat layer) may include carboxymethylcellulose having an etherification degree of 0.6 to 0.8 and an weight average molecular weight of 20000 to 200000 in an amount of 1 to 5% by mass, and preferably 1 to 3% by mass relative to the amount of the pigment.

The coating amount of the undercoat layer is not specifically limited, and is preferably not less than 2 g/m², more preferably not less than 4 g/m², and specifically preferably not less than 7 to 12 g/m² in accordance with characteristics of the heat-sensitive recording material.

In the invention, primer base paper having a undercoat layer (specifically preferably a undercoat layer having a high oil-absorbing property, a high adiabatic effect and high flatness) is preferred, and primer base paper having a undercoat layer which includes an oil-absorbing pigment and which has been made using a blade coater is specifically preferred in view of improvement in a head matching property with respect to a thermal head and improvements in sensitivity and image quality.

The total ion concentration of Na⁺ ions and K⁺ ions included in the heat-sensitive recording material is preferably not more than 1500 ppm, more preferably not more than 1000 ppm, and specifically preferably not more than 800 ppm in view of prevention of head corrosion of a thermal head to be brought into contact with the heat-sensitive recording material. As a result of selecting and using materials having a low ion content, the total ion concentration in the whole of the heat-sensitive recording material including the support, layers, and the like can be suppressed and the amount of ions adhered to a head can be suppressed, which can lead to improvement in an anticorrosion property (durability) of the thermal head.

The ion concentration of Na⁺ ions and K⁺ ions can be measured by extracting these ions in a heat-sensitive recording material with hot water and measuring the mass of Na⁺ ions and K⁺ ions in the hot water by an ion quantitative analysis method using an atomic absorption method. The total ion concentration is represented by ppm relative to the total mass of the heat-sensitive recording material.

In the heat-sensitive recording material of the invention, wettablity of the surface of the heat-sensitive recording layer, i.e., the contact angle of a droplet of distilled water when 0.1 seconds have lapsed since dripping of the droplet on the surface of the heat-sensitive recording layer is preferably not less than 20°, and more preferably not less than 50°. By adjusting the contact angle in the above-mentioned range, bleeding of ink at the time of printing with an ink jet printer or at the time of stamping can be effectively prevented (provision of or improvement in ink jet applicability), by which improvement in stamping applicability can be achieved.

The contact angle in the above-mentioned range can be obtained by incorporating an electron-accepting compound represented by general formula (1) (preferably 4-hydroxybenzenesulfonanilide) into the heat-sensitive recording material. Alternatively, a method including: adding at least one of materials capable of keeping the contact angle of distilled water on the recording surface high, such as a sensitizer and paraffin wax according to the invention, to the heat-sensitive recording layer is also preferable.

The contact angle can be measured by dripping distilled water on the surface (recording surface) of the heat-sensitive recording layer of a heat-sensitive recording material and measuring the contact angle when 0.1 seconds have lapsed since the dripping by a conventional method. For example, the contact angle can be measured with a dynamic contact angle absorption tester such as FIBRO system (trade name: DAT1100, manufactured by FIBRO system, ab), or the like.

The first embodiment of the heat-sensitive recording material in the invention is useful in view of superior image storability, and a level of density of a formed image, which has been left under environmental conditions of a temperature of 60° C. and a relative humidity of 20% for 24 hours, is retained at a rate of not less than 65% relative to that of the formed image before leaving (The density retention rate after the leaving is not less than 65%). cAs mentioned above, by incorporating the electron-accepting compound represented by general formula (1) (specifically preferably 4-hydroxybenzenesulfoneanilide), and, in a preferred embodiment, further incorporating an image stabilizer, or the like, the density retention rate can be adjusted in the above-mentioned range. Accordingly, the formed image can be maintained at a high density for a long period of time, and the heat-sensitive recording material can be applied to fields in which image reliability is required for a long period of time such as fields of storage of important documents, advance tickets, receipts, cash vouchers, and the like.

The density retention rate of an image is represented, as shown in the following equation, by the ratio (%) of the density of an image which has been printed and has been left under the atmosphere of a temperature of 60° C. and a relative humidity of 20% for 24 hours after the printing, to the density of an image immedeately after the image has been printed in the same manner as the printing method of the image that has been left. The densities are measured with a Macbeth reflection densitometer (e.g., RD-918).
Density retention rate=[(Image density after leaving)/(Image density immediately after printing)]×100

### Second Embodiment

In the second embodiment of the heat-sensitive recording material of the invention, the heat-sensitive recording material comprises a heat-sensitive recording layer of a coloration system containing an electron-donating colorless dye and an electron-accepting compound in combination and as the electron-accepting compound, a compound defined as R¹-Ph-SO₂R² is contained and the image density formed by printing with a thermal head by energy application at 15.2 mJ/mm² by a thermal head is 1.20 or more.

Hereinafter, the second embodiment of the heat-sensitive recording material of the invention will be described more in details.

The second embodiment of the heat-sensitive recording material of the invention comprises one or two or more heat-sensitive recording layers on a support and preferably a protective layer. Furthermore, if required, the material may have any other layer such as an intermediate layer, or the like.

<Heat-Sensitive Recording Layer>

The heat-sensitive recording layer includes at least an electron-donating colorless dye and an electron-accepting compound that reacts with the electron-donating colorless dye to develop color, and preferably includes an image stabilizer (an ultraviolet light blocking agent), an inorganic pigment, an adhesive and a sensitizer. If required, the layer may include any other component.

Electron-Donating Colorless Dye

The heat-sensitive recording layer used in the second embodiment of the invention includes an electron-donating colorless dye as a color-developing component. The description of the electron-donating colorless dye is same as that for the electron-donating colorless dye included in the heat-sensitive recording layer described in the first embodiment of the invention.

Electron-Accepting Compound

In the second embodiment of the heat-sensitive recording layer used in the invention includes at least one kind of the compound represented by general formula (1) as an electron-accepting compound that reacts with the electron-donating colorless dye during heating to develop color. In addition, in the third aspect, it is preferable to include this compound in the heat-sensitive recording layer. By including the compound as an electron-accepting compound, sensitivity can be increased while keeping background fogging at low level. Furthermore, long-term storability of a formed image (image storability), chemical resistance, ink jet applicability and a head matching property with respect to a thermal head can be simultaneously improved.
R¹-Ph-SO₂R² General formula (1)

In the formula, R¹ represents a hydroxyl group or an alkyl group, R² represents -Ph, —NH-Ph, -Ph-OR³ or —NH—CO—NH-Ph, R³ represents an alkyl group, and Ph represents a phenyl group, which is optionally substituted with a substituent having —SO₂R².

The alkyl group represented by R¹ is preferably an alkyl group having 1 to 3 carbon atoms, and more preferably a methyl group, an ethyl group, an isopropyl group, or the like. Among these, R¹ is specifically preferably a hydroxyl group.

R³ represents an alkyl group, and the alkyl group preferably has 1 to 4 carbon atoms, and is specifically preferably an isopropyl group, or the like. Ph may be a substituted phenyl group wherein the phenyl group is substituted with a “substituent including —SO₂R²”, and R² of the substituent may be substituted with a methyl group, a halogen atom, or the like. Examples of the substituent include —CH₂—C₆H₅—NHCONH—SO₂—C₆H₅, —SO₂—C₆H₄—CH₃, —SO₂—C₆H₄—Cl, and the like. Furthermore, in the second to fourth aspects, the substituent can be —SO₂—C₆H₅.

Among these, R² is preferably —NH-Ph, and specifically preferably —NH—C₆H₅.

Preferable examples of the compound represented by general formula (1) include 4-hydroxybenzenesulfoneanilide (=p-N-phenylsulfamoylphenol), p-N-(2-chlorophenyl)sulfamoylphenol, p-N-3-tolylsulfamoylphenol, p-N-2-tolylsulfamoylphenol, p-N-(3-methoxyphenyl)sulfamoylphenol, p-N-(3-hydroxyphenyl) sulfamoylphenol, p-N-(4-hydroxyphenyl) sulfamoylphenol, 2-chloro-4-N-phenylsulfamoylphenol, 2-chloro-4-N-(3-hydroxyphenyl) sulfamoylphenol, 4′-hydroxy-p-toluenesulfoneanilide, 4,4′-bis (p-toluenesulfonylaminocarbonylamino)diphenylmethane (=BTUM), 4-hydroxy-4′-isopropoxydiphenylsulfone, and the like. In addition, in the second to fourth aspect of the invention, the compound can be 2,4-bis (phenylsulfonyl)phenol. However, in the invention, the compound of formula (1) is not limited to these compounds.

Among the electron-accepting compounds represented by general formula (1), 4-hydroxybenzenesulfoneanilide is the most preferable in view of balance between image retention property and background fogging.

The amount of the electron-accepting compound in a single heat-sensitive recording layer is preferably 50 to 400% by mass, and more preferably 100 to 300% by mass relative to the mass of the electron-donating colorless dye.

Any other known electron-accepting compound may be used in combination with the electron-accepting compound represented by general formula (1), so long as the effects of the invention (specifically decrease in background fogging level, improvement in sensitivity, and improvements in image storability, chemical resistance and a head matching property) are not deteriorated.

The known electron-accepting compound is properly selected and used. It is spedicfically preferably a phenolic compound or a salicylic acid derivative or a polyvalent metal salt thereof from the viewpoint of suppression of background fogging.

The description of the phenolic compounds and the salicylic acid derivatives are same as that for the phenolic compounds and salicylic acid derivatives described in the first embodiment of the invention.

When the known electron-accepting compound is used in combination with the compound of formula (1), the amount of the electron-accepting compound represented by general formula (1) is preferably not less than 50% by mass, and specifically preferably not less than 70% by mass relative to the total mass of the electron-accepting compounds.

In preparation of a coating solution for forming a heat-sensitive recording layer, the particle size (volume mean diameter) of the electron-accepting compound is preferably not more than 1.0 μm, and more preferably 0.4 to 0.7 μm. When the volume mean diameter exceeds 1.0 μm, heat sensitivity sometimes decreases. When the volume mean diameter is less than 0.4 μm, background fogging sometimes deteriorates.

The volume mean diameter can also be readily measured by using a laser diffraction type size distribution measuring instrument (e.g., LA500 manufactured by Horiba, Inc.), or the like.

Sensitizer

The heat-sensitive recording layer used in the second embodiment of the invention preferably includes a sensitizer. The description of the sensitizer is same as that for the sensitizer described in the first embodiment of the invention.

Image Stabilizer (Ultraviolet Light Absorbent)

The heat-sensitive recording layer used in the second embodiment of the invention preferably includes an image stabilizer ((including an ultraviolet light absorbent). The description of the image stabilizer (including an ultraviolet light absorbent) is same as that for the image stabilizer duscribed in the first embodiment of the invention.

Inorganic Pigment

The heat-sensitive recording layer of the second embodiment of the invention preferably includes an inorganic pigment, specifically at least one kind selected from calcite calcium carbonate, amorphous silica and aluminum hydroxide (inorganic pigments according to the invention). The description of the inorganic pigment is same as that for the inorganic pigment described in the first embodiment of the invention.

Adhesive

The heat-sensitive recording of the second embodiment of the invention preferably includes, as an adhesive (or a protective colloid at the time of dispersion), at least one kind selected from sulfo-modified polyvinyl alcohol, diacetone-modified polyvinyl alcohol and acetoacetyl-modified polyvinyl alcohol (i.e., modified polyvinyl alcohols (hereinafter sometimes referred to as “specific modified PVA”). The description of the adhesive is same as that for the adhesive described in the first embodiment of the invention.

Other Component

The heat-sensitive recording layer of the seconnd embodiment of the invention may include, according to the purpose or need, other components such as a cross-linking agent, any other pigment, a metal soap, wax, a surfactant, a binder, an antistatic agent, a defoaming agent, a fluorescence dye, and the like as well as the above-mentioned components.

[Cross-Linking Agent]

The heat-sensitive recording layer may include a cross-linking agent that reacts with the specific modified PVA, and/or any other modified PVA used as an adhesive (or a protective colloid) and the like. By incorporating such a cross-linking agent, water resistance of the heat-sensitive recording material can be improved. The description of the cross-linking agent is same as that for the cross-linking agent described in the first embodiment of the invention.

[Mordant]

The heat-sensitive recording layer may include a mordant for the purpose of preventing bleeding at the time of ink jet recording. The description of the mordant is same as that for the mordant described in the first embodiment of the invention.

[Metal Soap, Wax and Surfactant]

The description of the metal soap, wax and surfactant are same as that for the metal soap, wax and surfactant described in the first embodiment of the invention.

[Binder]

The electron-donating colorless dye, the electron-accepting compound, the inorganic pigment, the adhesive and the sensitizer, and other components can be suitably dispersed in a water-soluble binder. The description of the binder is same as that for the binder described in the first embodiment of the invention.

Others

The electron-donating colorless dye, the electron-accepting compound, the inorganic pigment, the adhesive and the sensitizer can be simultaneously or separately dispersed with a stirrer or a crusher such as a ball mill, an attritor, a sand mill, or the like and then a coating solution is prepared. If neccesary, the coating solution may include the above-mentioned other components, i.e., a cross-linking agent, a mordant, a metal soap, wax, a surfactant, a binder, an antistatic agent, a defoaming agent, a fluorescence dye and the like.

As mentioned above, the coating solution is prepared and applied onto the surface of a support, whereby a heat-sensitive recording layer is formed.

The coating method for applying a coating solution, the dried coating amount of the coating solution for applying and forming the heat-sensitive recording layer, the simultaneously multiple layers coating by a curtain coating method which is a preferable coating method of the invention, and the curtain coating method apparatus to be used for curtain coating method are same as that for those described in the first embodiment of the invention.

In the second embodiment of the invention, adjustment of the image density to be 1.20 or more in the case of thermal printing by energy application at 15.2 mJ/mm² can be achieved by properly selecting above-mentioned respective components and layer structure and application method, particularly the types and the amounts of the electron-donating colorless dye, electron-accepting compound, adhesive, and sensitizer, application method, and existence or absence of the protective layer, in desirable manner.

The image density of the images by the above-mentioned energy application is particularly preferable to be 1.25 to 1.35.

<Protective Layer>

At least one protective layer is preferably disposed on the heat-sensitive recording layer. The protective layer may include organic or inorganic micropowder, a binder, a surfactant, a heat-melting substance, and the like. The description of the protective layer is same as that for the protective layer described in the first embodiment of the inveniton.

Support

Conventionally known supports can be applied to the supports. Specific examples tehreof include supports paper supports such as woodfree paper, and the like, coated paper in which paper is coated with a resin or a pigment, paper on which a resin layer is laminated, woodfree paper having a undercoat layer, synthetic paper, plastic films, and the like. A support including recycled pulp as a main component, i.e. a support in which the mass of recycled pulp is 50% by mass of the components of the support can be also used.

The description of the support and the undercoat layer to be formed on the support are same as that for those described in the first embodiment.

The description of the total ion concentration of Na⁺ ions and K⁺ ions included in the heat-sensitive recording material is same as that described in the first embodiment.

In the second embodiment of the heat-sensitive recording material of the invention, the surface wettability of the heat-sensitive recording layer, that is the contact angle after 0.1 seconds after of dropwise dropping distilled water on the surface of the heat-sensitive recording layer is preferably 20° or more and more preferably 50° or more. By controlling the contact angle in the above-mentioned range, the blurring of printing can be prevented (suitability to ink jet printing is provided and made good) at the time of printing by an ink jet printer.

The above-mentioned contact angle can be obtained by adding the electron-accepting compound (preferably 4-hydroxybenzenesulfoneanilide) represented by the above-mentioned general formula (1) and besides, as a material for keeping the contact angle of the recording face to the distilled water high, a method of adding a sensitizer, paraffin wax and the like to the heat-sensitive recording layer according to the invention is also preferably employed.

The description of the measurement of the contact angle is same As that for measurement of the contact angle in the first embodiment.

The second embodiment of the heat-sensitive recording material of the invention is advantageous in terms of excellent image storability and it is preferable to keep the density retention rate of the formed image 65% or more in the case where the formed image is left still under environmental conditions of 60° C. temperature and 20% relative humidity for 24 hours after the printing. As described above, the density retention rate can be kept in the above-mentioned range by adding the electron-accepting compound (particularly preferably 4-hydroxybenzenesulfoneanilide) represented by the general formula (1) and preferably an image stabilizer as well. Accordingly, the formed image can be kept with a high density for a long duration and thus the heat-sensitive recording material can be employed in fields such as important document storage, prepaid tickets, receipts, money certificates, and the like for which long term image reliability is required.

The description of the density retention rate of the image is same as that described in the first embodiment of the invention.

### Third Embodiment

In the third embodiment of the heat-sensitive recording material of the invention, the heat-sensitive recording material includes a heat-sensitive recording layer of a coloration system containing an electron-donating colorless dye and an electron-accepting compound in combination and the image density formed by printing with a thermal head by energy application at 15.2 mJ/mm² by a thermal head is 1.20 or more and the static friction coefficient and the dynamic friction coefficient are in the range of 0.2 to 0.5 in the case where the outermost surface of the front side having at least one heat-sensitive recording layer and the outermost surface of the rear side are rubbed against each other.

Here, the outermost surface in the front face side means the surface of the heat-sensitive recording layer or the surface of the layer formed in the most outside (the remotest side from the support) among the layers in the case where other layers such as a protective layer or the like are formed on the heat-sensitive recording layer. Similarly, the outermost surface of the rear side means the surface in the side of the support where the heat-sensitive recording layer is not formed or the surface of the layer formed in the most outside among the layers in the case where other layers are formed on the rear side of the heat-sensitive recording layer.

If the static friction coefficient and the dynamic friction coefficient are lower than 0.2, the friction force to the transportation means such as a rubber roller is insufficient and therefore the transportation means slips on the material to result in increase of sending failure at the time of transporting the heat-sensitive recording material and deterioration of the transportation property. On the other hand, if the static friction coefficient and the dynamic friction coefficient exceed 0.5, the slippage among the respective sheets is worsened in the case where the sheets of the heat-sensitive recording material are used while being stacked and when the heat-sensitive recording material is transported in form of sheets, the probability that a plurality of sheets are stacked and transported together is increased and therefore, similarly the transportation property is deteriorated. The static friction coefficient is preferably in the range of 0.25 to 0.45, more preferably 0.30 to 0.45 and similarly, the dynamic friction coefficient is preferably in the range of 0.25 to 0.45, more preferably 0.30 to 0.45.

The above-mentioned static friction coefficient and dynamic friction coefficient can be measured according to ASTM D 1897-73. Practically, they can be measured by the following method.

At first, the heat-sensitive recording material having the heat-sensitive recording layer only in one face is cut into a size of 100 mm width and 200 mm length at a thermostat chamber at 23° C. (a heat-sensitive recording material piece A) and stuck to a smooth plate while the recording face being set upside. A heat-sensitive recording material piece B cut in a size of 60 mm width ad 120 mm length in the same manner is wound around a load weight [W⁰=1.96 N (200 gf): hereinafter, referred to as sleigh] while the recording face being set in the inside (the outermost surface of the rear side being set in the outside) and fixed by a cellophane tape.

Next, the sleigh is connected to the load cell by a monofilament string and the sleigh wrapped with the heat-sensitive recording material piece B is lightly put on the heat-sensitive recording face (the outermost surface in the front face) of the heat-sensitive recording material piece A stuck to the smooth plate and the smooth plate is moved at a testing speed 600 mm/min to measure the static friction coefficient and the dynamic friction coefficient.

In the third embodiment of the heat-sensitive recording material of the invention, the static friction coefficient and dynamic friction coefficient between the outermost surface in the front face and the outermost surface of the rear side can be adjusted in the above-mentioned ranges by controlling the addition amounts of a lubricant as well as a metal soap, a wax, a surfactant and the like in the respective outermost layers. Examples of the lubricant are metal soap such as zinc stearate, calcium stearate and waxes such as paraffin wax, microcrystalline wax, carnauba wax, synthesized polymer wax and the like.

Hereinafter, the third embodiment of the heat-sensitive recording material of the invention will be described in details.

The third embodiment of the heat-sensitive recording material of the invention comprises one or two or more heat-sensitive recording layers on a support and preferably a protective layer. If necessary, other layers such as an intermediate layer may be formed.

<Heat-Sensitive Recording Layer>

The heat-sensitive recording layer includes at least an electron-donating colorless dye and an electron-accepting compound that reacts with the electron-donating colorless dye to develop color, and preferably includes an image stabilizer (an ultraviolet light blocking agent), an inorganic pigment, an adhesive and a sensitizer. If required, the layer may include any other component.

Electron-Donating Colorless Dye

The heat-sensitive recording layer used in the third embodiment of the invention includes an electron-donating colorless dye as a color-developing component. The description of the electron-donating colorless dye is same as that for the electron-donating colorless dye described in the first embodiment of the invention.

Electron-Accepting Compound

In the third embodiment of the heat-sensitive recording layer used in the invention includes at least one kind of the compound represented by general formula (1) as an electron-accepting compound that reacts with the electron-donating colorless dye during heating to develop color. In addition, in the third aspect, it is preferable to include this compound in the heat-sensitive recording layer. By including the compound as an electron-accepting compound, sensitivity can be increased while keeping background fogging at low level. Furthermore, long-term storability of a formed image (image storability), chemical resistance, ink jet applicability and a head matching property with respect to a thermal head can be simultaneously improved.
R¹-Ph-SO₂R² General formula (1)

In the formula, R¹ represents a hydroxyl group or an alkyl group, R² represents -Ph, —NH-Ph, -Ph-OR³ or —NH—CO—NH-Ph, R³ represents an alkyl group, and Ph represents a phenyl group, which is optionally substituted with a substituent having —SO₂R².

The alkyl group represented by R¹ is preferably an alkyl group having 1 to 3 carbon atoms, and more preferably a methyl group, an ethyl group, an isopropyl group, or the like. Among these, R¹ is specifically preferably a hydroxyl group.

R³ represents an alkyl group, and the alkyl group preferably has 1 to 4 carbon atoms, and is specifically preferably an isopropyl group, or the like. Ph may be a substituted phenyl group wherein the phenyl group is substituted with a “substituent including —SO₂R²”, and R² of the substituent may be substituted with a methyl group, a halogen atom, or the like. Examples of the substituent include —CH₂—C₆H₅—NHCONH—SO₂—C₆H₅, —SO₂—C₆H₄—CH₃, —SO₂—C₆H₄—Cl, and the like. Furthermore, in the second to fourth aspects, the substituent can be —SO₂—C₆H₅.

Among these, R² is preferably —NH-Ph, and specifically preferably —NH—C₆H₅.

Preferable examples of the compound represented by general formula (1) are same as that for those described in the second embodiment of the invention. However, in the invention, the compound is not limited to these compounds.

Among the electron-accepting compounds represented by general formula (1), 4-hydroxybenzenesulfoneanilide is the most preferable in view of balance between image retention property and background fogging.

The amount of the electron-accepting compound in a single heat-sensitive recording layer is preferably 50 to 400% by mass, and more preferably 100 to 300% by mass relative to the mass of the electron-donating colorless dye.

Any other known electron-accepting compound may be used in combination with the electron-accepting compound represented by general formula (1), so long as the effects of the invention (specifically decrease in background fogging level, improvement in sensitivity, and improvements in image storability, chemical resistance and a head matching property) are not deteriorated.

The known electron-accepting compound is properly selected and used. It is spedicfically preferably a phenolic compound or a salicylic acid derivative or a polyvalent metal salt thereof from the viewpoint of suppression of background fogging.

The description of the above-mentioned phenolic compounds and salicylic acid derivatives are same as that for the phenolic compounds and salicylic acid derivatives described in the first embodiment of the invention.

When the known electron-accepting compound is used in combination with the compound of formula (1), the amount of the electron-accepting compound represented by general formula (1) is preferably not less than 50% by mass, and specifically preferably not less than 70% by mass relative to the total mass of the electron-accepting compounds.

In preparation of a coating solution for forming a heat-sensitive recording layer, the particle size (volume mean diameter) of the electron-accepting compound is preferably not more than 1.0 μm, and more preferably 0.4 to 0.7 μm. When the volume mean diameter exceeds 1.0 μm, heat sensitivity sometimes decreases. When the volume mean diameter is less than 0.4 μm, background fogging sometimes deteriorates.

The volume mean diameter can also be readily measured by using a laser diffraction type size distribution measuring instrument (e.g., LA500 manufactured by Horiba, Inc.), or the like.

Sensitizer

The heat-sensitive recording layer used in the third embodiment of the invention preferably includes a sensitizer. The description of the sensitizer is same as that for the sensitizer described in the first embodiment of the invention.

Image Stabilizer (Ultraviolet Light Absorbent)

The heat-sensitive recording layer used in the theird embodiment of the invention preferably includes an image stabilizer ((including an ultraviolet light absorbent). The description of the image stabilizer (including an ultraviolet light absorbent) is same as that for the image stabilizer duscribed in the first embodiment of the invention.

Inorganic Pigment

The heat-sensitive recording layer of the third embodiment of the invention preferably includes an inorganic pigment, specifically at least one kind selected from calcite calcium carbonate, amorphous silica and aluminum hydroxide (inorganic pigments according to the invention). The description of the inorganic pigment is same as that for the inorganic pigment described in the first embodiment of the invention.

Adhesive

The heat-sensitive recording of the third embodiment of the invention preferably preferably includes, as an adhesive (or a protective colloid at the time of dispersion), at least one kind selected from sulfo-modified polyvinyl alcohol, diacetone-modified polyvinyl alcohol and acetoacetyl-modified polyvinyl alcohol (i.e., modified polyvinyl alcohols (hereinafter sometimes referred to as “specific modified PVA”). The description of the adhesive is same as that for the adhesive described in the first embodiment of the invention.

Other Component

The heat-sensitive recording layer of the third embodiment of the invention may include, according to the purpose or need, other components such as a cross-linking agent, any other pigment, a metal soap, wax, a surfactant, a binder, an antistatic agent, a defoaming agent, a fluorescence dye, and the like as well as the above-mentioned components.

[Cross-Linking Agent]

The heat-sensitive recording layer may include a cross-linking agent that reacts with the specific modified PVA, and/or any other modified PVA used as an adhesive (or a protective colloid) and the like. By incorporating such a cross-linking agent, water resistance of the heat-sensitive recording material can be improved. The description of the cross-linking agent is same as that for the cross-linking agent described in the first embodiment of the invention.

[Mordant]

The heat-sensitive recording layer may include a mordant for the purpose of preventing bleeding at the time of ink jet recording. The description of the mordant is same as that for the mordant described in the first embodiment of the invention.

[Metal Soap, Wax and Surfactant]

The description of the metal soap, wax and surfactant are the same as that for those described in the first embodiment of the invention.

[Binder]

The electron-donating colorless dye, the electron-accepting compound, the inorganic pigment, the adhesive and the sensitizer, and other components can be suitably dispersed in a water-soluble binder. The description of the binder is same as that for the binder described in the first embodiment of the invention.

Others

The electron-donating colorless dye, the electron-accepting compound, the inorganic pigment, the adhesive and the sensitizer can be simultaneously or separately dispersed with a stirrer or a crusher such as a ball mill, an attritor, a sand mill, or the like and then a coating solution is prepared. If neccesary, the coating solution may include the above-mentioned other components, i.e., a cross-linking agent, a mordant, a metal soap, wax, a surfactant, a binder, an antistatic agent, a defoaming agent, a fluorescence dye and the like.

As mentioned above, the coating solution is prepared and applied onto the surface of a support, whereby a heat-sensitive recording layer is formed. he coating method for applying the coating solution is not specifically limited, and may be suitably selected from coating methods using an air knife coater, a roll coater, a blade coater, a curtain coater, or the like. After the application, the resultant coating is dried, and the dried coating is subjected to smoothing treatment, preferably calendar treatment, and the resultant material is used.

The dried coating amount of the coating solution for forming a heat-sensitive recording layer is, although it is not particularly limited, preferably about 2 to 7 g/m² based on the dried coarting amount.

In the invention, a curtain coating method using a curtain coater is specifically preferred. The reasons for this are as follows. The components can be concentrated on a recording surface. Moreover, high density (high sensitivity) can be obtained even when smaller amounts of materials are used. Furthermore, image quality can be simultaneously improved. When a layer or layers other than a heat-sensitive recording layer, such a protecitve layer, are laminated as mentioned later, the amount of energy consumed during preparation can be further decreased by simultaneously applying multiple layers by a curtain coating method.

The description for the multiple layers simultaneously coating by curtain coating method, and the curtain coating apparatus to be used for curtain coating method are same as that for those described in the first embodiment of the invention.

In the third embodiment of the invention, adjustment of the image density to be 1.20 or more in the case of thermal printing by energy application at 15.2 mJ/mm² can be achieved by properly selecting above-mentioned respective components and layer structure and application method, particularly the types and the amounts of the electron-donating colorless dye, electron-accepting compound, adhesive, and sensitizer, application method, and existence or absence of the protective layer, in desirable manner.

The image density of the images by the above-mentioned energy application is particularly preferable to be 1.25 to 1.35.

<Protective Layer>

At least one protective layer is preferably disposed on the heat-sensitive recording layer. The protective layer may include organic or inorganic micropowder, a binder, a surfactant, a heat-melting substance, and the like. The description of the protective layer is same as that for that described in the first embodiment of the inveniton.

Support

Conventionally known supports can be applied to the supports. Specific examples tehreof include supports paper supports such as woodfree paper, and the like, coated paper in which paper is coated with a resin or a pigment, paper on which a resin layer is laminated, woodfree paper having a undercoat layer, synthetic paper, plastic films, and the like. A support including recycled pulp as a main component, i.e. a support in which the mass of recycled pulp is 50% by mass of the components of the support can be also used.

The description of the support and the description of the undercoat layer to be formed on the support are same as that for those described in the first embodiment.

The description of the total ion concentration of Na⁺ ions and K⁺ ions included in the heat-sensitive recording material is same as that described in the first embodiment.

In the third embodiment of the heat-sensitive recording material of the invention, the surface wettability of the heat-sensitive recording layer, that is the contact angle after 0.1 seconds after of dropwise dropping distilled water on the surface of the heat-sensitive recording layer is preferably 20° or more and more preferably 50° or more. By controlling the contact angle in the above-mentioned range, the blurring of printing can be prevented (suitability to ink jet printing is provided and made good) at the time of printing by an ink jet printer.

The above-mentioned contact angle can be obtained by adding the electron-accepting compound (preferably 4-hydroxybenzenesulfoneanilide) represented by the above-mentioned general formula (1) and besides, as a material for keeping the contact angle of the recording face to the distilled water high, a method of adding a sensitizer, paraffin wax and the like to the heat-sensitive recording layer according to the invention is also preferably employed.

The description of the measurement of the contact angle is same as that for the description in the first embodiment.

The third embodiment of the heat-sensitive recording material of the invention is advantageous in terms of excellent image storability and it is preferable to keep the density retention rate of the formed image 65% or more in the case where the formed image is left still under environmental conditions of 60° C. temperature and 20% relative humidity for 24 hours after the printing. As described above, the density retention rate can be kept in the above-mentioned range by adding the electron-accepting compound (particularly preferably 4-hydroxybenzenesulfoneanilide) represented by the general formula (1) and preferably an image stabilizer as well. Accordingly, the formed image can be kept with a high density for a long duration and thus the heat-sensitive recording material can be employed in fields such as important document storage, prepaid tickets, receipts, money certificates, and the like for which long term image reliability is required.

The description of the density retention rate of the image is same as that for the description of the density retention rate described in the first embodiment of the invention.

### Fourth Embodiment

In the fourth embodiment of a heat-sensitive recording material of the invention, the heat-sensitive recording material comprises a heat-sensitive recording layer containing an electron-donating colorless dye, an electron-accepting compound for coloring by reacting with the electron-donating colorless dye, and a pigment on a support and is characterized in that the pigment has the boiled linseed oil absorption amount of 30 to 200 ml/100 g and a volume average particle diameter of 0.5 to 3 μm and the heat-sensitive recording material is used for a recording apparatus capable of thermal printing at speed of 10 cm/sec or more.

Hereinafter, the fourth embodiment of the heat-sensitive recording material of the invention will be described more in details.

The fourth embodiment of the heat-sensitive recording material of the invention comprises one or two or more heat-sensitive recording layers on a support and preferably a protective layer. If necessary, other layers such as an intermediate layer may be formed.

<Heat-Sensitive Recording Layer>

The heat-sensitive recording layer includes at least an electron-donating colorless dye and an electron-accepting compound that reacts with the electron-donating colorless dye to develop color, and preferably includes an image stabilizer (an ultraviolet light blocking agent), an inorganic pigment, an adhesive and a sensitizer. If required, the layer may include any other component.

Electron-Donating Colorless Dye

The heat-sensitive recording layer of the forth embodiment of the invention includes an electron-donating colorless dye as a color-developing component. The description of the electron-donating colorless dye is same as that for the electron-donating colorless dye described in the first embodiment of the invention.

Electron-Accepting Compound

In the forth embodiment of the heat-sensitive recording layer used in the invention includes at least one kind of the compound represented by general formula (1) as an electron-accepting compound that reacts with the electron-donating colorless dye during heating to develop color. In addition, in the third aspect, it is preferable to include this compound in the heat-sensitive recording layer. By including the compound as an electron-accepting compound, sensitivity can be increased while keeping background fogging at low level. Furthermore, long-term storability of a formed image (image storability), chemical resistance, ink jet applicability and a head matching property with respect to a thermal head can be simultaneously improved.
R¹-Ph-SO₂R² General formula (1)

In the formula, R¹ represents a hydroxyl group or an alkyl group, R² represents -Ph, —NH-Ph, -Ph-OR³ or —NH—CO—NH-Ph, R³ represents an alkyl group, and Ph represents a phenyl group, which is optionally substituted with a substituent having —SO₂R².

The alkyl group represented by R¹ is preferably an alkyl group having 1 to 3 carbon atoms, and more preferably a methyl group, an ethyl group, an isopropyl group, or the like. Among these, R¹ is specifically preferably a hydroxyl group.

R³ represents an alkyl group, and the alkyl group preferably has 1 to 4 carbon atoms, and is specifically preferably an isopropyl group, or the like. Ph may be a substituted phenyl group wherein the phenyl group is substituted with a “substituent including —SO₂R²”, and R² of the substituent may be substituted with a methyl group, a halogen atom, or the like. Examples of the substituent include —CH₂—C₆H₅—NHCONH—SO₂—C₆H₅, —SO₂—C₆H₄—CH₃, —SO₂—C₆H₄—Cl, and the like. Furthermore, in the second to fourth aspects, the substituent can be —SO₂—C₆H₅.

Among these, R² is preferably —NH-Ph, and specifically preferably —NH—C₆H₅.

Preferable examples of the compound represented by general formula (1) are the same as those described in the second embodiment of the invention. However, in the invention, the compound is not limited to these compounds.

Among the electron-accepting compounds represented by the General formula (1), 4-hydroxybenzenesulfoneanilide is the most preferable in view of the balance between image retention property and background fogging.

The amount of the electron-accepting compound in a single heat-sensitive recording layer is preferably 50 to 400% by mass, and more preferably 100 to 300% by mass relative to the mass of the electron-donating colorless dye.

Any other known electron-accepting compound may be used in combination with the electron-accepting compound represented by general formula (1), so long as the effects of the invention (specifically decrease in background fogging level, improvement in sensitivity, and improvements in image storability, chemical resistance and a head matching property) are not deteriorated.

The known electron-accepting compound is properly selected and used. It is spedicfically preferably a phenolic compound or a salicylic acid derivative or a polyvalent metal salt thereof from the viewpoint of suppression of background fogging.

The description of the above-mentioned phenolic compounds and salicylic acid derivatives are same as that for the phenolic compounds and salicylic acid derivatives described in the first embodiment of the invention.

When the known electron-accepting compound is used in combination with the compound of formula (1), the amount of the electron-accepting compound represented by general formula (1) is preferably not less than 50% by mass, and specifically preferably not less than 70% by mass relative to the total mass of the electron-accepting compounds.

In preparation of a coating solution for forming a heat-sensitive recording layer, the particle size (volume mean diameter) of the electron-accepting compound is preferably not more than 1.0 μm, and more preferably 0.4 to 0.7 μm. When the volume mean diameter exceeds 1.0 μm, heat sensitivity sometimes decreases. When the volume mean diameter is less than 0.4 μm, background fogging sometimes deteriorates.

The volume mean diameter can also be readily measured by using a laser diffraction type size distribution measuring instrument (e.g., LA500 manufactured by Horiba, Inc.), or the like.

Pigment

In the fourth embodiment of the invention, as described above, the boiled linseed oil absorption amount of the pigment is set in the range of 30 to 200 ml/100 g, and by adjusting the boiled linseed oil absorption amount in the above-mentioned range, excellent high speed printing suitability can be provided, that is, the head staining hardly occurs even in the case of high speed printing.

If the boiled linseed oil absorption amount is less than 30 ml/100 g, the head staining easily occurs and if it is 200 ml/100 g or more, the sensitivity is hardly exhibited.

The boiled linseed oil absorption amount of the pigment is more preferably 40 to 150 ml/100 g and furthermore preferably 50 to 100 ml/100 g.

In the fourth embodiment of the invention, the volume mean diameter of the pigment is set in the range of 0.5 to 3 μm and if it is smaller than 0.5 μm, the head staining easily occurs and if it is 3 μm or more, the sensitivity is hardly exhibited.

The volume mean diameter of the pigment is more preferably 0.7 to 2.5 μm and furthermore preferably 1.0 to 2.0 μm.

Further, as the pigment, more specifically, at least one of calcite type calcium carbonate, amorphous silica, and aluminum hydroxide (pigments according to the invention) is preferably added. Addition of such pigments improves the head matching property with a thermal head with which the heat-sensitive recording material is brought into contact and simultaneously provides printing suitability and plain paper-like touch.

(Light) calcium carbonate generally includes those having crystal forms of calcite, aragonite, vaterite and like and from a viewpoint of coloring density at the time of recording by a thermal head, prevention of head staining as well as absorption property and hardness, calcite type (light) calcium carbonate is preferable and above all, those having a spindle-like shape or scalenohedron shape are preferable. The calcite type (light) calcium carbonate can be produced by a known production method.

The average particle size of the above-mentioned calcite type (light) calcium carbonate is preferably 1 to 3 μm on the basis of the volume mean diameter. The volume mean diameter can be measured in the same manner as that for the above-mentioned electron-donating colorless dye.

The content of “the pigments according to the invention” in a single heat-sensitive recording layer is preferably 50 to 500 parts by mass, more preferably 70 to 350 parts by mass, and furthermore preferably 90 to 250 parts by mass to 100 parts by mass of the electron-accepting compound from a viewpoint of improvement of the coloring density and prevention of scam adhesion to the thermal head.

Further, to the extent that the effects (especially, improvement of the head matching property, the printing suitability, and plain paper-like touch) of the invention are not affected, other pigments may be used in combination with the pigments according to the invention.

As other pigments, calcium carbonate except the calcite type (light) calcium carbonate, barium sulfate, lithopone, agalmatolite, kaolin, calcined kaolin, amorphous silica, kaolin, magnesium carbonate, magnesium oxide, and the like can be exemplified.

The volume mean diameters of other pigments are preferably 0.3 to 1.5 μm and more preferably 0.5 to 0.9 μm [by measurement using laser diffraction particle size distribution measurement method (e.g. LA 500 manufactured by Horiba Co., Ltd.)].

In the case of using other pigments in combination with the pigment according to the invention, the ratio (v/w) of the total amount (v) of the pigment according to the invention and the total amount (w) of other pigment is preferably (100/0) to (60/40) and more preferably (100/0) to (80/20).

From a viewpoint of suppression of wear of the thermal head, pigments with Mohs hardness 3 or less are preferable. “Mohs hardness” is described in English Japanese Plastic Industry Dictionary, 5th edition, p. 616 (Shin OGAWA, published by Kogyo Chosakai Publishing Co., Ltd.). Pigments with Mohs hardness 3 or less include calcium carbonate and aluminum hydroxide.

If the pigment according to the invention is used with magnesium carbonate and magnesium oxide, it is advantageously effective to lower the background fogging and the content of magnesium carbonate and/or magnesium oxide in such a case is preferably 3 to 50% by mass, more preferably 5 to 30% by mass in the total of the pigments.

Sensitizer

The heat-sensitive recording layer of the forth embodiment of the invention preferably includes a sensitizer. The description of the sensitizer is same as that for the description in the first embodiment of the invention.

Image Stabilizer (Ultraviolet Light Absorbent)

The heat-sensitive recording layer of the forth embodiment of the invention preferably includes an image stabilizer ((including an ultraviolet light absorbent). The description of the image stabilizer (including an ultraviolet light absorbent) is same as that for the image stabilizer duscribed in the first embodiment of the invention.

Adhesive

The heat-sensitive recording of the forth embodiment of the invention preferably preferably includes, as an adhesive (or a protective colloid at the time of dispersion), at least one kind selected from sulfo-modified polyvinyl alcohol, diacetone-modified polyvinyl alcohol and acetoacetyl-modified polyvinyl alcohol (i.e., modified polyvinyl alcohols (hereinafter sometimes referred to as “specific modified PVA”). The description of the adhesive is same as that for the adhesive described in the first embodiment of the invention.

Other Component

The heat-sensitive recording layer of the forth embodiment of the invention may include, according to the purpose or need, other components such as a cross-linking agent, any other pigment, a metal soap, wax, a surfactant, a binder, an antistatic agent, a defoaming agent, a fluorescence dye, and the like as well as the above-mentioned components.

[Cross-Linking Agent]

The heat-sensitive recording layer may include a cross-linking agent that reacts with the specific modified PVA, and/or any other modified PVA used as an adhesive (or a protective colloid) and the like. By incorporating such a cross-linking agent, water resistance of the heat-sensitive recording material can be improved. The description of the cross-linking agent is same as that for the cross-linking agent described in the first embodiment of the invention.

[Mordant]

The heat-sensitive recording layer may include a mordant for the purpose of preventing bleeding at the time of ink jet recording. The description of the mordant is same as that for the mordant described in the first embodiment of the invention.

[Metal Soap, Wax and Surfactant]

The description of the metal soap, wax and surfactant are the same as that for those described in the first embodiment of the invention.

[Binder]

The electron-donating colorless dye, the electron-accepting compound, the inorganic pigment, the adhesive and the sensitizer, and other components can be suitably dispersed in a water-soluble binder. The description of the binder is same as that for the binder described in the first embodiment of the invention.

Others

The electron-donating colorless dye, the electron-accepting compound, the inorganic pigment, the adhesive and the sensitizer can be simultaneously or separately dispersed with a stirrer or a crusher such as a ball mill, an attritor, a sand mill, or the like and then a coating solution is prepared. If neccesary, the coating solution may include the above-mentioned other components, i.e., a cross-linking agent, a mordant, a metal soap, wax, a surfactant, a binder, an antistatic agent, a defoaming agent, a fluorescence dye and the like.

As mentioned above, the coating solution is prepared and applied onto the surface of a support, whereby a heat-sensitive recording layer is formed. he coating method for applying the coating solution is not specifically limited, and may be suitably selected from coating methods using an air knife coater, a roll coater, a blade coater, a curtain coater, or the like. After the application, the resultant coating is dried, and the dried coating is subjected to smoothing treatment, preferably calendar treatment, and the resultant material is used.

The dried coating amount of the coating solution for forming a heat-sensitive recording layer is, although it is not particularly limited, preferably about 2 to 7 g/m² based on the dried coarting amount.

In the forth embodiment of the invention, a curtain coating method using a curtain coater is specifically preferred. The reasons for this are as follows. The components can be concentrated on a recording surface. Moreover, high density (high sensitivity) can be obtained even when smaller amounts of materials are used. Furthermore, image quality can be simultaneously improved. When a layer or layers other than a heat-sensitive recording layer, such a protecitve layer, are laminated as mentioned later, the amount of energy consumed during preparation can be further decreased by simultaneously applying multiple layers by a curtain coating method.

The specific description for the multiple layers simultaneously coating by curtain coating method, and the curtain coating method apparatus to be used for curtain coating method are same as that for those described in the first embodiment of the invention.

<Protective Layer>

At least one protective layer is preferably disposed on the heat-sensitive recording layer. The protective layer may include organic or inorganic micropowder, a binder, a surfactant, a heat-melting substance, and the like. The description of the protective layer is same as that for that described in the first embodiment of the inveniton.

Support

Conventionally known supports can be applied to the supports. Specific examples tehreof include supports paper supports such as woodfree paper, and the like, coated paper in which paper is coated with a resin or a pigment, paper on which a resin layer is laminated, woodfree paper having a undercoat layer, synthetic paper, plastic films, and the like. A support including recycled pulp as a main component, i.e. a support in which the mass of recycled pulp is 50% by mass of the components of the support can be also used.

The description of the support and the description of the undercoat layer to be formed on the support are same as that for those described in the first embodiment.

The description of the total ion concentration of Na⁺ ions and K⁺ ions included in the heat-sensitive recording material is same as that described in the first embodiment.

In the forth embodiment of the heat-sensitive recording material of the invention, the surface wettability of the heat-sensitive recording layer, that is the contact angle after 0.1 seconds after of dropwise dropping distilled water on the surface of the heat-sensitive recording layer is preferably 20° or more and more preferably 50° or more. By controlling the contact angle in the above-mentioned range, the blurring of printing can be prevented (suitability to ink jet printing is provided and made good) at the time of printing by an ink jet printer.

The above-mentioned contact angle can be obtained by adding the electron-accepting compound (preferably 4-hydroxybenzenesulfoneanilide) represented by the above-mentioned general formula (1) and besides, as a material for keeping the contact angle of the recording face to the distilled water high, a method of adding a sensitizer, paraffin wax and the like to the heat-sensitive recording layer according to the invention is also preferably employed.

The description of the measurement of the contact angle is same as that for the description in the first embodiment.

The forth embodiment of the heat-sensitive recording material of the invention is advantageous in terms of excellent image storability and it is preferable to keep the density retention rate of the formed image 65% or more in the case where the formed image is left still under environmental conditions of 60° C. temperature and 20% relative humidity for 24 hours after the printing. As described above, the density retention rate can be kept in the above-mentioned range by adding the electron-accepting compound (particularly preferably 4-hydroxybenzenesulfoneanilide) represented by the general formula (1) and preferably an image stabilizer as well. Accordingly, the formed image can be kept with a high density for a long duration and thus the heat-sensitive recording material can be employed in fields such as important document storage, prepaid tickets, receipts, money certificates, and the like for which long term image reliability is required.

The description of the density retention rate of the image is same as that for the description of the density retention rate described in the first embodiment of the invention.

The fourth embodiment of the heat-sensitive recording material of the invention is used for a recording apparatus capable of carrying out thermal printing (image formation) at a speed of 10 cm/sec or more and printing (image formation) can be carried out on the heat-sensitive recording layer with the above-mentioned constitution by imagewise thermal printing directly on the surface of the heat-sensitive recording layer or on the surface via the protective layer if the protective layer is formed.

The speed of the thermal printing (image formation) is preferably 12 cm/sec or more.

### Examples of the First Embodiment

Hereinafter, the first embodiment of the invention will be described along with examples. However, the invention is not limited to these Examples. “Parts” and “%” used in Examples mean “parts by mass” and “% by mass”, respectively.

### Example 1

<Preparation of Coating Solution for Heat-Sensitive Recording Layer>

Preparation of Dispersion A (Containing Electron-Donating Colorless Dye)

The following components were mixed with a ball mill to prepare dispersion liquid A-1 having a volume mean diameter of 0.7 μm. The volume mean diameter was measured with a laser diffraction type size distribution measuring instrument (trade name: LA500, manufactured by Horiba, Inc.).

[Sition of Dispersion Liquid A]

| | |
|---|---|
| 2-Anilino-3-methyl-6-diethylaminofluorane | 10 parts |
| (an electron-donating colorless dye) | |
| 2.5% Polyvinyl alcohol solution | 50 parts |
| (trade name: PVA-105, manufactured by Kuraray | |
| Co., Ltd.) | |

Preparation of Dispersion Liquid B (Containing Electron-Accepting Compound)

The following components were mixed with a ball mill to prepare dispersion liquid B-1 having a volume mean diameter of 0.7 μm. The volume mean diameter was measured in the same manner as the method for measuring the volume mean diameter of dispersion liquid A.

(Composition of Dispersion Liquid B)

| | |
|---|---|
| 4-Hydroxybenzenesulfoneanilide | 20 parts |
| (an electron-accepting compound represented by general | |
| formula (1)) | |
| 2.5% Polyvinyl alcohol solution | 100 parts |
| (trade name: PVA-105, manufactured by Kuraray Co., Ltd.) | |

Preparation of Dispersion Liquid C (Containing a Sensitizer)

The following components were mixed with a ball mill to prepare dispersion liquid C having a volume mean diameter of 0.7 μm. The volume mean diameter was measured in the same manner as the method for measuring the volume mean diameter of dispersion liquid A.

(Composition of Dispersion Liquid C)

| | |
|---|---|
| 2-Benzyloxynaphthalene (a sensitizer) | 20 parts |
| 2.5% Polyvinyl alcohol solution | 100 parts |
| (trade name: PVA-105, manufactured by Kuraray | |
| Co., Ltd.) | |

Preparation of Dispersion D (Containing Pigment)

The following components were mixed with a sand mill to prepare dispersion liquid D having a volume mean diameter of 2.0 μm. The volume mean diameter was measured in the same manner as the method for measuring the volume mean diameter of dispersion liquid A.

(Composition of Dispersion Liquid D)

| | |
|---|---|
| Calcite light calcium carbonate | 40 parts |
| (Trade name: UNIVER 70, manufactured by Shiraishi | |
| Kogyo K.K.) | |
| Sodium polyacrylate | 1 part |
| Water | 60 parts |

Preparation of Coating Solution for Heat-Sensitive Recording Layer

The following components were mixed to prepare a coating solution for a heat-sensitive recording layer.

(Composition of Coating Solution for Heat-Sensitive Recording Layer)

| | |
|---|---|
| Dispersion liquid A | 60 parts |
| Dispersion liquid B | 120 parts |
| Dispersion liquid C | 120 parts |
| Dispersion liquid D | 101 parts |
| 30% Zinc stearate dispersion liquid | 15 parts |
| Paraffin wax (30%) | 20 parts |
| Sodium dodecylbenzenesulfonate (25%) | 3 parts |

<Preparation of Coating Solution for Undercoat Layer of Support>

The following components were mixed and stirred with a dissolver to prepare a dispersion liquid.

| | |
|---|---|
| Calcined kaolin (oil-absorption amount: 75 ml/ | 100 parts |
| 100 g) | |
| Sodium hexametaphosphate | 1 part |
| Water | 110 parts |

Twenty parts of SBR (styrene-butadiene rubber latex) and 25 parts of oxidized starch (25%) were then added to the obtained dispersion liquid to prepare a coating solution for an support primer layer of a support.

<Preparation of Heat-Sensitive Recording Material>

Woodfree paper having smoothness measured by JIS-P8119 of 150 seconds was prepared as a support. The coating solution for an support primer layer primer layer of a support obtained above was applied to the surface of the woodfree paper by a blade coater so that the coating amount after drying became 8 g/m². Thus, an primer layer was formed. By applying the primer layer, the smoothness measured by JIS-P8119 of the support became 350 seconds.

The coating solution for a heat-sensitive recording layer obtained above was then applied to the undercoat layer with a curtain coater so that the coating amount after drying became 4 g/m²

Successively, using an air knife, water as a back liquid was applied with 5 g/m² thickness to the surface of the support (the rear side of the support) in the side where no heat-sensitive recording layer was formed and dried to adjust the curl. After that, the surface of the formed heat-sensitive recording layer was subjected to calendaring treatment to obtain a heat-sensitive recording material (1) of the invention.

The obtained heat-sensitive recording material (1) was subjected to the measurement (evaluation) in conditions by the methods as described below. The coloring density was 1.28 (measured by Macbeth reflection densitometer RD-918) in the case of energy application at 15.2 mJ/mm² by the thermal head.

### Example 2

Preparation of Dispersion Liquid E

The following components were mixed with a ball mill to prepare dispersion liquid E having a volume mean diameter of 0.7 μm. The volume mean diameter was measured in the same manner as in Example 1.

(Composition of Dispersion Liquid E)

| | |
|---|---|
| 1,1,3-Tris(2-methyl-4-hydroxy-5-tert-butylphenyl)butane (an | 5 parts |
| image stabilizer) | |
| 2.5% Polyvinyl alcohol solution | 25 parts |
| (trade name: PVA-105, manufactured by Kuraray Co., Ltd.; | |
| an adhesive) | |

Preparation of Coating Solution for Heat

Dispersion liquids A, B, C and D were prepared in the same manner as in Example 1 and mixed with dispersion liquid E obtained above in accordance with the following composition to prepare a coating solution for a heat-sensitive recording layer. Furthermore, the heat-sensitive recording material of the invention (2) was obtained in the same manner as in Example 1.

(Composition of Coating Solution for Heat-Sensitive

| | |
|---|---|
| Dispersion liquid A | 60 parts |
| Dispersion liquid B | 120 parts |
| Dispersion liquid C | 120 parts |
| Dispersion liquid E | 30 parts |
| Dispersion liquid D | 101 parts |
| 30% Zinc stearate dispersion liquid | 15 parts |
| Paraffin wax (30%) | 20 parts |
| Sodium dodecylbenzenesulfonate (25%) | 3 parts |

### Example 3

Dispersion liquid E was prepared in the same manner as in Example 2 except that 1,1,3-tris(2-methyl-4-hydroxy-5-cyclohexylphenyl)butane was used instead of 1,1,3-tris(2-methyl-4-hydroxy-5-tert-butylphenyl)butane (an image stabilizer) used in the preparation of dispersion liquid E-1. Furthermore, the heat-sensitive recording material of the invention (3) was obtained in the same manner as in Example 2.

### Examples 4 and 5

The heat-sensitive recording materials of the invention (4) and (5) were obtained in the same manner as in Example 1 except that 20 parts of amorphous silica (trade name: MIZUKASIL P832, manufactured by Mizusawa Industrial Chemicals, Ltd.) and 40 parts of aluminum hydroxide (trade name: HYGILITE H42, manufactured by Showa Denko K.K.) were used, respectively, instead of 40 parts of calcite light calcium carbonate (UNIVER 70; inorganic pigment) used in the preparation of dispersion liquid D.

### Example 6

The heat-sensitive recording material of the invention (6) was obtained in the same manner as in Example 1 except that a 2.5% sulfo-modified polyvinyl alcohol (trade name: GOHSERAN L3266, manufactured by Nippon Synthetic Chemical Industry Co., Ltd.) aqueous solution was used instead of a 2.5% polyvinyl alcohol aqueous solution (an adhesive) used in the preparations of dispersion liquids A, B and C.

### Example 7

The heat-sensitive recording material of the invention (7) was obtained in the same manner as in Example 1 except that a 2.5% polyvinyl alcohol aqueous solution (an adhesive) used in the preparations of dispersion liquids A, B and C was changed to a 2.5% diacetone-modified polyvinyl alcohol (trade name: D500, manufactured by Unitika Ltd.) aqueous solution to prepare dispersion liquids A, B and C, and that 13 parts of a 5% adipic acid dihydrazide aqueous solution (a crosslinking agent) was added to the coating solution for a heat-sensitive recording layer obtained by mixing the thus-obtained dispersion liquids A, B and C.

### Eample 8

The heat-sensitive recording material of the invention (8) was obtained in the same manner as in Example 1 except that a 2.5% polyvinyl alcohol aqueous solution (an adhesive) used in the preparations of dispersion liquids A, B and C was changed to a 2.5% acetoacetyl-modified polyvinyl alcohol (trade name: GOHSEFIMER Z210, manufactured by Nippon Synthetic Chemical Industry Co., Ltd.) aqueous solution to prepare dispersion liquids A, B and C, and that 13 parts of a 5% glyoxal aqueous solution (a crosslinking agent) was added to the coating solution for a heat-sensitive recording layer obtained by mixing the thus-obtained dispersion liquids A, B and C.

### Example 9

of the invention (9) was obtained in the same manner as in Example 1 except that recycled paper (50 g/m²) made of recycled pulp (70%) and LBKP (30%) and having smoothness measured by JIS-P8119 of 170 seconds was used instead of woodfree paper used as the substrate in Example 1.

### Example 10

The heat-sensitive recording material of the invention (10) was obtained in the same manner as in Example 1 except that, after formation of an undercoat layer on a substrate, the coating solution for a heat-sensitive recording layer obtained in Example 1 and the following coating solution for a protective layer were applied simultaneously with a curtain coater and the resultant coatings were dried to form multiple layers and the surface of the laminated protective layer was subjected to calendaring treatment instead of applying the coating solution for a heat-sensitive recording layer, drying and calendaring the resultant coating after formation of an undercoat layer on a substrate in the <Preparation of heat-sensitive recording material> of Example 1. The dried coating amount of the protective layer was 2.0 g/m².

Preparation of Coating Solution for Protective Layer

The following components were stirred with a sand mill to prepare a pigment dispersion having a volume mean diameter of 2 μm. The volume mean diameter was measured in the same manner as in Example 1.

| | |
|---|---|
| Aluminum hydroxide (average particle size 1 μm) | 40 parts |
| (trade name: HYGILITE H42, manufactured by Showa | |
| Denko K.K.) | |
| Sodium polyacrylate | 1 part |
| Water | 60 parts |

A mixture of 200 parts of a 15% urea phosphate esterified starch aqueous solution (trade name: MS4600, manufactured by Nihon Shokuhin Kako Co., Ltd.), 200 parts of a 15% polyvinyl alcohol aqueous solution (trade name: PVA-105, manufactured by Kuraray Co., Ltd.) and 60 parts of water was separately prepared. The pigment dispersion obtained above, and 25 parts of a zinc stearate emulsified dispersion having a volume mean diameter of 0.15 μm (trade name: HYDRIN F115, manufactured by Chukyo Yushi Co., Ltd.) and 125 parts of a 2% 2-ethylhexyl sodium sulfosuccinate aqueous solution were added to the mixture to form a coating solution for a protective layer.

### Examples 11 to 13

The heat-sensitive recording materials of the invention (11) to (13) were obtained in the same manner as in Example 10 except that 40 parts of aluminum hydroxide (trade name: HYGILITE H43; volume mean diameter: 0.7 μm; manufactured by Showa Denko K.K.), 40 parts of kaolin (trade name: KAOBRITE; volume mean diameter: 2.5 μm; manufactured by Shiraishi Kogyo K.K.) and 20 parts of amorphous silica (trade name: MIZUKASIL P707; volume mean diameter: 2.2 μm; manufactured by Mizusawa Industrial Chemicals, Ltd.) were used, respectively, instead of 40 parts of aluminum hydroxide (HYGILITE H42; an inorganic pigment) used in the preparation of the coating solution for a protective layer in Example 10.

### Examples 14 to 20

The heat-sensitive recording materials of the invention (14) to (20) were obtained in the same manner as in Example 1 except that dimethylbenzyl oxalate (trade name: HS3520R-N, manufactured by Dainippon Ink and Chemicals, Inc.), m-terphenyl, ethylene glycol tolyl ether, p-benzylbiphenyl, 1,2-diphenoxymethylbenzene, diphenylsulfone and 1,2-diphenoxyethane were used, respectively, instead of 2-benzyloxynaphthalene (a sensitizer) used in the preparation of dispersion liquid C in Example 1.

### Examples 21 to 25

The heat-sensitive recording materials of the invention (21) to (25) were obtained in the same manner as in Example 1 except that 2-anilino-3-methyl-6-dibutylaminofluorane, 2-anilino-3-methyl-6-(N-ethyl-N-isoamylamino)fluorane, 2-anilino-3-methyl-6-(N-ethyl-N-propylamino)fluorane, 2-anilino-3-methyl-6-di-n-amylaminofluorane and 2-anilino-3-methyl-6-(N-ethyl-N-p-tolylamino)fluorine were used, respectively, instead of 2-anilino-3-methyl-6-diethylaminofluorane (an electron-donating colorless dye) used in the preparation of dispersion liquid A in Example 1.

### Example 26

The heat-sensitive recording material of the invention (26) was obtained in the same manner as in Example 1 except that an air knife coater was used instead of the curtain coater used in the application of the coating solution for a heat-sensitive recording layer in Example 1.

### Examples 27 to 29

The heat-sensitive recording materials of the invention (27) to (29) were obtained in the same manner as in Example 1 except that N-benzyl-4-hydroxybenzenesulfoneamide (=p-N-benzylsulfamoylphenol), BTUM and 4-hydroxy-4′-isopropoxydiphenylsulfone were used, respectively, instead of 4-hydroxybenzenesulfoneanilide (an electron-accepting compound) used in the preparation of dispersion liquid B in Example 1.

### Comparative Examples 1 and 2

The comparative heat-sensitive recording materials (30) and (31) were obtained in the same manner as in Example 1 except that 2,2′-bis(4-hydroxyphenol)propane (bisphenol A) and 4,4′-di-hydroxydiphenylsulfone were used, respectively, instead of 4-hydroxybenzenesulfoneanilide (an electron-accepting compound) used in the preparation of dispersion liquid B in Example 1.

### Comparative Example 3

The comparative heat-sensitive recording material (32) was obtained in the same manner as in Example 1 except that the amount of 4-hydroxybenzenesulfoneanilide (an electron-accepting compound) used in the preparation of dispersion liquid B in Example 1 was changed from 20 parts to 4 parts.

### Comparative Example 4

The comparative heat-sensitive recording material (33) was obtained in the same manner as in Example 1, except that no back liquid was applied in Example 1.

### Comparative Example 5

The comparative heat-sensitive recording material (34) was obtained in the same manner as in Example 1, except that the back liquid was applied excessively (12 g/m²) in Example 1.

(Evaluation)

The heat-sensitive recording materials (1) to (29) of the invention and the conparative heat-sensitive recording materials (30) to (34) obtained in the above described manner were subjected to the following measurements and evaluations. The results of the measurements and evaluations are shown in the following Table 1.

(1) Measurement of Sensitivity

Printing was carried out with a heat-sensitive printing apparatus including a thermal head which has a partially glazed structure (trade name: KF2003-GD31A, manufactured by Rohm Co., Ltd.). The printing was carried out under conditions of a head voltage of 24V and a printing cycle of 0.98 ms/line (printing velocity: 12.8 cm/seconds) and a pulse width of 0.375 ms (applied energy: 15.2 mJ/mm²), and printing densities were measured with Macbeth reflection densitometer (trade name: RD-918, manufactured by Macbeth Corporation).

(2) Evaluation of Background Fogging

Each of the heat-sensitive recording materials (1) to (99) was left under environmental conditions of a temperature of 60° C. and a relative humidity of 20% for 24 hours, and each of the heat-sensitive recording materials (100) to (132) was left under environmental conditions of a temperature of 40° C. and a relative humidity of 80% for 24 hours. Thereafter, the density of the background portion (non-image portion) of each material was measured with Macbeth reflection densitometer (trade name: RD-918, manufactured by Macbeth Corporation). The lower the value is, the better the background fogging is.

(3) Evaluation of Image Storability

Printing was conducted on each of the heat-sensitive recording materials with the same apparatus as the apparatus used in “(1) Measurement of sensitibity” under the same conditions as those in “(1) Measurement of sensitivity”. The image density of each material immediately after the printing, and the image density of the material after the printed image had been left under the atmosphere of a temperature of 60° C. and a relative humidity of 20% for 24 hours were measured with Macbeth reflection densitometer (trade name: RD-918, manufactured by Macbeth Corporation). Then, the ratio (%; density retention rate) of the image density after the leaving to the image density immediately after the printing was calculated based on the following equation. The ratio was used as an index for evaluating image storability. The higher the value is, the better the image storability is.
Density retention rate=[(Image density after leaving)/(Image density immediately after printing)]×100
(4) Evaluation of Chemical Resistance

Printing was conducted on each of the heat-sensitive recording materials with the same apparatus as the apparatus used in “(1) Measurement of sensitibity” under the same conditions as those in “(1) Measurement of sensitivity”. Writing was conducted on the surface of the background portion and the printed portion of each printed material with a fluorescent pen (trade name: Zebra fluorescent pen 2-pink, manufactured by Zebra Co., Ltd.). Thereafter, each material was left for one day. The degree of background fogging of the background portion and the image density of the image portion of each heat-sensitive recording material were visually observed and evaluated according to the following criteria.

[Criteria]

◯: The background fogging density of the background portion did not increase, and the density of the image portion did not change.
Δ: The background fogging density of the background portion slightly increased, and the density of the image portion slightly faded out.
X: The background fogging density of the background portion significantly increased, and the image portion almost faded out.
   (5) Evaluation of Printing Troubles Caused by Friction Between a Head and a Recording Material

Each of the heat-sensitive recording materials was cut into 1000 sheets having A4 size. A test chart having a printing rate of 20% was printed on 1,000 sheets of each material with a word processor (trade name: RUPO 95JV, manufactured by Toshiba Corporation). The number of missing dots was used as an index for evaluation of printing troubles caused by friction between a head and a recording material.

(6) Evaluation of Ink Jet Applicability

[1] Ink Resistance

Printing was conducted on each of the heat-sensitive recording materials in the same manner as in “(1) Measurement of sensitivity”. The image density (D¹) immediately after the printing was measured with Macbeth reflection densitometer (trade name: RD918, manufactured by Macbeth Corporation). The surface of the printed heat-sensitive recording layer (printing portions on which printing had been conducted) was brought into contact with a high quality image that was formed with an ink jet printer (trade name: EPSON MJ930C, manufactured by Epson Inc.), and these were left under at 25° C. for 48 hours in this state. The image density (D²) of the heat-sensitive recording layer after the leaving was measured with Macbeth reflection densitometer RD918. The density retention rate (%; D²/D¹×100) was calculated from the obtained densities of each heat-sensitive recording material, and was used as an index for evaluating inke jet ink resistance. The higher the value is, the better the ink resistance is.

[2] Ink Jet Recording Applicability

Letters were printed on each of the heat-sensitive recording materials with a word processor (trade name: RUPO JW-95JU, manufactured by Toshiba Corporation). Pinting was further conducted on the thus-printed heat-sensitive recording layer with an ink jet printer, and bleeding of the ink in ink jet-recorded portions and fading of letter portions printed by the word processor were visually evaluated according to the following criteria.

(Criteria)

◯: Bleeding of ink and fading of letter portions slightly occured but the letters could be read without any problem.
Δ: A part of letter portions faded, but it was possible to read the letters.
X: Letter portions completely disappeared, and the letters could not be read.
   (7) Curl Height

Each heat-sensitive recording material was cut along the width direction into 10 cm square and after conditioning humidity to 45% RH at 23° C. placed horizontally while the heat-sensitive recording layer of each material was set upward or downward and the height of the four corners most coming up from the horizontal plane was measured as the maximum value (mm).

(8) Handling Easiness

Using a word processor (trade name: Rupo 95JV, manufactured by Toshiba), 30 sheets of each heat-sensitive recording material with A4 size were set in a feeding part and printing was carried out on the sheets and the evaluation was carried out according to the following standards.
◯: Printing was carried out normally and sheets were stacked without any problem after printing.
X: Printing was carried out slantingly to the right and left direction of each sheet or sheets were fed while being folded or after the printing, sheets were stacked in disordered manner or the sheets stacked prior were pushed out by the sheets printed later.

(9) Measurement of Contact Angle

Distilled water was dripped on the surface of the heat-sensitive recording layer of each heat-sensitive recording material (a recording surface), and the contact angle when 0.1 seconds had lapsed since the dripping was measured with FIBRO system (trade name: DAT1100, manufactured by FIBRO system, ab). The greater the value is, the more useful the material is, in view of its effects.

(10) Measurement of Concentration of Ions (Na⁺ and K⁺)

Na⁺ and K⁺ ions of each heat-sensitive recording material were extracted with hot water, and the masses of Na⁺ and K⁺ ions contained in the extract were measured by ion quantitative analysis using an atomic absorption method. The ion concentrations in Tables 1 represent the total ion concentration of Na⁺ and K⁺ ions of each material, and shows the total ppm value relative to the total mass of the heat-sensitive recording material.

TABLE 1

| | | | | | | | Ink jet | | | | | |
|---|---|---|---|---|---|---|---|---|---|---|---|---|
| | Heat- | | | | | | suitability | | | | | Ion |
| | sensitive | Image | | Background | | | ink | ink jet | Curl | | Contact | concen- |
| | recording | density | Image | fogging | Chemical | Printing | resis- | recording | height | Handling | angle | tration |
| | material | (sensitivity) | storability | density | resistance | trouble | tance | suitability | [mm] | easiness | [°] | [ppm] |
| Example 1 | (1) | 1.28 | 95% | 0.09 | ◯ | 0 point | 90% | ◯ | 1.1 | ◯ | 51 | 780 |
| Example 2 | (2) | 1.27 | 98% | 0.10 | ◯ | 0 point | 93% | ◯ | 1.3 | ◯ | 55 | 800 |
| Example 3 | (3) | 1.26 | 97% | 0.10 | ◯ | 0 point | 92% | ◯ | 1.2 | ◯ | 53 | 800 |
| Example 4 | (4) | 1.26 | 93% | 0.10 | ◯ | 0 point | 88% | ◯ | 1.4 | ◯ | 50 | 770 |
| Example 5 | (5) | 1.27 | 96% | 0.09 | ◯ | 0 point | 91% | ◯ | 1.1 | ◯ | 55 | 790 |
| Example 6 | (6) | 1.30 | 96% | 0.08 | ◯ | 0 point | 93% | ◯ | 1.5 | ◯ | 50 | 800 |
| Example 7 | (7) | 1.29 | 97% | 0.08 | ◯ | 0 point | 92% | ◯ | 1.6 | ◯ | 52 | 800 |
| Example 8 | (8) | 1.28 | 95% | 0.08 | ◯ | 0 point | 93% | ◯ | 1.4 | ◯ | 55 | 790 |
| Example 9 | (9) | 1.28 | 94% | 0.09 | ◯ | 0 point | 93% | ◯ | 4.0 | ◯ | 60 | 800 |
| Example 10 | (10) | 1.23 | 98% | 0.09 | ◯ | 0 point | 98% | ◯ | 3.0 | ◯ | 45 | 800 |
| Example 11 | (11) | 1.22 | 97% | 0.09 | ◯ | 0 point | 97% | ◯ | 2.8 | ◯ | 42 | 800 |
| Example 12 | (12) | 1.21 | 98% | 0.10 | ◯ | 0 point | 98% | ◯ | 3.3 | ◯ | 48 | 790 |
| Example 13 | (13) | 1.20 | 96% | 0.10 | ◯ | 0 point | 92% | ◯ | 3.1 | ◯ | 35 | 800 |
| Example 14 | (14) | 1.27 | 94% | 0.09 | ◯ | 0 point | 89% | ◯ | 1.1 | ◯ | 50 | 790 |
| Example 15 | (15) | 1.26 | 95% | 0.10 | ◯ | 0 point | 91% | ◯ | 1.3 | ◯ | 51 | 800 |
| Example 16 | (16) | 1.28 | 94% | 0.09 | ◯ | 0 point | 92% | ◯ | 0.9 | ◯ | 51 | 790 |
| Example 17 | (17) | 1.24 | 91% | 0.10 | ◯ | 0 point | 89% | ◯ | 1.5 | ◯ | 50 | 800 |
| Example 18 | (18) | 1.26 | 95% | 0.10 | ◯ | 0 point | 91% | ◯ | 1.6 | ◯ | 52 | 790 |
| Example 19 | (19) | 1.28 | 93% | 0.09 | ◯ | 0 point | 89% | ◯ | 1.2 | ◯ | 51 | 800 |
| Example 20 | (20) | 1.25 | 92% | 0.10 | ◯ | 0 point | 91% | ◯ | 1.3 | ◯ | 50 | 790 |
| Example 21 | (21) | 1.28 | 97% | 0.10 | ◯ | 0 point | 93% | ◯ | 1.2 | ◯ | 55 | 790 |
| Example 22 | (22) | 1.26 | 95% | 0.10 | ◯ | 0 point | 88% | ◯ | 1.1 | ◯ | 55 | 780 |
| Example 23 | (23) | 1.26 | 92% | 0.10 | ◯ | 0 point | 87% | ◯ | 1.0 | ◯ | 55 | 790 |
| Example 24 | (24) | 1.28 | 95% | 0.10 | ◯ | 0 point | 91% | ◯ | 1.0 | ◯ | 51 | 790 |
| Example 25 | (25) | 1.24 | 88% | 0.08 | ◯ | 0 point | 85% | ◯ | 1.3 | ◯ | 50 | 780 |
| Example 26 | (26) | 1.26 | 93% | 0.10 | ◯ | 0 point | 90% | ◯ | 1.3 | ◯ | 52 | 780 |
| Example 27 | (27) | 1.20 | 65% | 0.09 | Δ | 0 point | 80%% | Δ | 1.5 | ◯ | 55 | 760 |
| Example 28 | (28) | 1.22 | 98% | 0.12 | ◯ | 0 point | 92% | ◯ | 1.2 | ◯ | 50 | 800 |
| Example 29 | (29) | 1.26 | 98% | 0.11 | ◯ | 0 point | 96% | ◯ | 1.2 | ◯ | 51 | 790 |
| Comparative | (30) | 1.30 | 70% | 0.08 | X | 0 point | 60% | X | 1.5 | ◯ | 45 | 790 |
| example 1 | | | | | | | | | | | | |
| Comparative | (31) | 1.15 | 65% | 0.08 | X | 0 point | 65% | X | 1.4 | ◯ | 42 | 780 |
| example 2 | | | | | | | | | | | | |
| Comparative | (32) | 1.05 | 50% | 0.09 | Δ | 0 point | 55% | Δ | 1.6 | ◯ | 45 | 760 |
| example 3 | | | | | | | | | | | | |
| Comparative | (33) | 1.28 | 95% | 0.09 | ◯ | 0 point | 90% | ◯ | 6.0 | X | 51 | 780 |
| example 4 | | | | | | | | | | | | |
| Comparative | (34) | 1.28 | 95% | 0.09 | ◯ | 0 point | 90% | ◯ | 5.5 | X | 51 | 780 |
| example 5 | | | | | | | | | | | | |

According to the results shown in Table 1, with respect to the heat-sensitive recording materials (1) to (29) of the invention, no particular curling deformation was observed and printing and transportation were well carried out to show excellent handling easiness and in addition, high coloring density (high sensitivity) was obtained (good printing suitability) without deteriorating the background whiteness and due to the contact angle improvement, the ink jet suitability was provided and also excellent chemical resistance was provided and further head wear was lessened to show excellent thermal head matching property as well. That is, these heat-sensitive recording materials were found satisfactory simultaneously in all of the high production quality and handling easiness, high sensitivity, background whiteness, image storability, ink jet suitability, chemical resistance and thermal head matching property (wear resistance).

In comparison with the heat-sensitive recording material (1), the heat-sensitive recording materials (2) and (3) containing the image stabilizers were provided with improved image storability and ink resistance and the heat-sensitive recording material (6) containing a preferable adhesive (protection colloid) was provided with further improved sensitivity and lowered background fogging. Addition of the image stabilizers was found effective to give particularly excellent stamping suitability and handling easiness. In the case of the heat-sensitive recording materials (10) to (13) having protective layers containing specified inorganic pigments suitable for the second embodiment of the invention, the image storability and the ink resistance (chemical resistance) could further be improved. Also, due to the sensitizers used for Examples 14 to 20, preferable properties similar to those of the heat-sensitive recording material (1) of Example 1 were obtained and the electron-donating colorless dyes used for Examples 21 to 25 were found effective to keep background fogging low and give good coloration property and image storability. As shown in the case of Examples 1 and 26, curtain coating method was found preferable in terms of the sensitivity improvement. In the case where waste paper pulp was added to the support (Example 9), it did not cause any adverse effects on properties and abilities.

On the other hand, in the comparative heat-sensitive recording materials (30) to (34) using the described electron-accepting compounds, the properties and abilities which the heat-sensitive recording materials are required to have were not satisfied all together and these heat-sensitive recording materials were found inferior in the image storability, chemical resistance, and ink jet suitability even if the curl degree, handling easiness, and the sensitivity were kept good and if the image storability was considered with a high priority, the curl degree and handling easiness were deteriorated. Further, it was found effective to properly adjust the application of the back liquid to be optimum.

### Examples of the Second Embodiment

Hereinafter, the second embodiment of the invention will be described along with examples, however the second embodiment of the invention is not limited to these examples. Hereinafter, the terms “part(s)” and “%” denote “part(s) by mass” and “% by mass”.

### Example 30

The heat-sensitive recording materials of the second embodiment of the invention were produced by the following procedure by employing the following component constitutions and application methods and at the time of production, the coloring density was adjusted to be 1.20 or higher in the case of energy application at 15.2 mJ/mm² by the thermal head.

<Preparation of Coating Solution for Heat-Sensitive Recording Layer)

Preparation of Dispersion A (Containing Electron-Donating Colorless Dye)

The dispersion liquid A with the same composition as that of the dispersion liquid A in Example 1 of the first embodiment was prepared by the same manner as in Example 1.

Preparation of Dispersion Liquid B (Containing Electron-Accepting Compound)

The dispersion B with the same composition as that of the dispersion liquid B in Example 1 of the first embodiment was prepared by the same manner as in Example 1.

Preparation of Dispersion Liquid C (Containing Sensitizer)

The dispersion liquid C with the same composition as that of the dispersion liquid C in Example 1 of the first embodiment was prepared by the same manner as in Example 1.

Preparation of Dispersion Liquid D (Containing Pigment)

The dispersion liquid D with the same composition as that of the dispersion liquid D in Example 1 of the first embodiment was prepared by the same manner as in Example 1.

Preparation of Coating Colution for Heat-Sensitive Recording Layer

The following compositions were mixed to produce the coating solution for the heat-sensitive recording layer.

(Composition of Coating Solution for Heat-Sensitive Recording Layer)

| | |
|---|---|
| Dispersion liquid A | 60 parts |
| Dispersion liquid B | 120 parts |
| Dispersion liquid C | 120 parts |
| Dispersion liquid D-2 | 101 parts |
| 30% Zinc stearate dispersion liquid | 15 parts |
| Paraffin wax (30%) | 15 parts |
| Sodium dodecylbenzenesulfonate (25%) | 4 parts |

<Preparation of Coating Solution for Undercoat Layer of Support>

The coating solution for the undercoat layer of the support with the same composition as that of the solution in Example 1 of the first embodiment was prepared by the same manner as in Example 1.

<Preparation of a Heat-Sensitive Recording Material>

Woodfree paper having smoothness measured by JIS-P8119 of 150 seconds was prepared as a substrate. The coating solution for an undercoat layer of a substrate obtained above was applied to the surface of the woodfree paper by a blade coater so that the coating amount after drying became 8 g/m² and an undercoat layer was thus formed. By applying the undercoat layer, the smoothness measured by JIS-P8119 of the substrate became 350 seconds.

The coating solution for a heat-sensitive recording layer obtained above was then applied to the undercoat layer with a curtain coater so that the coating amount after drying became 4 g/m². The resultant coating was dried and a heat-sensitive recording layer was thus obtained. The surface of the thus-formed heat-sensitive recording layer was then subjected to calendaring treatment and a heat-sensitive recording material of the invention (33) was obtained.

The color development density of the obtained heat-sensitive recording material (33) (measured by Macbeth reflection densitometer RD-918) at an energy, applied to a thermal head, of 15.2 mJ/mm², which was measured according to the same conditions and method as those in evaluations described later, was 1.28.

### Example 31

Preparation of Dispersion Liquid E

Dispersion liquid E with the same composition as that in Example 2 of the first embodiment was prepared by the same manner.

Preparation of Coating Solution for Heat-Sensitive Recording Layer

The dispersion liquids A, B, C and D-2 were prepared in the same manner as in Example 30 and together with the dispersion liquid E obtained as described above, these dispersion liquids were mixed to produce the coating solution for the heat-sensitive recording layer and further in the same manner as in Example 30, the heat-sensitive recording material (36) of the invention was obtained.

(Composition of a Coating Solution for a Heat-Sensitive Recording Layer)

| | |
|---|---|
| Dispersion liquid A | 60 parts |
| Dispersion liquid B | 120 parts |
| Dispersion liquid C | 120 parts |
| Dispersion liquid D-2 | 101 parts |
| 30% Zinc stearate dispersion liquid | 15 parts |
| Paraffin wax (30%) | 20 parts |
| Sodium dodecylbenzenesulfonate (25%) | 4 parts |

### Example 32

Dispersion liquid E was prepared in the same manner as in Example 31 except that 1,1,3-tris(2-methyl-4-hydroxy-5-cyclohexylphenyl)butane was used instead of 1,1,3-tris(2-methyl-4-hydroxy-5-tert-butylphenyl)butane (an image stabilizer) used in the preparation of dispersion liquid E. Furthermore, the heat-sensitive recording material of the invention (37) was obtained in the same manner as in Example 31.

### Examples 33 and 34

The heat-sensitive recording materials of the invention (38) and (39) were obtained in the same manner as in Example 30 except that 20 parts of amorphous silica (trade name: MIZUKASIL P832, manufactured by Mizusawa Industrial Chemicals, Ltd.) and 40 parts of aluminum hydroxide (trade name: HYGILITE H42, manufactured by Showa Denko K.K.) were used, respectively, instead of 40 parts of calcite light calcium carbonate (UNIVER 70; inorganic pigment) used in the preparation of dispersion liquid D-2.

### Example 35

The heat-sensitive recording material of the invention (40) was obtained in the same manner as in Example 30 except that a 2.5% sulfo-modified polyvinyl alcohol (trade name: GOHSERAN L3266, manufactured by Nippon Synthetic Chemical Industry Co., Ltd.) aqueous solution was used instead of a 2.5% polyvinyl alcohol aqueous solution (an adhesive) used in the preparations of dispersion liquids A, B and C.

### Example 36

The heat-sensitive recording material of the invention (41) was obtained in the same manner as in Example 30 except that a 2.5% polyvinyl alcohol aqueous solution (an adhesive) used in the preparations of dispersion liquids A, B and C was changed to a 2.5% diacetone-modified polyvinyl alcohol (trade name: D500, manufactured by Unitika Ltd.) aqueous solution to prepare dispersion liquids A, B and C, and that 13 parts of a 5% adipic acid dihydrazide aqueous solution (a crosslinking agent) was added to the coating solution for a heat-sensitive recording layer obtained by mixing the thus-obtained dispersion liquids A, B and C.

### Example 37

The heat-sensitive recording material of the invention (42) was obtained in the same manner as in Example 30 except that a 2.5% polyvinyl alcohol aqueous solution (an adhesive) used in the preparations of dispersion liquids A B and C was changed to a 2.5% acetoacetyl-modified polyvinyl alcohol (trade name: GOHSEFIMER Z210, manufactured by Nippon Synthetic Chemical Industry Co., Ltd.) aqueous solution to prepare dispersion liquids A, B and C, and that 13 parts of a 5% glyoxal aqueous solution (a crosslinking agent) was added to the coating solution for a heat-sensitive recording layer obtained by mixing the thus-obtained dispersion liquids A, B and C.

### Example 38

The heat-sensitive recording material of the invention (43) was obtained in the same manner as in Example 30 except that recycled paper (50 g/m²) made of recycled pulp (70%) and LBKP (30%) and having smoothness measured by JIS-P8119 of 170 seconds was used instead of woodfree paper used as the substrate in Example 30.

### Example 39

The heat-sensitive recording material of the invention (44) was obtained in the same manner as in Example 30 except that, after formation of an undercoat layer on a substrate, the coating solution for a heat-sensitive recording layer obtained in Example 30 and the following coating solution for a protective layer were applied simultaneously with a curtain coater and the resultant coatings were dried to form multiple layers and the surface of the laminated protective layer was subjected to calendaring treatment instead of applying the coating solution for a heat-sensitive recording layer, drying and calendaring the resultant coating after formation of an undercoat layer on a substrate in the <Preparation of heat-sensitive recording material> of Example 30. The dried coating amount of the protective layer was 2.0 g/m².

Preparation of Coating Solution for Protective Layer

A coating solution for the protective layer with the same composition as that of the coating solution for the protective layer in Example 10 of the first embodiment was prepared by the same manner.

### Examples 40 to 42

The heat-sensitive recording materials of the invention (45) to (47) were obtained in the same manner as in Example 39 except that 40 parts of aluminum hydroxide (trade name: HYGILITE H43; volume mean diameter: 0.7 μm; manufactured by Showa Denko K.K.), 40 parts of kaolin (trade name: KAOBRITE; volume mean diameter: 2.5 μm; manufactured by Shiraishi Kogyo K.K.) and 20 parts of amorphous silica (trade name: MIZUKASIL P707; volume mean diameter: 2.2 μm; manufactured by Mizusawa Industrial Chemicals, Ltd.) were used, respectively, instead of 40 parts of aluminum hydroxide (HYGILITE H42; an inorganic pigment) used in the preparation of the coating solution for a protective layer in Example 39.

### Examples 43 to 49

The heat-sensitive recording materials of the invention (48) to (54) were obtained in the same manner as in Example 30 except that dimethylbenzyl oxalate (trade name: HS3520R-N, manufactured by Dainippon Ink and Chemicals, Inc.), m-terphenyl, ethylene glycol tolyl ether, p-benzylbiphenyl, 1,2-diphenoxymethylbenzene, diphenylsulfone and 1,2-diphenoxyethane were used, respectively, instead of 2-benzyloxynaphthalene (a sensitizer) used in the preparation of dispersion liquid C in Example 30.

### Examples 50 to 54

The heat-sensitive recording materials of the invention (55) to (59) were obtained in the same manner as in Example 30 except that 2-anilino-3-methyl-6-dibutylaminofluorane, 2-anilino-3-methyl-6-(N-ethyl-N-isoamylamino)fluorane, 2-anilino-3-methyl-6-(N-ethyl-N-propylamino)fluorane, 2-anilino-3-methyl-6-di-n-amylaminofluorane and 2-anilino-3-methyl-6-(N-ethyl-N-p-tolylamino)fluorine were used, respectively, instead of 2-anilino-3-methyl-6-diethylaminofluorane (an electron-donating colorless dye) used in the preparation of dispersion liquid A in Example 30.

### Example 55

The heat-sensitive recording material of the invention (60) was obtained in the same manner as in Example 30 except that an air knife coater was used instead of the curtain coater used in the application of the coating solution for a heat-sensitive recording layer in Example 30.

### Examples 56 to 59

The heat-sensitive recording materials of the invention (61) to (64) were obtained in the same manner as in Example 30 except that N-benzyl-4-hydroxybenzenesulfoneamide (=p-N-benzylsulfamoylphenol), BTUM, 4-hydroxy-4′-isopropoxydiphenylsulfone and 2,4-bis(phenylsulfonyl)phenol were used, respectively, instead of 4-hydroxybenzenesulfoneanilide (an electron-accepting compound) used in the preparation of dispersion liquid B in Example 30.

### Comparative Examples 6 and 7

The comparative heat-sensitive recording materials (65) and (66) were obtained in the same manner as in Example 30 except that 2,2′-bis(4-hydroxyphenol)propane (bisphenol A) and 4,4′-di-hydroxydiphenylsulfone were used, respectively, instead of 4-hydroxybenzenesulfoneanilide (an electron-accepting compound) used in the preparation of dispersion liquid B in Example 30.

### Comparative Example 8

The comparative heat-sensitive recording material (67) was obtained in the same manner as in Example 30 except that the amount of 4-hydroxybenzenesulfoneanilide (an electron-accepting compound) used in the preparation of dispersion liquid B in Example 30 was changed from 20 parts to 4 parts.

### Comparative Example 9

A The comparative heat-sensitive recording material (68) was obtained in the same manner as in Example 30, except that the application amount of the coating solution for the heat-sensitive recording layer was changed to be 10 g/m² in Example 30.

(Evaluation)

The heat-sensitive recording materials (35) to (64) of the invention and the heat-sensitive recording materials (65) to (68) for comparison obtained in the above described manner were subjected to the following measurements and evaluations. The results of the measurements and evaluations are shown in the following Table 2.

(1) Measurement of the Sensitivity

The sensitivity was measured by the same evaluation and method in Examples of the first embodiment.

(2) Evaluation of Background Whiteness

The background portions of the respective heat-sensitive recording material surfaces were measured by Macbeth reflection densitometer (trade name: RD-918, manufactured by Macbeth Co.).

(3) Evaluation of Background Fogging

The background fogging was evaluated by the same evaluation and method in Examples of the first embodiment.

(4) Evaluation of Image Storability

The image storability was evaluated by the same evaluation and method in Examples of the first embodiment.

(5) Evaluation of Chemical Resistance

The chemical resistance was evaluated by the same evaluation and method in Examples of the first embodiment.

(6) Evaluation of Printing Troubles Caused by Friction Between a Head and a Recording Material

The printing troubles caused by friction between a head and a recording material was evaluated by the same evaluation and method in Examples of the first embodiment.

(7) Evaluation of Ink Jet Suitability

[1] Ink Resistance

The ink resistance was evaluated by the same evaluation and method in Examples of the first embodiment.

[2] Ink Jet Recording Applicability

The ink jet recording suitability was evaluated by the same evaluation and method in Examples of the first embodiment.

(8) Measurement of Contact Angle

The contact angle was measured by the same evaluation and method in Examples of the first embodiment.

(9) Measurement of Concentration of Ions (Na⁺ and K⁺)

The ion concentration was measured by the same evaluation and method in Examples of the first embodiment.

TABLE 2

| | Heat- | | | | Background | | | Ink jet suitability | | | Ion |
|---|---|---|---|---|---|---|---|---|---|---|---|
| | sensitive | Image | | | fogging density | | | | ink jet | Contact | concen- |
| | recording | density | Background | Image | of background | Chemical | Printing | ink | recording | angle | tration |
| | material | (sensitivity) | whiteness | storability | portion | resistance | trouble | resistance | suitability | [°] | [ppm] |
| Example 30 | (35) | 1.28 | 0.07 | 95% | 0.09 | ◯ | 0 point | 90% | ◯ | 51 | 780 |
| Example 31 | (36) | 1.27 | 0.08 | 98% | 0.10 | ◯ | 0 point | 93% | ◯ | 55 | 800 |
| Example 32 | (37) | 1.26 | 0.08 | 97% | 0.10 | ◯ | 0 point | 92% | ◯ | 53 | 800 |
| Example 33 | (38) | 1.26 | 0.08 | 93% | 0.10 | ◯ | 0 point | 88% | ◯ | 50 | 770 |
| Example 34 | (39) | 1.27 | 0.07 | 96% | 0.09 | ◯ | 0 point | 91% | ◯ | 55 | 790 |
| Example 35 | (40) | 1.30 | 0.06 | 96% | 0.08 | ◯ | 0 point | 93% | ◯ | 50 | 800 |
| Example 36 | (41) | 1.29 | 0.06 | 97% | 0.08 | ◯ | 0 point | 92% | ◯ | 52 | 800 |
| Example 37 | (42) | 1.28 | 0.07 | 95% | 0.08 | ◯ | 0 point | 93% | ◯ | 55 | 790 |
| Example 38 | (43) | 1.28 | 0.07 | 94% | 0.09 | ◯ | 0 point | 93% | ◯ | 60 | 800 |
| Example 39 | (44) | 1.23 | 0.07 | 98% | 0.09 | ◯ | 0 point | 98% | ◯ | 45 | 800 |
| Example 40 | (45) | 1.22 | 0.07 | 97% | 0.10 | ◯ | 0 point | 97% | ◯ | 42 | 800 |
| Example 41 | (46) | 1.21 | 0.08 | 98% | 0.10 | ◯ | 0 point | 98% | ◯ | 48 | 790 |
| Example 42 | (47) | 1.20 | 0.08 | 96% | 0.09 | ◯ | 0 point | 92% | ◯ | 35 | 800 |
| Example 43 | (48) | 1.27 | 0.07 | 94% | 0.10 | ◯ | 0 point | 89% | ◯ | 50 | 790 |
| Example 44 | (49) | 1.26 | 0.08 | 95% | 0.09 | ◯ | 0 point | 91% | ◯ | 51 | 800 |
| Example 45 | (50) | 1.28 | 0.07 | 94% | 0.10 | ◯ | 0 point | 92% | ◯ | 51 | 790 |
| Example 46 | (51) | 1.24 | 0.07 | 91% | 0.10 | ◯ | 0 point | 89% | ◯ | 50 | 800 |
| Example 47 | (52) | 1.26 | 0.08 | 95% | 0.09 | ◯ | 0 point | 91% | ◯ | 52 | 490 |
| Example 48 | (53) | 1.28 | 0.07 | 93% | 0.10 | ◯ | 0 point | 89% | ◯ | 51 | 800 |
| Example 49 | (54) | 1.25 | 0.07 | 92% | 0.10 | ◯ | 0 point | 91% | ◯ | 50 | 790 |
| Example 50 | (55) | 1.28 | 0.08 | 97% | 0.10 | ◯ | 0 point | 93% | ◯ | 55 | 790 |
| Example 51 | (56) | 1.26 | 0.08 | 95% | 0.10 | ◯ | 0 point | 88% | ◯ | 55 | 780 |
| Example 52 | (57) | 1.26 | 0.08 | 92% | 0.10 | ◯ | 0 point | 87% | ◯ | 55 | 790 |
| Example 53 | (58) | 1.28 | 0.08 | 95% | 0.10 | ◯ | 0 point | 91% | ◯ | 51 | 790 |
| Example 54 | (59) | 1.24 | 0.06 | 88% | 0.08 | ◯ | 0 point | 85% | ◯ | 50 | 780 |
| Example 55 | (60) | 1.26 | 0.09 | 93% | 0.10 | ◯ | 0 point | 90% | ◯ | 52 | 780 |
| Example 56 | (61) | 1.20 | 0.10 | 65% | 0.09 | Δ | 0 point | 80% | Δ | 55 | 760 |
| Example 57 | (62) | 1.22 | 0.10 | 98% | 0.12 | ◯ | 0 point | 92% | ◯ | 50 | 800 |
| Example 58 | (63) | 1.26 | 0.07 | 91% | 0.07 | ◯ | 0 point | 93% | ◯ | 52 | 780 |
| Example 59 | (64) | 1.26 | 0.09 | 98% | 0.11 | ◯ | 0 point | 96% | ◯ | 51 | 790 |
| Comparative | (65) | 1.30 | 0.07 | 70% | 0.08 | X | 0 point | 60% | X | 45 | 790 |
| example 6 | | | | | | | | | | | |
| Comparative | (66) | 1.15 | 0.07 | 65% | 0.08 | X | 0 point | 65% | X | 42 | 780 |
| example 7 | | | | | | | | | | | |
| Comparative | (67) | 1.05 | 0.07 | 50% | 0.09 | Δ | 0 point | 55% | Δ | 45 | 760 |
| example 8 | | | | | | | | | | | |
| Comparative | (68) | 1.35 | 0.12 | 85% | 0.15 | ◯ | 0 point | 80% | ◯ | 55 | 1100 |
| example 9 | | | | | | | | | | | |

According to the results shown in Table 2, with respect to the heat-sensitive recording materials (35) to (64) of the invention containing the electron-accepting compounds represented by the general formula (1) and provided with the coloring density adjusted to be 1.20 or higher by energy application at 15.2 mJ/mm², the background fogging in the background portions was kept to low, high coloring density (high sensitivity) was obtained (good printing suitability) and the image storability after printing was good and due to the contact angle improvement, the ink jet suitability was provided and also excellent chemical resistance was provided and further head wear was lessened to show excellent thermal head matching property as well. That is, these heat-sensitive recording materials were found satisfactory simultaneously in all of the high sensitivity as well as background whiteness, image storability, ink jet suitability, chemical resistance and thermal head matching property (wear resistance).

In comparison with the heat-sensitive recording material (35), the heat-sensitive recording materials (36) and (37) containing the image stabilizers were provided with improved image storability and ink resistance and the heat-sensitive recording material (40) containing a preferable adhesive (protection colloid) was provided with further improved sensitivity and lowered background fogging. Addition of the image stabilizers was found effective to give particularly excellent stamping suitability and handling easiness. In the case of the heat-sensitive recording materials (44) to (47) having protective layers containing specified inorganic pigments suitable for the first embodiment of the invention, the image storability and the ink resistance (chemical resistance) could further be improved. Also, due to the sensitizers used for Examples 43 to 49, preferable properties similar to those of the heat-sensitive recording material (35) of Example 30 were obtained and the electron-donating colorless dyes used for Examples 50 to 54 were found effective to keep background fogging low and give good coloration property and image storability. As shown in the case of Examples 30 and 55, curtain coating method was found preferable in terms of the sensitivity improvement. In the case where waste paper pulp was added to the support (Example 38), it did not cause any adverse effects on properties and abilities.

On the other hand, in the comparative heat-sensitive recording materials (65) to (68) containing no compound represented by the general formula (1) as the electron-accepting compound, not only the high sensitivity was achieved but also the heat-sensitive recording materials were inferior in the image storability, chemical resistance, and ink jet suitability and thus the properties and abilities which the heat-sensitive recording material was required to have were not satisfied together. Further, in the case of the heat-sensitive recording material (68) for which the coating amount was increased, the material consumption amount was increased and effects on the environments were significant and further the energy was consumed so much at the time of drying and in addition, the drying temperature was required to be at a high temperature and accordingly, the background whiteness was deteriorated and the image storability tended to be deteriorated.

### Examples of the Third Embodiment

Hereinafter, the second embodiment of the invention will be described along with examples, however the second embodiment of the invention is not limited to these examples. “Parts” and “%” used in Examples mean “parts by mass” and “% by mass”, respectively.

### Example 60

The heat-sensitive recording materials of the third embodiment of the invention were produced by the following procedure by employing the following component constitutions and application methods and at the time of production, the coloring density was adjusted to be 1.20 or higher in the case of energy application at 15.2 mJ/mm² by the thermal head.

<Preparation of Coating Solution for Heat-Sensitive Recording Layer)

Preparation of Dispersion Liquid A (Containing Electron-Donating Colorless Dye)

The dispersion liquid A with the same composition as that of the dispersion liquid A in Example 1 of the first embodiment was prepared by the same manner as in Example 1.

Preparation of Dispersion Liquid B (Containing Electron-Accepting Compound)

The dispersion liquid B with the same composition as that of the dispersion liquid B in Example 1 of the first embodiment was prepared by the same manner as in Example 1.

Preparation of Dispersion Liquid C (Containing Sensitizer)

The dispersion liquid C with the same composition as that of the dispersion liquid C in Example 1 of the first embodiment was prepared by the same manner as in Example 1.

Preparation of Dispersion Liquid D (Containing Pigment)

The dispersion liquid D with the same composition as that of the dispersion liquid D in Example 1 of the first embodiment was prepared by the same manner as in Example 1.

Preparation of a Coating Solution for a Heat-Sensitive Recording Layer

The following components were mixed to give a coating solution for a heat-sensitive recording layer.

(Composition of a Coating Solution for a Heat-Sensitive Recording Layer)

| | |
|---|---|
| Dispersion liquid A | 60 parts |
| Dispersion liquid B | 120 parts |
| Dispersion liquid C | 120 parts |
| Dispersion liquid D | 101 parts |
| 30% Zinc stearate dispersion liquid | 15 parts |
| Paraffin wax (30%) | 15 parts |
| Sodium dodecylbenzenesulfonate (25%) | 4 parts |

<Preparation of Coating Solution for Undercoat Layer Of Support>

The coating solution for the undercoat layer of the support with the same composition as that of the solution in Example 1 of the first embodiment was prepared by the same manner as in Example 1.

<Preparation of a Heat-Sensitive Recording Material>

Woodfree paper having smoothness measured by JIS-P8119 of 150 seconds was prepared as a substrate. The coating solution for an undercoat layer of a substrate obtained above was applied to the surface of the woodfree paper by a blade coater so that the coating amount after drying became 8 g/m² and an undercoat layer was thus formed. By applying the undercoat layer, the smoothness measured by JIS-P8119 of the substrate became 350 seconds.

The coating solution for a heat-sensitive recording layer obtained above was then applied to the undercoat layer with a curtain coater so that the coating amount after drying became 4 g/m². The resultant coating was dried and a heat-sensitive recording layer was thus obtained. The surface of the thus-formed heat-sensitive recording layer was then subjected to calendaring treatment and a heat-sensitive recording material of the invention (69) was obtained.

The color development density of the obtained heat-sensitive recording material (69) (measured by Macbeth reflection densitometer RD-918) at an energy, applied to a thermal head, of 15.2 mJ/mm², which was measured according to the same conditions and method as those in evaluations described later, was 1.28.

### Example 61

Preparation of Dispersion Liquid E

Dispersion liquid E with the same composition as that in Example 2 of the second embodiment was prepared by the same manner.

Preparation of Coating Solution for Heat-Sensitive Recording Layer

The dispersion liquids A, B, C and D were prepared in the same manner as in Example 60 and together with the dispersion liquid E obtained as described above, these dispersion liquids were mixed to produce the coating solution for the heat-sensitive recording layer and further in the same manner as in Example 60, the heat-sensitive recording material (70) of the invention was obtained.

(Composition of a Coating Solution for a Heat-Sensitive Recording Layer)

| | |
|---|---|
| Dispersion liquid A | 60 parts |
| Dispersion liquid B | 120 parts |
| Dispersion liquid C | 120 parts |
| Dispersion liquid D | 101 parts |
| 30% Zinc stearate dispersion liquid | 20 parts |
| Paraffin wax (30%) | 20 parts |
| Sodium dodecylbenzenesulfonate (25%) | 4 parts |

### Example 62

Example 61 except that 1,1,3-tris(2-methyl-4-hydroxy-5-cyclohexylphenyl)butane was used instead of 1,1,3-tris(2-methyl-4-hydroxy-5-tert-butylphenyl)butane (an image stabilizer) used in the preparation of dispersion liquid E. Furthermore, the heat-sensitive recording material of the invention (71) was obtained in the same manner as in Example 61.

### Examples 63 and 64

The heat-sensitive recording materials of the invention (72) and (73) were obtained in the same manner as in Example 60 except that 20 parts of amorphous silica (trade name: MIZUKASIL P832, manufactured by Mizusawa Industrial Chemicals, Ltd.) and 40 parts of aluminum hydroxide (trade name: HYGILITE H42, manufactured by Showa Denko K.K.) were used, respectively, instead of 40 parts of calcite light calcium carbonate (UNIVER 70; inorganic pigment) used in the preparation of dispersion liquid D.

### Example 65

The heat-sensitive recording material of the invention (74) was obtained in the same manner as in Example 60 except that a 2.5% sulfo-modified polyvinyl alcohol (trade name: GOHSERAN L3266, manufactured by Nippon Synthetic Chemical Industry Co., Ltd.) aqueous solution was used instead of a 2.5% polyvinyl alcohol aqueous solution (an adhesive) used in the preparations of dispersion liquids A B and C.

### Example 66

The heat-sensitive recording material of the invention (75) was obtained in the same manner as in Example 60 except that a 2.5% polyvinyl alcohol aqueous solution (an adhesive) used in the preparations of dispersion liquids A, B and C was changed to a 2.5% diacetone-modified polyvinyl alcohol (trade name: D500, manufactured by Unitika Ltd.) aqueous solution to prepare dispersion liquids A, B and C, and that 13 parts of a 5% adipic acid dihydrazide aqueous solution (a crosslinking agent) was added to the coating solution for a heat-sensitive recording layer obtained by mixing the thus-obtained dispersion liquids A, B and C.

### Example 67

The heat-sensitive recording material of the invention (76) was obtained in the same manner as in Example 60 except that a 2.5% polyvinyl alcohol aqueous solution (an adhesive) used in the preparations of dispersion liquids A, B and C was changed to a 2.5% acetoacetyl-modified polyvinyl alcohol (trade name: GOHSEFIMER Z210, manufactured by Nippon Synthetic Chemical Industry Co., Ltd.) aqueous solution to prepare dispersion liquids A, B and C, and that 13 parts of a 5% glyoxal aqueous solution (a crosslinking agent) was added to the coating solution for a heat-sensitive recording layer obtained by mixing the thus-obtained dispersion liquids A, B and C.

### Example 68

The heat-sensitive recording material of the invention (77) was obtained in the same manner as in Example 60 except that recycled paper (50 g/m²) made of recycled pulp (70%) and LBKP (30%) and having smoothness measured by JIS-P8119 of 170 seconds was used instead of woodfree paper used as the substrate in Example 60.

### Example 69

The heat-sensitive recording material of the invention (78) was obtained in the same manner as in Example 60 except that, after formation of an undercoat layer on a substrate, the coating solution for a heat-sensitive recording layer obtained in Example 60 and the following coating solution for a protective layer were applied simultaneously with a curtain coater and the resultant coatings were dried to form multiple layers and the surface of the laminated protective layer was subjected to calendaring treatment instead of applying the coating solution for a heat-sensitive recording layer, drying and calendaring the resultant coating after formation of an undercoat layer on a substrate in the <Preparation of heat-sensitive recording material> of Example 60. The dried coating amount of the protective layer was 2.0 g/m².

Preparation of Coating Solution for Protective Layer

A coating solution for the protective layer with the same composition as that of the coating solution for the protective layer in Example 10 of the first embodiment was prepared by the same manner.

### Examples 70 to 72

The heat-sensitive recording materials of the invention (79) to (81) were obtained in the same manner as in Example 69 except that 40 parts of aluminum hydroxide (trade name: HYGILITE H43; volume mean diameter: 0.7 μm; manufactured by Showa Denko K.K.), 40 parts of kaolin (trade name: KAOBRITE; volume mean diameter: 2.5 μm; manufactured by Shiraishi Kogyo K.K.) and 20 parts of amorphous silica (trade name: MIZUKASIL P707; volume mean diameter: 2.2 μm; manufactured by Mizusawa Industrial Chemicals, Ltd.) were used, respectively, instead of 40 parts of aluminum hydroxide (HYGILITE H42; an inorganic pigment) used in the preparation of the coating solution for a protective layer in Example 69.

### Examples 73 to 79

The heat-sensitive recording materials of the invention (82) to (88) were obtained in the same manner as in Example 60 except that dimethylbenzyl oxalate (trade name: HS3520R-N, manufactured by Dainippon Ink and Chemicals, Inc.), m-terphenyl, ethylene glycol tolyl ether, p-benzylbiphenyl, 1,2-diphenoxymethylbenzene, diphenylsulfone and 1,2-diphenoxyethane were used, respectively, instead of 2-benzyloxynaphthalene (a sensitizer) used in the preparation of dispersion liquid C.

### Examples 80 to 84

The heat-sensitive recording materials of the invention (89 to (93) were obtained in the same manner as in Example 60 except that 2-anilino-3-methyl-6-dibutylaminofluorane, 2-anilino-3-methyl-6-(N-ethyl-N-isoamylamino)fluorane, 2-anilino-3-methyl-6-(N-ethyl-N-propylamino)fluorane, 2-anilino-3-methyl-6-di-n-amylaminofluorane and 2-anilino-3-methyl-6-(N-ethyl-N-p-tolylamino)fluorine were used, respectively, instead of 2-anilino-3-methyl-6-diethylaminofluorane (an electron-donating colorless dye) used in the preparation of dispersion liquid A in Example 60.

### Example 85

The heat-sensitive recording material of the invention (94) was obtained in the same manner as in Example 60 except that an air knife coater was used instead of the curtain coater used in the application of the coating solution for a heat-sensitive recording layer in Example 60.

### Examples 86 to 89

The heat-sensitive recording materials of the invention (95) to (98) were obtained in the same manner as in Example 60 except that N-benzyl-4-hydroxybenzenesulfoneamide (=p-N-benzylsulfamoylphenol), BTUM, 4-hydroxy-4′-isopropoxydiphenylsulfone and 2,4-bis(phenylsulfonyl)phenol were used, respectively, instead of 4-hydroxybenzenesulfoneanilide (an electron-accepting compound) used in the preparation of dispersion liquid B in Example 60.

### Comparative Example 10

The comparative heat-sensitive recording material (99) was obtained in the same manner as in Example 60 except that 4,4′-di-hydroxydiphenylsulfone was used instead of 4-hydroxybenzenesulfoneanilide (an electron-accepting compound) used in the preparation of dispersion liquid B in Example 60.

### Comparative Example 11

The comparative heat-sensitive recording material (100) was obtained in the same manner as in Example 60, except that the amount of 4-hydroxybenzenesulfonealinide (the electron-accepting compound) used for the preparation of the dispersion liquid B of Example 60 was changed to be 4 parts form 20 parts.

### Comparative Example 12

The comparative heat-sensitive recording material (101) was obtained in the same manner as in Example 60, except that the woodfree paper with smoothness of 150 seconds measured according to JIS-P8119 used for the support for Example 60 was changed to the wood-free paper with smoothness of 30 seconds and neither dispersion liquid of 30% zinc stearate nor paraffin wax was used for the coating solution for the heat-sensitive recording layer.

### Comparative Example 13

The comparative heat-sensitive recording material (102) was obtained in the same manner as in Example 60, except that the wood-free paper with smoothness of 150 seconds measured according to JIS-P8119 used for the support for Example 60 was changed to the coated paper with smoothness of 1,000 seconds and the amount of the dispersion liquid of 30% zinc stearate used for the coating solution for the heat-sensitive recording layer was changed to be 45 parts from 15 parts and the amount of the paraffin wax was changed to be 45 parts from 15 parts.

(Evaluation)

The heat-sensitive recording materials (69) to (98) of the invention and the heat-sensitive recording materials (99) to (102) for comparison obtained in the above described manner were subjected to the following measurements and evaluations. The results of the measurements and evaluations are shown in the following Table 3.

(1) Measurement of the Sensitivity

The sensitivity was measured by the same evaluation and method in Examples of the first embodiment.

(2) Measurement of the Static Friction Coefficient and Dynamic Friction Coefficient

According to ASTM D 1897-73, the static friction coefficient and dynamic friction coefficient were measured. That is, the heat-sensitive recording material having the heat-sensitive recording layer only in one face was cut into a size of 100 mm width and 200 mm length at a thermostat chamber at 23° C. (a heat-sensitive recording material piece A) and stuck to a smooth plate while the recording face being set upside. A heat-sensitive recording material piece B cut in a size of 60 mm width ad 120 mm length in the same manner was wound around a load weight [W⁰=1.96 N (200 gf): hereinafter, referred to as sleigh] while the recording face being set in the inside and fixed by a cellophane tape. The sleigh was connected to the load cell by a monofilament string and the sleigh wrapped with the heat-sensitive recording material piece B was lightly put on the heat-sensitive recording face of the heat-sensitive recording material piece A stuck to the smooth plate and the smooth plate was moved at a testing speed 600 mm/min to measure the static friction coefficient and the dynamic friction coefficient.

(3) Evaluation of Image Storability

The image storability was measured by the same evaluation and method in Examples of the first embodiment.

(4) Evaluation of Background Fogging

The background fogging was evaluated by the same evaluation and method in Examples of the first embodiment.

(5) Evaluation of Chemical Resistance

The chemical resistance was evaluated by the same evaluation and method in Examples of the first embodiment.

(6) Evaluation of Printing Troubles Caused by Friction Between a Head and a Recording Material

The printing troubles caused by friction between a head and a recording material was evaluated by the same evaluation and method in Examples of the first embodiment.

(7) Transportation Property

Using a word processor (trade name: Rupo 95JV, manufactured by Toshiba), 30 sheets of each heat-sensitive recording material with A4 size were set in a feeding part and printing was carried out on the sheets and the evaluation was carried out according to the following standards.
◯: Sheets were fed normally one by one.
X: No sheet was fed or a plurality of sheets were simultaneously fed together.
   (8) Evaluation of Ink Jet Suitability
   [1] Ink Resistance

The ink resistance was evaluated by the same evaluation and method in Examples of the first embodiment.

[2] Ink Jet Recording Applicability

The ink jet recording suitability was evaluated by the same evaluation and method in Examples of the first embodiment.

(9) Measurement of Contact Angle

The contact angle was measured by the same evaluation and method in Examples of the first embodiment.

(10) Measurement of Concentration of Ions (Na⁺ and K⁺)

The ion concentration was measured by the same evaluation and method in Examples of the first embodiment.

TABLE 3

| | | | | | | | | | | Ink jet | | | |
|---|---|---|---|---|---|---|---|---|---|---|---|---|---|
| | Heat- | Image | Static | | | Back- | | | | suitability | | | Ion |
| | sensitive | density | friction | Dynamic | | ground | | | Trans- | ink | ink jet | Contact | concen- |
| | recording | (sensi- | coef- | friction | Image | fogging | Chemical | Printing | portation | resis- | recording | angle | tration |
| | material | tivity) | ficient | coefficient | storability | density | resistance | trouble | property | tance | suitability | [°] | [ppm] |
| Example 60 | (69) | 1.28 | 0.40 | 0.35 | 95% | 0.09 | ◯ | 0 point | ◯ | 90% | ◯ | 51 | 780 |
| Example 61 | (70) | 1.27 | 0.40 | 0.36 | 98% | 0.10 | ◯ | 0 point | ◯ | 93% | ◯ | 55 | 800 |
| Example 62 | (71) | 1.26 | 0.40 | 0.35 | 97% | 0.10 | ◯ | 0 point | ◯ | 92% | ◯ | 53 | 800 |
| Example 63 | (72) | 1.26 | 0.39 | 0.35 | 93% | 0.10 | ◯ | 0 point | ◯ | 88% | ◯ | 50 | 770 |
| Example 64 | (73) | 1.27 | 0.42 | 0.39 | 96% | 0.09 | ◯ | 0 point | ◯ | 91% | ◯ | 55 | 790 |
| Example 65 | (74) | 1.30 | 0.40 | 0.35 | 96% | 0.08 | ◯ | 0 point | ◯ | 93% | ◯ | 50 | 800 |
| Example 66 | (75) | 1.29 | 0.40 | 0.36 | 97% | 0.08 | ◯ | 0 point | ◯ | 92% | ◯ | 52 | 800 |
| Example 67 | (76) | 1.28 | 0.40 | 0.35 | 95% | 0.08 | ◯ | 0 point | ◯ | 93% | ◯ | 55 | 790 |
| Example 68 | (77) | 1.28 | 0.47 | 0.44 | 94% | 0.09 | ◯ | 0 point | ◯ | 93% | ◯ | 60 | 800 |
| Example 69 | (78) | 1.23 | 0.35 | 0.30 | 98% | 0.09 | ◯ | 0 point | ◯ | 98% | ◯ | 45 | 800 |
| Example 70 | (79) | 1.22 | 0.30 | 0.27 | 97% | 0.09 | ◯ | 0 point | ◯ | 97% | ◯ | 42 | 800 |
| Example 71 | (80) | 1.21 | 0.36 | 0.28 | 98% | 0.10 | ◯ | 0 point | ◯ | 98% | ◯ | 48 | 790 |
| Example 72 | (81) | 1.20 | 0.35 | 0.29 | 96% | 0.10 | ◯ | 0 point | ◯ | 92% | ◯ | 35 | 800 |
| Example 73 | (82) | 1.27 | 0.40 | 0.35 | 94% | 0.09 | ◯ | 0 point | ◯ | 89% | ◯ | 50 | 790 |
| Example 74 | (83) | 1.26 | 0.40 | 0.36 | 95% | 0.10 | ◯ | 0 point | ◯ | 91% | ◯ | 51 | 800 |
| Example 75 | (84) | 1.28 | 0.41 | 0.35 | 94% | 0.09 | ◯ | 0 point | ◯ | 92% | ◯ | 51 | 790 |
| Example 76 | (85) | 1.24 | 0.40 | 0.35 | 91% | 0.10 | ◯ | 0 point | ◯ | 89% | ◯ | 50 | 800 |
| Example 77 | (86) | 1.26 | 0.41 | 0.36 | 95% | 0.10 | ◯ | 0 point | ◯ | 91% | ◯ | 52 | 790 |
| Example 78 | (87) | 1.28 | 0.40 | 0.35 | 93% | 0.09 | ◯ | 0 point | ◯ | 89% | ◯ | 51 | 800 |
| Example 79 | (88) | 1.25 | 0.41 | 0.36 | 92% | 0.10 | ◯ | 0 point | ◯ | 91% | ◯ | 50 | 790 |
| Example 80 | (89) | 1.28 | 0.41 | 0.35 | 97% | 0.10 | ◯ | 0 point | ◯ | 93% | ◯ | 55 | 790 |
| Example 81 | (90) | 1.26 | 0.40 | 0.36 | 95% | 0.10 | ◯ | 0 point | ◯ | 88% | ◯ | 55 | 780 |
| Example 82 | (91) | 1.26 | 0.40 | 0.35 | 92% | 0.10 | ◯ | 0 point | ◯ | 87% | ◯ | 55 | 790 |
| Example 83 | (92) | 1.28 | 0.40 | 0.36 | 95% | 0.10 | ◯ | 0 point | ◯ | 91% | ◯ | 51 | 790 |
| Example 84 | (93) | 1.24 | 0.41 | 0.35 | 88% | 0.08 | ◯ | 0 point | ◯ | 85% | ◯ | 50 | 780 |
| Example 85 | (94) | 1.26 | 0.34 | 0.31 | 93% | 0.10 | ◯ | 0 point | ◯ | 90% | ◯ | 52 | 780 |
| Example 86 | (95) | 1.20 | 0.40 | 0.35 | 65% | 0.9 | Δ | 0 point | ◯ | 80% | Δ | 55 | 760 |
| Example 87 | (96) | 1.22 | 0.40 | 0.36 | 98% | 0.12 | ◯ | 0 point | ◯ | 92% | ◯ | 50 | 800 |
| Example 88 | (97) | 1.26 | 0.41 | 0.36 | 91% | 0.07 | ◯ | 0 point | ◯ | 93% | ◯ | 52 | 780 |
| Example 89 | (98) | 1.26 | 0.40 | 0.35 | 98% | 0.11 | ◯ | 0 point | ◯ | 96% | ◯ | 51 | 790 |
| Comparative | (99) | 1.15 | 0.41 | 0.36 | 65% | 0.08 | X | 0 point | ◯ | 65% | X | 42 | 780 |
| example 10 | | | | | | | | | | | | | |
| Comparative | (100) | 1.05 | 0.40 | 0.35 | 50% | 0.09 | Δ | 0 point | ◯ | 55% | Δ | 45 | 760 |
| example 11 | | | | | | | | | | | | | |
| Comparative | (101) | 1.1 | 0.65 | 0.60 | 92% | 0.09 | X | 0 point | X | 88% | X | 35 | 720 |
| example 12 | | | | | | | | | | | | | |
| Comparative | (102) | 1.16 | 0.17 | 0.15 | 88% | 0.10 | X | 0 point | X | 84% | X | 60 | 820 |
| example 13 | | | | | | | | | | | | | |

According to the results shown in Table 3, with respect to the heat-sensitive recording materials (69) to (98) of the invention provided with the coloring density adjusted to be 1.20 or higher by energy application at 15.2 mJ/mm² and the static friction coefficient and the dynamic friction coefficient adjusted in the range of 0.2 to 0.5 or higher in the case where the outermost surface of the front side having at least one heat-sensitive recording layer and the outermost surface of the rear side are rubbed against each other, the background fogging in the background portions was kept to low, high coloring density (high sensitivity) was obtained (good printing suitability) and the image storability after printing was good and due to the contact angle improvement, the ink jet suitability was provided and also excellent chemical resistance was provided and further head wear was lessened to show excellent thermal head matching property as well. Further the third embodiment of the heat-sensitive recording materials of the invention was found excellent in the transportation property.

In comparison with the heat-sensitive recording material (69), the heat-sensitive recording materials (70) and (71) containing the image stabilizers were provided with improved image storability and ink resistance and the heat-sensitive recording material (74) containing a preferable adhesive (protection colloid) was provided with further improved sensitivity and lowered background fogging. Addition of the image stabilizers was found effective to give particularly excellent stamping suitability and handling easiness. In the case of the heat-sensitive recording materials (78) to (81) having protective layers containing specified inorganic pigments suitable for the third embodiment of the invention, the image storability and the ink resistance (chemical resistance) could further be improved. Also, due to the sensitizers used for Examples 73 to 79, preferable properties similar to those of the heat-sensitive recording material (69) of Example 60 were obtained and the electron-donating colorless dyes used for Examples 80 to 84 were found effective to keep background fogging low and give good coloration property and image storability. As shown in the case of Examples 60 and 85, curtain coating method was found preferable in terms of the sensitivity improvement. In the case where waste paper pulp was added to the support (Example 68), it did not cause any adverse effects on properties and abilities.

On the other hand, in the comparative heat-sensitive recording materials (99) to (102) containing no compound represented by the general formula (1) as the electron-accepting compound and having the image density of printing by a thermal head with energy application at 15.2 mJ/mm² lower than 1.20, not only the high sensitivity was achieved but also the heat-sensitive recording materials were inferior in the image storability, chemical resistance, and ink jet suitability and thus the properties and abilities which the heat-sensitive recording material was required to have were not satisfied together.

### Examples of the Fourth Embodiment

Hereinafter, the second embodiment of the invention will be described along with examples, however the second embodiment of the invention is not limited to these examples. “Parts” and “%” used in Examples mean “parts by mass” and “% by mass”, respectively.

### Example 90

<Preparation of Coating Solution for Heat-Sensitive Recording Layer)

Preparation of Dispersion Liquid A (Containing Electron-Donating Colorless Dye)

The dispersion liquid A with the same composition as that of the dispersion liquid A in Example 1 of the first embodiment was prepared by the same manner as in Example 1.

Preparation of Dispersion Liquid B (Containing Electron-Accepting Compound)

The dispersion liquid B with the same composition as that of the dispersion liquid B in Example 1 of the first embodiment was prepared by the same manner as in Example 1.

Preparation of Dispersion Liquid C (Containing Sensitizer)

The dispersion liquid C with the same composition as that of the dispersion liquid C in Example 1 of the first embodiment was prepared by the same manner as in Example 1.

Preparation of Dispersion Liquid D-4 (Containing Pigment)

The dispersion liquid D-4 with a volume mean diameter of 2.0 μm was obtained by mixing the following respective components and then dispersing them. The volume mean diameter was measured in the same manner as the case of the dispersion liquid A.

[Composition of the dispersion liquid D-4]

| | | |
|---|---|---|
| Calcite type light calcium carbonate (pigment) | 40 | parts, |
| (trade name: Unibur 70, manufactured by | | |
| Shiraishi Kogyo Kaisha, Ltd.; boiled linseed oil | | |
| absorption amount: 55 ml/100 g) | | |
| Aqueous solution of 40% sodium hexametaphosphate | 1 | part, and |
| Distilled water | 60 | parts. |

Preparation of Coating Solution of
Heat-sensitive recording Layer

| | | |
|---|---|---|
| Dispersion liquid A | 60 | parts, |
| Dispersion liquid B | 120 | parts, |
| Dispersion liquid C | 120 | parts, |
| Dispersion liquid D-4 | 101 | parts, |
| 30% Zinc stearate dispersion liquid of | 15 | parts, |
| Paraffin wax (30%) | 15 | parts, and |
| Sodium dodecylbenzenesulfonate (25%) | 4 | parts |

<Preparation of Coating Solution for Undercoat Layer of Support>

The coating solution for the undercoat layer of the support with the same composition as that of the solution in Example 1 of the first embodiment was prepared by the same manner as in Example 1, except that distilled water was used for water.

<Preparation of a Heat-Sensitive Recording Material>

Woodfree paper having smoothness measured by JIS-P8119 of 150 seconds was prepared as a substrate. The coating solution for an undercoat layer of a substrate obtained above was applied to the surface of the woodfree paper by a blade coater so that the coating amount after drying became 8 g/m² and an undercoat layer was thus formed. By applying the undercoat layer, the smoothness measured by JIS-P8119 of the substrate became 350 seconds.

The coating solution for a heat-sensitive recording layer obtained above was then applied to the undercoat layer with a curtain coater so that the coating amount after drying became 4 g/m². The resultant coating was dried and a heat-sensitive recording layer was thus obtained. The surface of the thus-formed heat-sensitive recording layer was then subjected to calendaring treatment and a heat-sensitive recording material of the invention (103) was obtained

### Example 91

Preparation of Dispersion Liquid E

Dispersion liquid E with the same composition as that in Example 2 of the second embodiment was prepared by the same manner.

Preparation of Coarting Solution for Heat-Sensitive Layer

The dispersion liquids A, B, C and D-4 were prepared in the same manner as in Example 90 and together with the dispersion liquid E obtained as described above, these dispersion liquids were mixed to produce the coating solution for the heat-sensitive recording layer and further in the same manner as in Example 90, the heat-sensitive recording material (104) of the invention was obtained.

(Composition of Coating Solution for Heat-Sensitive-Color Develop Layer)

| | |
|---|---|
| Dispersion liquid A | 60 parts |
| Dispersion liquid B | 120 parts |
| Dispersion liquid C | 120 parts |
| Dispersion liquid E | 30 parts |
| Dispersion liquid D-4 | 101 parts |
| 30% Zinc stearate dispersion liquid | 15 parts |
| Paraffin wax (30%) | 15 parts |
| Sodium dodecylbenzenesulfonate (25%) | 3 parts |

### Example 92

Dispersion liquid E was prepared in the same manner as in Example 91 except that 1,1,3-tris(2-methyl-4-hydroxy-5-cyclohexylphenyl)butane was used instead of 1,1,3-tris(2-methyl-4-hydroxy-5-tert-butylphenyl)butane (an image stabilizer) used in the preparation of dispersion liquid E. Furthermore, the heat-sensitive recording material of the invention (105) was obtained in the same manner as in Example 91.

### Examples 93

The heat-sensitive recording materials of the invention (106) was obtained in the same manner as in Example 90 except that 20 parts of amorphous silica (trade name: MIZUKASIL P832, manufactured by Mizusawa Industrial Chemicals, Ltd., boiled linseed oil absorption amount: 145 ml/100 g), instead of 40 parts of calcite light calcium carbonate (UNIVER 70; inorganic pigment) used in the preparation of dispersion liquid D-4. The volume mean diameter of the pigment dispersion liquid D for the present example was 2.5 μm.

### Example 94

The heat-sensitive recording materials of the invention (106) was obtained in the same manner as in Example 90 except that 20 parts of aluminum hydroxide (trade name: HYGILITE H42, manufactured by Showa Denko K.K., boiled linseed oil absorption amount: 43 ml/100 g), instead of 40 parts of calcite light calcium carbonate (UNIVER 70; inorganic pigment) used in the preparation of dispersion liquid D-4. The volume mean diameter of the pigment dispersion liquid D for the present example was 0.8 μm.

### Example 95

The heat-sensitive recording material of the invention (108) was obtained in the same manner as in Example 90 except that a 2.5% sulfo-modified polyvinyl alcohol (trade name: GOHSERAN L3266, manufactured by Nippon Synthetic Chemical Industry Co., Ltd.) aqueous solution was used instead of a 2.5% polyvinyl alcohol aqueous solution (an adhesive) used in the preparations of dispersion liquids A, B and C.

### Example 96

The heat-sensitive recording material of the invention (109) was obtained in the same manner as in Example 90 except that a 2.5% polyvinyl alcohol aqueous solution (an adhesive) used in the preparations of dispersion liquids A, B and C was changed to a 2.5% diacetone-modified polyvinyl alcohol (trade name: D500, manufactured by Unitika Ltd.) aqueous solution to prepare dispersion liquids A, B and C, and that 13 parts of a 5% adipic acid dihydrazide aqueous solution (a crosslinking agent) was added to the coating solution for a heat-sensitive recording layer obtained by mixing the thus-obtained dispersion liquids A, B and C.

### Example 97

The heat-sensitive recording material of the invention (110) was obtained in the same manner as in Example 90 except that a 2.5% polyvinyl alcohol aqueous solution (an adhesive) used in the preparations of dispersion liquids A, B and C was changed to a 2.5% acetoacetyl-modified polyvinyl alcohol (trade name: GOHSEFIMER Z210, manufactured by Nippon Synthetic Chemical Industry Co., Ltd.) aqueous solution to prepare dispersion liquids A, B and C, and that 13 parts of a 5% glyoxal aqueous solution (a crosslinking agent) was added to the coating solution for a heat-sensitive recording layer obtained by mixing the thus-obtained dispersion liquids A, B and C.

### Example 98

The heat-sensitive recording material of the invention (111) was obtained in the same manner as in Example 90 except that recycled paper (50 g/m²) made of recycled pulp (70%) and LBKP (30%) and having smoothness measured by JIS-P8119 of 170 seconds was used instead of woodfree paper used as the substrate in Example 90.

### Example 99

The heat-sensitive recording material of the invention (112) was obtained in the same manner as in Example 90 except that, after formation of an undercoat layer on a substrate, the coating solution for a heat-sensitive recording layer obtained in Example 90 and the following coating solution for a protective layer were applied simultaneously with a curtain coater and the resultant coatings were dried to form multiple layers and the surface of the laminated protective layer was subjected to calendaring treatment instead of applying the coating solution for a heat-sensitive recording layer, drying and calendaring the resultant coating after formation of an undercoat layer on a substrate in the <Preparation of heat-sensitive recording material> of Example 90. The dried coating amount of the protective layer was 2.0 g/m².

Preparation of a Coating Solution for a Protective Layer

A coating solution for the the protective layer was prepared in the same manner and same composition of the coating solution as in Example 10 of the first embodiment.

### Examples 100 to 102

The heat-sensitive recording materials of the invention (113) to (115) were obtained in the same manner as in Example 99 except that 40 parts of aluminum hydroxide (trade name: HYGILITE H43; volume mean diameter: 0.7 μm; manufactured by Showa Denko K.K.), 40 parts of kaolin (trade name: KAOBRITE; volume mean diameter: 2.5 μm; manufactured by Shiraishi Kogyo K.K.) and 20 parts of amorphous silica (trade name: MIZUKASIL P707; volume mean diameter: 2.2 μm; manufactured by Mizusawa Industrial Chemicals, Ltd.) were used, respectively, instead of 40 parts of aluminum hydroxide (HYGILITE H42; an inorganic pigment) used in the preparation of the coating solution for a protective layer in Example 99.

### Examples 103 to 109

The heat-sensitive recording materials of the invention (116) to (122) were obtained in the same manner as in Example 90 except that dimethylbenzyl oxalate (trade name: HS3520R-N, manufactured by Dainippon Ink and Chemicals, Inc.), m-terphenyl, ethylene glycol tolyl ether, p-benzylbiphenyl, 1,2-diphenoxymethylbenzene, diphenylsulfone and 1,2-diphenoxyethane were used, respectively, instead of 2-benzyloxynaphthalene (a sensitizer) used in the preparation of dispersion liquid C.

### Examples 110 to 114

The heat-sensitive recording materials of the invention (123) to (127) were obtained in the same manner as in Example 90 except that 2-anilino-3-methyl-6-dibutylaminofluorane, 2-anilino-3-methyl-6-(N-ethyl-N-isoamylamino)fluorane, 2-anilino-3-methyl-6-(N-ethyl-N-propylamino)fluorane, 2-anilino-3-methyl-6-di-n-amylaminofluorane and 2-anilino-3-methyl-6-(N-ethyl-N-p-tolylamino)fluorine were used, respectively, instead of 2-anilino-3-methyl-6-diethylaminofluorane (an electron-donating colorless dye) used in the preparation of dispersion liquid A in Example 90.

### Example 115

The heat-sensitive recording material of the invention (128) was obtained in the same manner as in Example 60 except that an air knife coater was used instead of the curtain coater used in the application of the coating solution for a heat-sensitive recording layer in Example 90.

### Examples 116 to 119

The heat-sensitive recording materials of the invention (128) to (132) were obtained in the same manner as in Example 90 except that N-benzyl-4-hydroxybenzenesulfoneamide (=p-N-benzylsulfamoylphenol), BTUM, 4-hydroxy-4′-isopropoxydiphenylsulfone and 2,4-bis(phenylsulfonyl)phenol were used, respectively, instead of 4-hydroxybenzenesulfoneanilide (an electron-accepting compound) used in the preparation of dispersion liquid B in Example 90.

### Comparative Example 14

The comparative heat-sensitive recording material (133) was obtained in the same manner as in Example 90, except that the amount of calcite type light calcium carbonate 40 parts used for the pigment dispersion liquid D-4 was changed to aluminum hydroxide (boiled linseed oil absorption amount: 22 ml/100 g) 40 parts. The volume mean diameter of the pigment dispersion liquid D-4 for the Comparative Example was 4.0 μm.

### Comparative Example 15

The conparative heat-sensitive recording material (134) was obtained in the same manner as in Example 90, except that the amount of calcite type light calcium carbonate 40 parts used for the pigment dispersion liquid D-4 was changed to amorphous silica (boiled linseed oil absorption amount: 210 ml/100 g) 40 parts. The volume mean diameter of the pigment dispersion liquid D-4 for the Comparative Example was 2.4 μm.

(Evaluation)

The heat-sensitive recording materials (103) to (132) of the invention and the heat-sensitive recording materials (133) and (134) for comparison obtained in the above described manner were subjected to the following measurements and evaluations. The results of the measurements and evaluations are shown in the following Table 4.

(1) Measurement of Sensitivity

The sensitivity was measured by the same evaluation and method in Examples of the first embodiment.

(2) Head Staining

The surface of the thermal head used for the above-mentioned sensitivity measurement and the recording quality of the heat-sensitive recording materials were observed and evaluated according to the following standards.
◯: No stain was observed in the thermal head and no abnormality was observed in the recording quality.
Δ: Stains were slightly observed in the thermal head, however no abnormality was observed in the recording quality.
X: Stains were observed in the thermal head and stains were also found in the recording material.
   (3) Plasticizer Resistance

The image density (density after kept still) was measured by Macbeth reflection densitometer (RD-918) after each heat-sensitive recording material printed in the above-mentioned condition (1) was closely wrapped with a sheet of a polyvinyl chloride wrapping film (trade name: Polymawrap 300, manufactured by Shin-Etsu Chemical Co., Ltd.) and left in environments at 25° C. and 50% RH for 24 hours. The rate (the plasticizer retention rate) to the image density immediately after the printing carried out in the same condition (1) was calculated. The numeric value was higher, the image storability could be said better.

Plasticizer retention rate=[(image density after the storage under the above-mentioned condition)/(image density immediately after printing)]×100

(4) Evaluation of Background Fogging

The background fogging was evaluated by the same evaluation and method in Examples of the first embodiment.

(5) Evaluation of Image Storability

The image storability was evaluated by the same evaluation and method in Examples of the first embodiment.

(6) Evaluation of Chemical Resistance

The chemical resistance was evaluated by the same evaluation and method in Examples of the first embodiment.

(7) Evaluation of Printing Troubles Caused by Friction Between a Head and a Recording Material

The printing troubles caused by friction between a head and a recording material was evaluated by the same evaluation and method in Examples of the first embodiment.

(8) Evaluation of ink Jet Suitability

[1] Ink Resistance

The ink resistance was evaluated by the same evaluation and method in Examples of the first embodiment.

[2] Ink Jet Recording Applicability

The ink jet recording suitability was evaluated by the same evaluation and method in Examples of the first embodiment.

(9) Measurement of the Contact Angle

The contact angle was measured by the same evaluation and method in Examples of the first embodiment.

(10) Measurement of Concentration of Ions (Na⁺ and K⁺)

The ion concentration was measured by the same evaluation and method in Examples of the first embodiment.

TABLE 4

| | Heat- | Image | | | | Back- | | | Ink jet suitability | | | |
|---|---|---|---|---|---|---|---|---|---|---|---|---|
| | sensitive | density | | | | ground | | | | ink jet | | Ion |
| | recording | (sensi- | Head | Plas- | Image | fogging | Chemical | Printing | ink | recording | Contact | concentration |
| | material | tivity) | staining | ticizer | storability | density | resistance | trouble | resistance | suitability | angle [°] | [ppm] |
| Example 90 | (103) | 1.28 | ◯ | 75% | 95% | 0.09 | ◯ | 0 point | 90% | ◯ | 51 | 780 |
| Example 91 | (104) | 1.27 | ◯ | 78% | 98% | 0.10 | ◯ | 0 point | 93% | ◯ | 55 | 800 |
| Example 92 | (105) | 1.26 | ◯ | 77% | 97% | 0.10 | ◯ | 0 point | 92% | ◯ | 53 | 800 |
| Example 93 | (106) | 1.26 | ◯ | 70% | 93% | 0.10 | ◯ | 0 point | 88% | ◯ | 50 | 770 |
| Example 94 | (107) | 1.27 | ◯ | 76% | 96% | 0.09 | ◯ | 0 point | 91% | ◯ | 55 | 790 |
| Example 95 | (108) | 1.30 | ◯ | 75% | 96% | 0.08 | ◯ | 0 point | 93% | ◯ | 50 | 800 |
| Example 96 | (109) | 1.29 | ◯ | 77% | 97% | 0.08 | ◯ | 0 point | 92% | ◯ | 52 | 800 |
| Example 97 | (110) | 1.28 | ◯ | 76% | 95% | 0.08 | ◯ | 0 point | 93% | ◯ | 55 | 790 |
| Example 98 | (111) | 1.28 | ◯ | 76% | 94% | 0.09 | ◯ | 0 point | 93% | ◯ | 60 | 800 |
| Example 99 | (112) | 1.23 | ◯ | 80% | 98% | 0.09 | ◯ | 0 point | 98% | ◯ | 45 | 800 |
| Example 100 | (113) | 1.22 | ◯ | 85% | 97% | 0.09 | ◯ | 0 point | 97% | ◯ | 42 | 800 |
| Example 101 | (114) | 1.21 | ◯ | 87% | 98% | 0.10 | ◯ | 0 point | 98% | ◯ | 48 | 790 |
| Example 102 | (115) | 1.20 | ◯ | 77% | 96% | 0.10 | ◯ | 0 point | 92% | ◯ | 35 | 800 |
| Example 103 | (116) | 1.27 | ◯ | 73% | 94% | 0.09 | ◯ | 0 point | 89% | ◯ | 50 | 790 |
| Example 104 | (117) | 1.26 | ◯ | 74% | 95% | 0.10 | ◯ | 0 point | 91% | ◯ | 51 | 800 |
| Example 105 | (118) | 1.28 | ◯ | 76% | 94% | 0.09 | ◯ | 0 point | 92% | ◯ | 51 | 790 |
| Example 106 | (119) | 1.24 | ◯ | 72% | 91% | 0.10 | ◯ | 0 point | 89% | ◯ | 50 | 800 |
| Example 107 | (120) | 1.26 | ◯ | 74% | 95% | 0.10 | ◯ | 0 point | 91% | ◯ | 52 | 790 |
| Example 108 | (121) | 1.28 | ◯ | 72% | 93% | 0.09 | ◯ | 0 point | 89% | ◯ | 51 | 800 |
| Example 109 | (122) | 1.25 | ◯ | 70% | 92% | 0.09 | ◯ | 0 point | 91% | ◯ | 50 | 790 |
| Example 110 | (123) | 1.28 | ◯ | 80% | 97% | 0.10 | ◯ | 0 point | 93% | ◯ | 55 | 790 |
| Example 111 | (124) | 1.26 | ◯ | 78% | 95% | 0.10 | ◯ | 0 point | 88% | ◯ | 55 | 780 |
| Example 112 | (125) | 1.26 | ◯ | 77% | 92% | 0.10 | ◯ | 0 point | 87% | ◯ | 55 | 790 |
| Example 113 | (126) | 1.28 | ◯ | 78% | 95% | 0.10 | ◯ | 0 point | 91% | ◯ | 51 | 790 |
| Example 114 | (127) | 1.24 | ◯ | 68% | 88% | 0.08 | ◯ | 0 point | 85% | ◯ | 50 | 780 |
| Example 115 | (128) | 1.26 | ◯ | 74% | 93% | 0.10 | ◯ | 0 point | 90% | ◯ | 52 | 780 |
| Example 116 | (129) | 1.20 | ◯ | 65% | 65% | 0.09 | Δ | 0 point | 80% | Δ | 55 | 760 |
| Example 117 | (130) | 1.22 | ◯ | 65% | 98% | 0.12 | ◯ | 0 point | 92% | ◯ | 50 | 800 |
| Example 118 | (131) | 1.26 | ◯ | 60% | 91% | 0.07 | ◯ | 0 point | 93% | ◯ | 52 | 780 |
| Example 119 | (132) | 1.26 | ◯ | 65% | 98% | 0.11 | ◯ | 0 point | 96% | ◯ | 51 | 790 |
| Comparative | (133) | 1.15 | Δ | 70% | 89% | 0.09 | ◯ | 0 point | 85% | ◯ | 50 | 780 |
| example 14 | | | | | | | | | | | | |
| Comparative | (134) | 1.03 | ◯ | 72% | 75% | 0.10 | ◯ | 0 point | 75% | ◯ | 40 | 800 |
| example 15 | | | | | | | | | | | | |

According to the results shown in Table 4, with respect to the heat-sensitive recording materials (103) to (132) of the invention containing electron-accepting compounds represented by the general formula (1) and pigments having the boiled linseed oil absorption amount of 30 to 200 ml/200 g and having a volume mean diameter of 0.5 to 3 μm, the background fogging in the background portions was kept to low, high coloring density (high sensitivity) was obtained (good printing suitability) and the image storability after printing was good and due to the contact angle improvement, the ink jet suitability was provided and also excellent chemical resistance and plasticizer resistance were provided and further head wear was lessened to show excellent thermal head matching property as well. That is, these heat-sensitive recording materials were found satisfactory simultaneously in all of the high sensitivity as well as background whiteness, image storability, ink jet suitability, chemical resistance and thermal head matching property (wear resistance).

In comparison with the heat-sensitive recording material (103), the heat-sensitive recording materials (104) and (105) containing the image stabilizers were provided with improved image storability and ink resistance and the heat-sensitive recording material (108) containing a preferable adhesive (protection colloid) was provided with further improved sensitivity and lowered background fogging. Addition of the image stabilizers was found effective to give particularly excellent stamping suitability and handling easiness. In the case of the heat-sensitive recording materials (112) to (115) having protective layers containing specified inorganic pigments suitable for the fourth embodiment of the invention, the image storability and the ink resistance (chemical resistance) could further be improved. Also, due to the sensitizers used for Examples 103 to 109, preferable properties similar to those of the heat-sensitive recording material (103) of Example 90 were obtained and the electron-donating colorless dyes used for Examples 110 to 114 were found effective to keep background fogging low and give good coloration property and image storability. As shown in the case of Examples 90 and 115, curtain coating method was found preferable in terms of the sensitivity improvement. In the case where waste paper pulp was added to the support (Example 98), it did not cause any adverse effects on properties and abilities.

On the other hand, in the comparative heat-sensitive recording materials (133) and (134) containing pigments having the boiled linseed oil absorption amount out of the range of 30 to 200 ml/100 g, properties and capabilities such as the head staining property and the image storability could not be satisfactory simultaneously.

### INDUSTRIAL APPLICABILITY

Accordingly, the invention can provide a heat-sensitive recording material which is scarcely curled and suitable for high quality recording and transportation; which is useful for forming images with high sensitivity and high density (good printing suitability) with suppressed fogging density in the background portion (background fogging); which is excellent in the image storability and chemical resistance after printing and has ink-jet suitability without causing hue failure and blurring of the ink jet images or image color fading attributed the ink for ink jet; and which shows good matching property to the thermal head and scarcely causes head wear or head stain even in the case of application to a high speed or a high functional printer having a partial graze structure (good head matching property in the high speed printing).

The invention also provides a heat-sensitive recording material, in addition to the above-mentioned properties, which gives sharp and high quality images, is excellent in the light fastness of the formed images, comprises a heat-sensitive recording layer or a protective layer for printing or stamping without blurring, is produced at a low cost with a saved amount of coating (environmental friendly property), and is provided with an plain paper-like touch.

1. A heat-sensitive recording material comprising a support and a heat-sensitive recording layer provided thereon, the heat-sensitive recording layer containing an electron-donating colorless dye and an electron-accepting compound for coloring by reacting with the electron-donating colorless dye,
wherein the electron-accepting compound is 4-hydroxybenzenesulfonanilide, a maximum value of a curl height of the heat-sensitive recording material at 23° C. and a relative humidity of 45% is 5.0 mm or less.

2. A heat-sensitive recording material according to claim 1, wherein the heat-sensitive recording layer is formed by applying a coating solution, and a dried coating amount after application is less than 6 g/cm².

3. (canceled)

4. A heat-sensitive recording material according to any one of claims 1 to 3, wherein a total ion concentration of Na⁺ ions and K⁺ ions is 1,500 ppm or less.

5. A heat-sensitive recording material according to any one of claims 1 to 4, wherein a contact angle after 0.1 seconds after dropwise dropping distilled water on the surface of the heat-sensitive recording layer is 20° or more.

6. A heat-sensitive recording material according to any one of claims 1 to 5, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane, and diphenylsulfone.

7. A heat-sensitive recording material according to any one of claims 1 to 6, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

8. A heat-sensitive recording material according to any one of claims 1 to 7, wherein at least one layer on the support is formed by application by a curtain coating method.

9. A heat-sensitive recording material comprising a support and a heat-sensitive recording layer provided thereon, the heat-sensitive recording layer containing an electron-donating colorless dye and an electron-accepting compound for coloring by reacting with the electron-donating colorless dye,
wherein the electron-accepting compound is 4-hydroxybenzenesulfonanilide, and an image density formed by thermal printing by energy application at 15.2 mJ/mm² from a heat-sensitive recording layer side of the support is 1.20 or more.

10. A heat-sensitive recording material according to claim 9, wherein the heat-sensitive recording layer is formed by applying a coating solution, and the dried coating amount after application is less than 6 g/cm².

11. (canceled)

12. A heat-sensitive recording material according to any one of claims 9 to 11, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, 1,2-diphenoxyethane, and diphenylsulfone.

13. A heat-sensitive recording material according to any one of claims 9 to 12, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

14. A heat-sensitive recording material according to any one of claims 9 to 13, wherein at least one layer on the support is formed by application by a curtain coating method.

15. A heat-sensitive recording material comprising a support and a heat-sensitive recording layer provided thereon, the heat-sensitive recording layer containing an electron-donating colorless dye and an electron-accepting compound for coloring by reacting with the electron-donating colorless dye,
wherein the electron-accepting compound is 4-hydroxybenzenesulfonanilide,
an image density formed by printing with a thermal head by energy application at 15.2 mJ/mm² is 1.20 or more, and
a static friction coefficient and a dynamic friction coefficient are in a range of 0.2 to 0.5 in a case where an outermost surface of a front side of the recording material having at least one heat-sensitive recording layer and an outermost surface of a rear side of the recording material are rubbed against each other.

16. (canceled)

17. (canceled)

18. A heat-sensitive recording material according to any one of claims 15 to 17, wherein the support contains waste paper pulp.

19. A heat-sensitive recording material according to any one of claims 15 to 18, wherein a total ion concentration of Na⁺ ions and K⁺ ions is 1,500 ppm or less.

20. A heat-sensitive recording material according to any one of claims 15 to 19, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, diphenylsulfone, and 1,2-diphenoxyethane.

21. A heat-sensitive recording material according to any one of claims 15 to 20, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.

22. A heat-sensitive recording material according to any one of claims 15 to 21, wherein at least one layer on the support is formed by application by a curtain coating method.

23. A heat-sensitive recording method in which thermal printing is conducted a thermal printing at a speed of 10 cm/sec or more using a heat-sensitive recording material, the heat-sensitive recording material, wherein the heat-sensitive recording material is comprises a support and a heat-sensitive recording layer provided thereon, and the heat-sensitive recording layer contains an electron-donating colorless dye, 4-hydroxybenzenesulfonanilide as an electron-accepting compound for coloring by reacting with the electron-donating colorless dye, and a pigment which has a boiled linseed oil absorption amount of 30 to 200 ml/100 g and an volume average particle diameter of 0.5 to 3 μm.

24. (canceled)

25. (canceled)

26. A heat-sensitive recording method according to any one of claims 23 to 25, wherein the pigment is at least one compound selected from calcite type (precipitated) calcium carbonate, amorphous silica, and aluminum hydroxide.

27. A heat-sensitive recording method according to any one of claims 23 to 26, wherein the heat-sensitive recording layer contains a sensitizer, and the sensitizer is at least one compound selected from 2-benzyloxynaphthalene, dimethylbenzyl oxalate, m-terphenyl, ethylene glycol tolyl ether, p-benzylbiphenyl, 1,2-diphenoxymethylbenzene, diphenylsulfone, and 1,2-diphenoxyethane.

28. A heat-sensitive recording method according to any one of claims 23 to 27, wherein the electron-donating colorless dye is at least one compound selected from 2-anilino-3-methyl-6-diethylaminofluoran, 2-anilino-3-methyl-6-dibutylaminofluoran, 2-anilino-3-methyl-6-(N-ethyl-N-isoamylamino)fluoran, 2-anilino-3-methyl-6-(N-ethyl-N-propylamino)fluoran, 2-anilino-3-methyl-6-di-n-amylaminofluoran, and 2-anilino-3-methyl-6-(N-ethyl-N-p-tolylamino)fluoran.
